(19) United States
(12) Patent Application Publication
(10) Pub. No.: US 2022/0415320 A1
(43) Pub. Date: Dec. 29, 2022

(54) Systems and Methods for Implementing Smart Assistant Systems

(71) Applicant: Meta Platforms, Inc., Menlo Park, CA (US)

(72) Inventors: Pujie Zheng, Seattle, WA (US); Lin Sun, Kenmore, WA (US); Ram Kumar Hariharan, Kirkland, WA (US); Haidong Wang, Clyde Hill, WA (US); Joshua Saylor McMullen, Kirkland, WA (US); Mengxi Li, Bellevue, WA (US); Long You Cai, Kirkland, WA (US); Keith Diedrick, Kirkland, WA (US); Crystal Annette Nakatsu Sung, Redmond, WA (US); Xi Chen, San Jose, CA (US); Stanislav Peshterliev, Redmond, WA (US); Debojeet Chatterjee, Sunnyvale, CA (US); Sonal Gupta, Sunnyvale, CA (US); Vikas Seshagiri Rao Bhardwaj, Seattle, WA (US); Yashar Mehdad, Redwood City, CA (US); Anuj Kumar, Kirkland, WA (US); Ashish Garg, Bellevue, WA (US); Justin Denney, San Francisco, CA (US); Hakan Inan, Emerald Lake Hills, CA (US); Iaroslav Markov, San Mateo, CA (US); Surya Teja Appini, Mountain View, CA (US); Bing Liu, Sunnyvale, CA (US); Shusen Liu, Mountain View, CA (US); Zhiqi Wang, Redmond, WA (US); Alexander Kolmykov-Zotov, Sammamish, WA (US)

(21) Appl. No.: 17/745,671

(22) Filed: May 16, 2022

Related U.S. Application Data
(60) Provisional application No. 63/214,076, filed on Jun. 23, 2021.
(60) Provisional application No. 63/247,173, filed on Sep. 22, 2021.
(60) Provisional application No. 63/247,182, filed on Sep. 22, 2021.
(60) Provisional application No. 63/248,849, filed on Sep. 27, 2021.
(60) Provisional application No. 63/255,269, filed on Oct. 13, 2021.

(51) Int. Cl. G10L 15/22; G06F 40/35

(52) U.S. Cl. CPC G10L 15/22; G06F 40/35; G10L 2015/221; G10L 2015/223

(57) ABSTRACT

In one embodiment, a system includes an automatic speech recognition (ASR) module, a natural-language understanding (NLU) module, a dialog manager, one or more agents, an arbitrator, a delivery system, one or more processors, and a non-transitory memory coupled to the processors comprising instructions executable by the processors, the processors operable when executing the instructions to receive a user input, process the user input using the ASR module, the NLU module, the dialog manager, one or more of the agents, the arbitrator, and the delivery system, and provide a response to the user input.

### PRIORITY

This application claims the benefit under 35 U.S.C. § 119(e) of U.S. Provisional Patent Application No. 63/214,076, filed 23 Jun. 2021, U.S. Provisional Patent Application No. 63/241,173, filed 22 Sep. 2021, U.S. Provisional Patent Application No. 63/247,182, filed 22 Sep. 2021, U.S. Provisional Patent Application No. 63/248,849, filed 27 Sep. 2021, and U.S. Provisional Patent Application No. 63/255,269, filed 13 Oct. 2021, each of which is incorporated herein by reference.

### TECHNICAL FIELD

This disclosure generally relates to databases and file management within network environments, and in particular relates to hardware and software for smart assistant systems.

### BACKGROUND

An assistant system can provide information or services on behalf of a user based on a combination of user input, location awareness, and the ability to access information from a variety of online sources (such as weather conditions, traffic congestion, news, stock prices, user schedules, retail prices, etc.). The user input may include text (e.g., online chat), especially in an instant messaging application or other applications, voice, images, motion, or a combination of them. The assistant system may perform concierge-type services (e.g., making dinner reservations, purchasing event tickets, making travel arrangements) or provide information based on the user input. The assistant system may also perform management or data-handling tasks based on online information and events without user initiation or interaction. Examples of those tasks that may be performed by an assistant system may include schedule management (e.g., sending an alert to a dinner date that a user is running late due to traffic conditions, update schedules for both parties, and change the restaurant reservation time). The assistant system may be enabled by the combination of computing devices, application programming interfaces (APIs), and the proliferation of applications on user devices.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. profile/news feed posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, the assistant system may assist a user to obtain information or services. The assistant system may enable the user to interact with the assistant system via user inputs of various modalities (e.g., audio, voice, text, image, video, gesture, motion, location, orientation) in stateful and multi-turn conversations to receive assistance from the assistant system. As an example and not by way of limitation, the assistant system may support mono-modal inputs (e.g., only voice inputs), multi-modal inputs (e.g., voice inputs and text inputs), hybrid/multi-modal inputs, or any combination thereof. User inputs provided by a user may be associated with particular assistant-related tasks, and may include, for example, user requests (e.g., verbal requests for information or performance of an action), user interactions with an assistant application associated with the assistant system (e.g., selection of UI elements via touch or gesture), or any other type of suitable user input that may be detected and understood by the assistant system (e.g., user movements detected by the client device of the user). The assistant system may create and store a user profile comprising both personal and contextual information associated with the user. In particular embodiments, the assistant system may analyze the user input using natural-language understanding (NLU). The analysis may be based on the user profile of the user for more personalized and context-aware understanding. The assistant system may resolve entities associated with the user input based on the analysis. In particular embodiments, the assistant system may interact with different agents to obtain information or services that are associated with the resolved entities. The assistant system may generate a response for the user regarding the information or services by using natural-language generation (NLG). Through the interaction with the user, the assistant system may use dialog-management techniques to manage and advance the conversation flow with the user. In particular embodiments, the assistant system may further assist the user to effectively and efficiently digest the obtained information by summarizing the information. The assistant system may also assist the user to be more engaging with an online social network by providing tools that help the user interact with the online social network (e.g., creating posts, comments, messages). The assistant system may additionally assist the user to manage different tasks such as keeping track of events. In particular embodiments, the assistant system may proactively execute, without a user input, tasks that are relevant to user interests and preferences based on the user profile, at a time relevant for the user. In particular embodiments, the assistant system may check privacy settings to ensure that accessing a user's profile or other user information and executing different tasks are permitted subject to the user's privacy settings.

In particular embodiments, the assistant system may assist the user via a hybrid architecture built upon both client-side processes and server-side processes. The client-side processes and the server-side processes may be two parallel workflows for processing a user input and providing assistance to the user. In particular embodiments, the client-side processes may be performed locally on a client system associated with a user. By contrast, the server-side processes may be performed remotely on one or more computing systems. In particular embodiments, an arbitrator on the client system may coordinate receiving user input (e.g., an audio signal), determine whether to use a client-side process, a server-side process, or both, to respond to the user input, and analyze the processing results from each process. The arbitrator may instruct agents on the client-side or server-side to execute tasks associated with the user input based on the aforementioned analyses. The execution results may be further rendered as output to the client system. By leveraging both client-side and server-side processes, the assistant system can effectively assist a user with optimal usage of computing resources while at the same time protecting user privacy and enhancing security.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with an assistant system.

FIG. 2 illustrates an example architecture of the assistant system.

FIG. 3 illustrates an example flow diagram of the assistant system.

FIG. 4 illustrates an example task-centric flow diagram of processing a user input.

FIG. 5 illustrates an example social graph.

FIG. 6 illustrates an example view of an embedding space.

FIG. 7 illustrates an example artificial neural network.

FIG. 8 illustrates an example computer system.

FIG. 9A illustrates an example interface of NLG configuration in the “response” section.

FIG. 9B illustrates an example interface of NLG configuration indicating a selection of enabled devices in the “response” section.

FIG. 10 illustrates an example section allowing developers to select the UI template type and set the argument identifier for the card/cards in the UI template.

FIG. 11 illustrates example different layout a developer may be able to configure for five different types of client systems.

FIG. 12 illustrates example different layout a developer may be able to configure for five different types of client systems.

FIG. 13 illustrates example templates for configuring responses.

FIG. 14 illustrates an example template for a single response.

FIG. 15 illustrates an example configuration of a single response.

FIG. 16 illustrates an example configuration of an alarm.

FIG. 17 illustrates an example template for multiple responses.

FIG. 18 illustrates an example configuration of multiple responses with image focused.

FIG. 19 illustrates an example configuration of multiple responses with people focused.

FIG. 20A illustrates an example user interface showing a configuration of image focused layout.

FIG. 20B illustrates the example user interface showing the configuration of image focused layout with a selection of showing ordinal number.

FIG. 21 illustrates an example user interface showing a configuration of multiple devices.

FIG. 22 illustrates an example anatomy of the list items.

FIG. 23A illustrates an example social dialog.

FIG. 23B illustrates an example discourse representation graph.

FIG. 23C illustrates example sub-dialogues.

FIG. 24A illustrates another example social dialog.

FIG. 24B illustrates another example discourse representation graph.

FIG. 24C illustrates other example sub-dialogues.

FIG. 25 illustrates an example RST tree.

FIG. 26 illustrates example interpretations in RST.

FIG. 27 illustrates an example hierarchy of QUD.

FIG. 28 illustrates an example diagram workflow for community Q&A.

FIG. 29 illustrates an example indexing pipeline.

FIG. 30 illustrates an example runtime search pipeline.

FIG. 31 illustrates an example workflow for community Q&A for an example query.

FIG. 32 illustrates an example incorporation of content stitching graph for response generation.

FIG. 33 illustrates an example CS graph.

FIG. 34 illustrates another example CS graph.

FIG. 35 illustrates an example workflow for graph ingestion.

FIG. 36 illustrates an example graph ingestion for text generation.

FIG. 37 illustrates an example workflow for graph-to-text.

FIG. 38 illustrates an example workflow for graph entity export.

FIG. 39 illustrates an example pipeline for NLG module integration.

FIG. 40 illustrates an example hybrid processing architecture of the conversational understanding reinforcement engine.

FIG. 41 illustrates an example fully on-device processing architecture of the conversational understanding reinforcement engine.

### DESCRIPTION OF EXAMPLE EMBODIMENTS

### System Overview

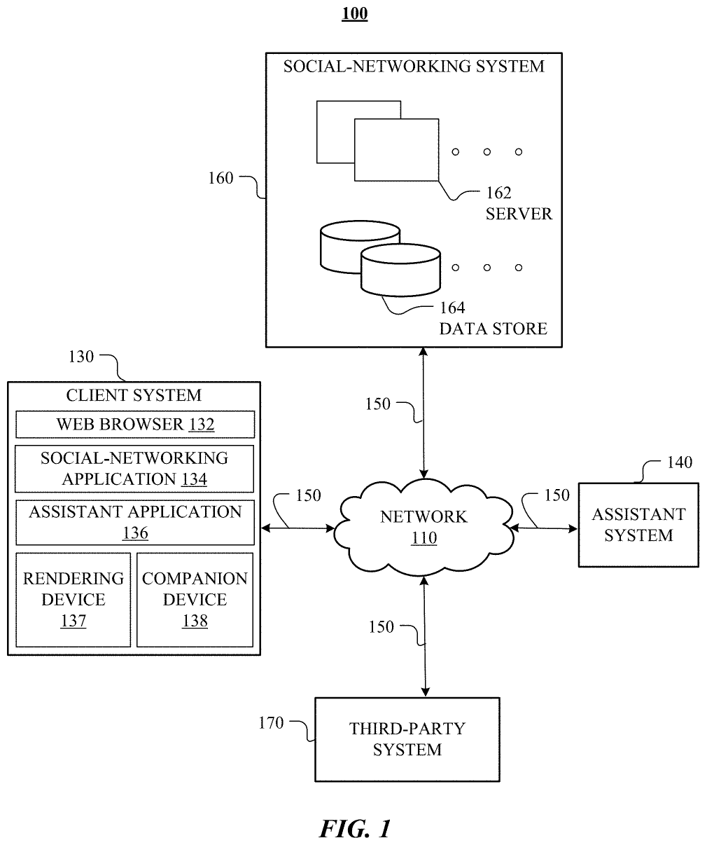

FIG. 1 illustrates an example network environment 100 associated with an assistant system. Network environment 100 includes a client system 130, an assistant system 140, a social-networking system 160, and a third-party system 170 connected to each other by a network 110. Although FIG. 1 illustrates a particular arrangement of a client system 130, an assistant system 140, a social-networking system 160, a third-party system 170, and a network 110, this disclosure contemplates any suitable arrangement of a client system 130, an assistant system 140, a social-networking system 160, a third-party system 170, and a network 110. As an example and not by way of limitation, two or more of a client system 130, a social-networking system 160, an assistant system 140, and a third-party system 170 may be connected to each other directly, bypassing a network 110. As another example, two or more of a client system 130, an assistant system 140, a social-networking system 160, and a third-party system 170 may be physically or logically co-located with each other in whole or in part. Moreover, although FIG. 1 illustrates a particular number of client systems 130, assistant systems 140, social-networking systems 160, third-party systems 170, and networks 110, this disclosure contemplates any suitable number of client systems 130, assistant systems 140, social-networking systems 160, third-party systems 170, and networks 110. As an example and not by way of limitation, network environment 100 may include multiple client systems 130, assistant systems 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a client system 130, an assistant system 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be any suitable electronic device including hardware, software, or embedded logic components, or a combination of two or more such components, and may be capable of carrying out the functionalities implemented or supported by a client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 130 may be a smart assistant device. More information on smart assistant devices may be found in U.S. patent application Ser. No. 15/949,011, filed 9 Apr. 2018, U.S. patent application Ser. No. 16/153,574, filed 5 Oct. 2018, U.S. Design patent application Ser. No. 29/631,910, filed 3 Jan. 2018, U.S. Design patent application Ser. No. 29/631,747, filed 2 Jan. 2018, U.S. Design patent application Ser. No. 29/631,913, filed 3 Jan. 2018, and U.S. Design patent application Ser. No. 29/631,914, filed 3 Jan. 2018, each of which is incorporated by reference. This disclosure contemplates any suitable client systems 130. In particular embodiments, a client system 130 may enable a network user at a client system 130 to access a network 110. The client system 130 may also enable the user to communicate with other users at other client systems 130.

In particular embodiments, a client system 130 may include a web browser 132, and may have one or more add-ons, plug-ins, or other extensions. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a client system 130 may include a social-networking application 134 installed on the client system 130. A user at a client system 130 may use the social-networking application 134 to access on online social network. The user at the client system 130 may use the social-networking application 134 to communicate with the user's social connections (e.g., friends, followers, followed accounts, contacts, etc.). The user at the client system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a client system 130 may include an assistant application 136. A user at a client system 130 may use the assistant application 136 to interact with the assistant system 140. In particular embodiments, the assistant application 136 may include an assistant xbot functionality as a front-end interface for interacting with the user of the client system 130, including receiving user inputs and presenting outputs. In particular embodiments, the assistant application 136 may comprise a stand-alone application. In particular embodiments, the assistant application 136 may be integrated into the social-networking application 134 or another suitable application (e.g., a messaging application). In particular embodiments, the assistant application 136 may be also integrated into the client system 130, an assistant hardware device, or any other suitable hardware devices. In particular embodiments, the assistant application 136 may be also part of the assistant system 140. In particular embodiments, the assistant application 136 may be accessed via the web browser 132. In particular embodiments, the user may interact with the assistant system 140 by providing user input to the assistant application 136 via various modalities (e.g., audio, voice, text, vision, image, video, gesture, motion, activity, location, orientation). The assistant application 136 may communicate the user input to the assistant system 140 (e.g., via the assistant xbot). Based on the user input, the assistant system 140 may generate responses. The assistant system 140 may send the generated responses to the assistant application 136. The assistant application 136 may then present the responses to the user at the client system 130 via various modalities (e.g., audio, text, image, and video). As an example and not by way of limitation, the user may interact with the assistant system 140 by providing a user input (e.g., a verbal request for information regarding a current status of nearby vehicle traffic) to the assistant xbot via a microphone of the client system 130. The assistant application 136 may then communicate the user input to the assistant system 140 over network 110. The assistant system 140 may accordingly analyze the user input, generate a response based on the analysis of the user input (e.g., vehicle traffic information obtained from a third-party source), and communicate the generated response back to the assistant application 136. The assistant application 136 may then present the generated response to the user in any suitable manner (e.g., displaying a text-based push notification and/or image(s) illustrating a local map of nearby vehicle traffic on a display of the client system 130).

In particular embodiments, a client system 130 may implement wake-word detection techniques to allow users to conveniently activate the assistant system 140 using one or more wake-words associated with assistant system 140. As an example and not by way of limitation, the system audio API on client system 130 may continuously monitor user input comprising audio data (e.g., frames of voice data) received at the client system 130. In this example, a wake-word associated with the assistant system 140 may be the voice phrase “hey assistant.” In this example, when the system audio API on client system 130 detects the voice phrase “hey assistant” in the monitored audio data, the assistant system 140 may be activated for subsequent interaction with the user. In alternative embodiments, similar detection techniques may be implemented to activate the assistant system 140 using particular non-audio user inputs associated with the assistant system 140. For example, the non-audio user inputs may be specific visual signals detected by a low-power sensor (e.g., camera) of client system 130. As an example and not by way of limitation, the visual signals may be a static image (e.g., barcode, QR code, universal product code (UPC)), a position of the user (e.g., the user's gaze towards client system 130), a user motion (e.g., the user pointing at an object), or any other suitable visual signal.

In particular embodiments, a client system 130 may include a rendering device 137 and, optionally, a companion device 138. The rendering device 137 may be configured to render outputs generated by the assistant system 140 to the user. The companion device 138 may be configured to perform computations associated with particular tasks (e.g., communications with the assistant system 140) locally (i.e., on-device) on the companion device 138 in particular circumstances (e.g., when the rendering device 137 is unable to perform said computations). In particular embodiments, the client system 130, the rendering device 137, and/or the companion device 138 may each be a suitable electronic device including hardware, software, or embedded logic components, or a combination of two or more such components, and may be capable of carrying out, individually or cooperatively, the functionalities implemented or supported by the client system 130 described herein. As an example and not by way of limitation, the client system 130, the rendering device 137, and/or the companion device 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 130, the rendering device 137, and the companion device 138 may operate as a smart assistant device. As an example and not by way of limitation, the rendering device 137 may comprise smart glasses and the companion device 138 may comprise a smart phone. As another example and not by way of limitation, the rendering device 137 may comprise a smart watch and the companion device 138 may comprise a smart phone. As yet another example and not by way of limitation, the rendering device 137 may comprise smart glasses and the companion device 138 may comprise a smart remote for the smart glasses. As yet another example and not by way of limitation, the rendering device 137 may comprise a VR/AR headset and the companion device 138 may comprise a smart phone.

In particular embodiments, a user may interact with the assistant system 140 using the rendering device 137 or the companion device 138, individually or in combination. In particular embodiments, one or more of the client system 130, the rendering device 137, and the companion device 138 may implement a multi-stage wake-word detection model to enable users to conveniently activate the assistant system 140 by continuously monitoring for one or more wake-words associated with assistant system 140. At a first stage of the wake-word detection model, the rendering device 137 may receive audio user input (e.g., frames of voice data). If a wireless connection between the rendering device 137 and the companion device 138 is available, the application on the rendering device 137 may communicate the received audio user input to the companion application on the companion device 138 via the wireless connection. At a second stage of the wake-word detection model, the companion application on the companion device 138 may process the received audio user input to detect a wake-word associated with the assistant system 140. The companion application on the companion device 138 may then communicate the detected wake-word to a server associated with the assistant system 140 via wireless network 110. At a third stage of the wake-word detection model, the server associated with the assistant system 140 may perform a keyword verification on the detected wake-word to verify whether the user intended to activate and receive assistance from the assistant system 140. In alternative embodiments, any of the processing, detection, or keyword verification may be performed by the rendering device 137 and/or the companion device 138. In particular embodiments, when the assistant system 140 has been activated by the user, an application on the rendering device 137 may be configured to receive user input from the user, and a companion application on the companion device 138 may be configured to handle user inputs (e.g., user requests) received by the application on the rendering device 137. In particular embodiments, the rendering device 137 and the companion device 138 may be associated with each other (i.e., paired) via one or more wireless communication protocols (e.g., Bluetooth).

The following example workflow illustrates how a rendering device 137 and a companion device 138 may handle a user input provided by a user. In this example, an application on the rendering device 137 may receive a user input comprising a user request directed to the rendering device 137. The application on the rendering device 137 may then determine a status of a wireless connection (i.e., tethering status) between the rendering device 137 and the companion device 138. If a wireless connection between the rendering device 137 and the companion device 138 is not available, the application on the rendering device 137 may communicate the user request (optionally including additional data and/or contextual information available to the rendering device 137) to the assistant system 140 via the network 110. The assistant system 140 may then generate a response to the user request and communicate the generated response back to the rendering device 137. The rendering device 137 may then present the response to the user in any suitable manner. Alternatively, if a wireless connection between the rendering device 137 and the companion device 138 is available, the application on the rendering device 137 may communicate the user request (optionally including additional data and/or contextual information available to the rendering device 137) to the companion application on the companion device 138 via the wireless connection. The companion application on the companion device 138 may then communicate the user request (optionally including additional data and/or contextual information available to the companion device 138) to the assistant system 140 via the network 110. The assistant system 140 may then generate a response to the user request and communicate the generated response back to the companion device 138. The companion application on the companion device 138 may then communicate the generated response to the application on the rendering device 137. The rendering device 137 may then present the response to the user in any suitable manner. In the preceding example workflow, the rendering device 137 and the companion device 138 may each perform one or more computations and/or processes at each respective step of the workflow. In particular embodiments, performance of the computations and/or processes disclosed herein may be adaptively switched between the rendering device 137 and the companion device 138 based at least in part on a device state of the rendering device 137 and/or the companion device 138, a task associated with the user input, and/or one or more additional factors. As an example and not by way of limitation, one factor may be signal strength of the wireless connection between the rendering device 137 and the companion device 138. For example, if the signal strength of the wireless connection between the rendering device 137 and the companion device 138 is strong, the computations and processes may be adaptively switched to be substantially performed by the companion device 138 in order to, for example, benefit from the greater processing power of the CPU of the companion device 138. Alternatively, if the signal strength of the wireless connection between the rendering device 137 and the companion device 138 is weak, the computations and processes may be adaptively switched to be substantially performed by the rendering device 137 in a standalone manner. In particular embodiments, if the client system 130 does not comprise a companion device 138, the aforementioned computations and processes may be performed solely by the rendering device 137 in a standalone manner.

In particular embodiments, an assistant system 140 may assist users with various assistant-related tasks. The assistant system 140 may interact with the social-networking system 160 and/or the third-party system 170 when executing these assistant-related tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, an assistant system 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes-which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow, for example, an assistant system 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a user input comprising a user request received from a client system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Assistant Systems

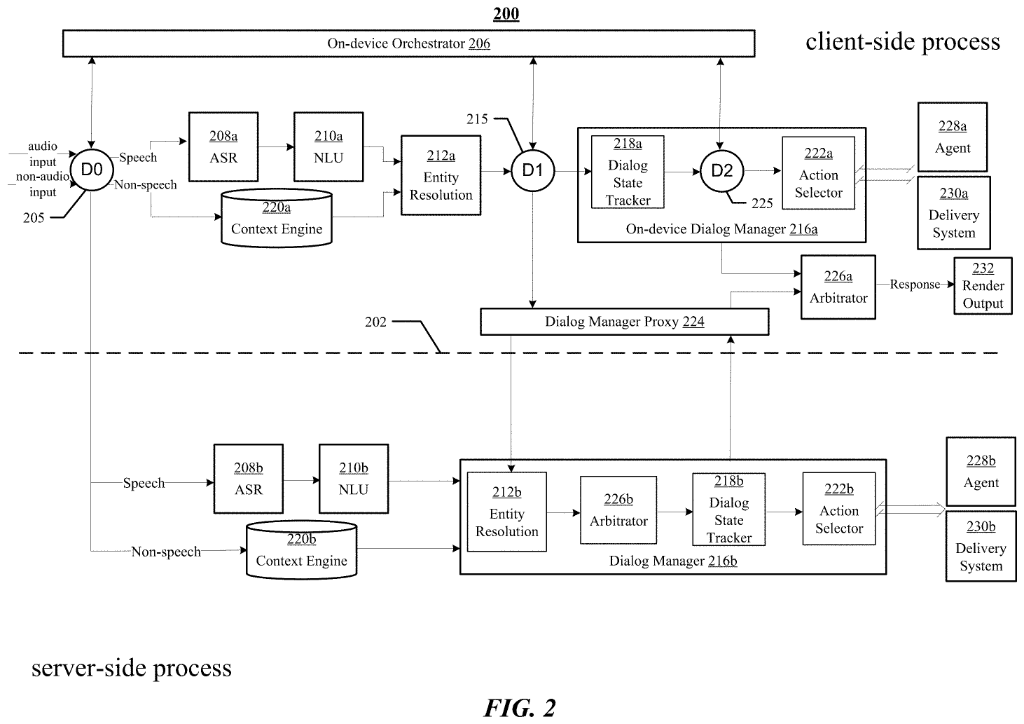

FIG. 2 illustrates an example architecture 200 of the assistant system 140. In particular embodiments, the assistant system 140 may assist a user to obtain information or services. The assistant system 140 may enable the user to interact with the assistant system 140 via user inputs of various modalities (e.g., audio, voice, text, vision, image, video, gesture, motion, activity, location, orientation) in stateful and multi-turn conversations to receive assistance from the assistant system 140. As an example and not by way of limitation, a user input may comprise an audio input based on the user's voice (e.g., a verbal command), which may be processed by a system audio API (application programming interface) on client system 130. The system audio API may perform techniques including echo cancellation, noise removal, beam forming, self-user voice activation, speaker identification, voice activity detection (VAD), and/or any other suitable acoustic technique in order to generate audio data that is readily processable by the assistant system 140. In particular embodiments, the assistant system 140 may support mono-modal inputs (e.g., only voice inputs), multi-modal inputs (e.g., voice inputs and text inputs), hybrid/multi-modal inputs, or any combination thereof. In particular embodiments, a user input may be a user-generated input that is sent to the assistant system 140 in a single turn. User inputs provided by a user may be associated with particular assistant-related tasks, and may include, for example, user requests (e.g., verbal requests for information or performance of an action), user interactions with the assistant application 136 associated with the assistant system 140 (e.g., selection of UI elements via touch or gesture), or any other type of suitable user input that may be detected and understood by the assistant system 140 (e.g., user movements detected by the client device 130 of the user).

In particular embodiments, the assistant system 140 may create and store a user profile comprising both personal and contextual information associated with the user. In particular embodiments, the assistant system 140 may analyze the user input using natural-language understanding (NLU) techniques. The analysis may be based at least in part on the user profile of the user for more personalized and context-aware understanding. The assistant system 140 may resolve entities associated with the user input based on the analysis. In particular embodiments, the assistant system 140 may interact with different agents to obtain information or services that are associated with the resolved entities. The assistant system 140 may generate a response for the user regarding the information or services by using natural-language generation (NLG). Through the interaction with the user, the assistant system 140 may use dialog management techniques to manage and forward the conversation flow with the user. In particular embodiments, the assistant system 140 may further assist the user to effectively and efficiently digest the obtained information by summarizing the information. The assistant system 140 may also assist the user to be more engaging with an online social network by providing tools that help the user interact with the online social network (e.g., creating posts, comments, messages). The assistant system 140 may additionally assist the user to manage different tasks such as keeping track of events. In particular embodiments, the assistant system 140 may proactively execute, without a user input, pre-authorized tasks that are relevant to user interests and preferences based on the user profile, at a time relevant for the user. In particular embodiments, the assistant system 140 may check privacy settings to ensure that accessing a user's profile or other user information and executing different tasks are permitted subject to the user's privacy settings. More information on assisting users subject to privacy settings may be found in U.S. patent application Ser. No. 16/182,542, filed 6 Nov. 2018, which is incorporated by reference.

In particular embodiments, the assistant system 140 may assist a user via an architecture built upon client-side processes and server-side processes which may operate in various operational modes. In FIG. 2, the client-side process is illustrated above the dashed line 202 whereas the server-side process is illustrated below the dashed line 202. A first operational mode (i.e., on-device mode) may be a workflow in which the assistant system 140 processes a user input and provides assistance to the user by primarily or exclusively performing client-side processes locally on the client system 130. For example, if the client system 130 is not connected to a network 110 (i.e., when client system 130 is offline), the assistant system 140 may handle a user input in the first operational mode utilizing only client-side processes. A second operational mode (i.e., cloud mode) may be a workflow in which the assistant system 140 processes a user input and provides assistance to the user by primarily or exclusively performing server-side processes on one or more remote servers (e.g., a server associated with assistant system 140). As illustrated in FIG. 2, a third operational mode (i.e., blended mode) may be a parallel workflow in which the assistant system 140 processes a user input and provides assistance to the user by performing client-side processes locally on the client system 130 in conjunction with server-side processes on one or more remote servers (e.g., a server associated with assistant system 140). For example, the client system 130 and the server associated with assistant system 140 may both perform automatic speech recognition (ASR) and natural-language understanding (NLU) processes, but the client system 130 may delegate dialog, agent, and natural-language generation (NLG) processes to be performed by the server associated with assistant system 140.

In particular embodiments, selection of an operational mode may be based at least in part on a device state, a task associated with a user input, and/or one or more additional factors. As an example and not by way of limitation, as described above, one factor may be a network connectivity status for client system 130. For example, if the client system 130 is not connected to a network 110 (i.e., when client system 130 is offline), the assistant system 140 may handle a user input in the first operational mode (i.e., on-device mode). As another example and not by way of limitation, another factor may be based on a measure of available battery power (i.e., battery status) for the client system 130. For example, if there is a need for client system 130 to conserve battery power (e.g., when client system 130 has minimal available battery power or the user has indicated a desire to conserve the battery power of the client system 130), the assistant system 140 may handle a user input in the second operational mode (i.e., cloud mode) or the third operational mode (i.e., blended mode) in order to perform fewer power-intensive operations on the client system 130. As yet another example and not by way of limitation, another factor may be one or more privacy constraints (e.g., specified privacy settings, applicable privacy policies). For example, if one or more privacy constraints limits or precludes particular data from being transmitted to a remote server (e.g., a server associated with the assistant system 140), the assistant system 140 may handle a user input in the first operational mode (i.e., on-device mode) in order to protect user privacy. As yet another example and not by way of limitation, another factor may be desynchronized context data between the client system 130 and a remote server (e.g., the server associated with assistant system 140). For example, the client system 130 and the server associated with assistant system 140 may be determined to have inconsistent, missing, and/or unreconciled context data, the assistant system 140 may handle a user input in the third operational mode (i.e., blended mode) to reduce the likelihood of an inadequate analysis associated with the user input. As yet another example and not by way of limitation, another factor may be a measure of latency for the connection between client system 130 and a remote server (e.g., the server associated with assistant system 140). For example, if a task associated with a user input may significantly benefit from and/or require prompt or immediate execution (e.g., photo capturing tasks), the assistant system 140 may handle the user input in the first operational mode (i.e., on-device mode) to ensure the task is performed in a timely manner. As yet another example and not by way of limitation, another factor may be, for a feature relevant to a task associated with a user input, whether the feature is only supported by a remote server (e.g., the server associated with assistant system 140). For example, if the relevant feature requires advanced technical functionality (e.g., high-powered processing capabilities, rapid update cycles) that is only supported by the server associated with assistant system 140 and is not supported by client system 130 at the time of the user input, the assistant system 140 may handle the user input in the second operational mode (i.e., cloud mode) or the third operational mode (i.e., blended mode) in order to benefit from the relevant feature.

In particular embodiments, an on-device orchestrator 206 on the client system 130 may coordinate receiving a user input and may determine, at one or more decision points in an example workflow, which of the operational modes described above should be used to process or continue processing the user input. As discussed above, selection of an operational mode may be based at least in part on a device state, a task associated with a user input, and/or one or more additional factors. As an example and not by way of limitation, with reference to the workflow architecture illustrated in FIG. 2, after a user input is received from a user, the on-device orchestrator 206 may determine, at decision point (DO) 205, whether to begin processing the user input in the first operational mode (i.e., on-device mode), the second operational mode (i.e., cloud mode), or the third operational mode (i.e., blended mode). For example, at decision point (DO) 205, the on-device orchestrator 206 may select the first operational mode (i.e., on-device mode) if the client system 130 is not connected to network 110 (i.e., when client system 130 is offline), if one or more privacy constraints expressly require on-device processing (e.g., adding or removing another person to a private call between users), or if the user input is associated with a task which does not require or benefit from server-side processing (e.g., setting an alarm or calling another user). As another example, at decision point (DO) 205, the on-device orchestrator 206 may select the second operational mode (i.e., cloud mode) or the third operational mode (i.e., blended mode) if the client system 130 has a need to conserve battery power (e.g., when client system 130 has minimal available battery power or the user has indicated a desire to conserve the battery power of the client system 130) or has a need to limit additional utilization of computing resources (e.g., when other processes operating on client device 130 require high CPU utilization (e.g., SMS messaging applications)).

In particular embodiments, if the on-device orchestrator 206 determines at decision point (DO) 205 that the user input should be processed using the first operational mode (i.e., on-device mode) or the third operational mode (i.e., blended mode), the client-side process may continue as illustrated in FIG. 2. As an example and not by way of limitation, if the user input comprises speech data, the speech data may be received at a local automatic speech recognition (ASR) module 208a on the client system 130. The ASR module 208a may allow a user to dictate and have speech transcribed as written text, have a document synthesized as an audio stream, or issue commands that are recognized as such by the system.

In particular embodiments, the output of the ASR module 208a may be sent to a local natural-language understanding (NLU) module 210a. The NLU module 210a may perform named entity resolution (NER), or named entity resolution may be performed by the entity resolution module 212a, as described below. In particular embodiments, one or more of an intent, a slot, or a domain may be an output of the NLU module 210a.

In particular embodiments, the user input may comprise non-speech data, which may be received at a local context engine 220a. As an example and not by way of limitation, the non-speech data may comprise locations, visuals, touch, gestures, world updates, social updates, contextual information, information related to people, activity data, and/or any other suitable type of non-speech data. The non-speech data may further comprise sensory data received by client system 130 sensors (e.g., microphone, camera), which may be accessed subject to privacy constraints and further analyzed by computer vision technologies. In particular embodiments, the computer vision technologies may comprise object detection, scene recognition, hand tracking, eye tracking, and/or any other suitable computer vision technologies. In particular embodiments, the non-speech data may be subject to geometric constructions, which may comprise constructing objects surrounding a user using any suitable type of data collected by a client system 130. As an example and not by way of limitation, a user may be wearing AR glasses, and geometric constructions may be utilized to determine spatial locations of surfaces and items (e.g., a floor, a wall, a user's hands). In particular embodiments, the non-speech data may be inertial data captured by AR glasses or a VR headset, and which may be data associated with linear and angular motions (e.g., measurements associated with a user's body movements). In particular embodiments, the context engine 220a may determine various types of events and context based on the non-speech data.

In particular embodiments, the outputs of the NLU module 210a and/or the context engine 220a may be sent to an entity resolution module 212a. The entity resolution module 212a may resolve entities associated with one or more slots output by NLU module 210a. In particular embodiments, each resolved entity may be associated with one or more entity identifiers. As an example and not by way of limitation, an identifier may comprise a unique user identifier (ID) corresponding to a particular user (e.g., a unique username or user ID number for the social-networking system 160). In particular embodiments, each resolved entity may also be associated with a confidence score. More information on resolving entities may be found in U.S. Pat. No. 10,803,050, filed 27 Jul. 2018, and U.S. patent application Ser. No. 16/048,072, filed 27 Jul. 2018, each of which is incorporated by reference.

In particular embodiments, at decision point (DO) 205, the on-device orchestrator 206 may determine that a user input should be handled in the second operational mode (i.e., cloud mode) or the third operational mode (i.e., blended mode). In these operational modes, the user input may be handled by certain server-side modules in a similar manner as the client-side process described above.

In particular embodiments, if the user input comprises speech data, the speech data of the user input may be received at a remote automatic speech recognition (ASR) module 208b on a remote server (e.g., the server associated with assistant system 140). The ASR module 208b may allow a user to dictate and have speech transcribed as written text, have a document synthesized as an audio stream, or issue commands that are recognized as such by the system.

In particular embodiments, the output of the ASR module 208b may be sent to a remote natural-language understanding (NLU) module 210b. In particular embodiments, the NLU module 210b may perform named entity resolution (NER) or named entity resolution may be performed by entity resolution module 212b of dialog manager module 216b as described below. In particular embodiments, one or more of an intent, a slot, or a domain may be an output of the NLU module 210b.

In particular embodiments, the user input may comprise non-speech data, which may be received at a remote context engine 220b. In particular embodiments, the remote context engine 220b may determine various types of events and context based on the non-speech data. In particular embodiments, the output of the NLU module 210b and/or the context engine 220b may be sent to a remote dialog manager 216b.

In particular embodiments, as discussed above, an on-device orchestrator 206 on the client system 130 may coordinate receiving a user input and may determine, at one or more decision points in an example workflow, which of the operational modes described above should be used to process or continue processing the user input. As further discussed above, selection of an operational mode may be based at least in part on a device state, a task associated with a user input, and/or one or more additional factors. As an example and not by way of limitation, with continued reference to the workflow architecture illustrated in FIG. 2, after the entity resolution module 212a generates an output or a null output, the on-device orchestrator 206 may determine, at decision point (D1) 215, whether to continue processing the user input in the first operational mode (i.e., on-device mode), the second operational mode (i.e., cloud mode), or the third operational mode (i.e., blended mode). For example, at decision point (D1) 215, the on-device orchestrator 206 may select the first operational mode (i.e., on-device mode) if an identified intent is associated with a latency sensitive processing task (e.g., taking a photo, pausing a stopwatch). As another example and not by way of limitation, if a messaging task is not supported by on-device processing on the client system 130, the on-device orchestrator 206 may select the third operational mode (i.e., blended mode) to process the user input associated with a messaging request. As yet another example, at decision point (D1) 215, the on-device orchestrator 206 may select the second operational mode (i.e., cloud mode) or the third operational mode (i.e., blended mode) if the task being processed requires access to a social graph, a knowledge graph, or a concept graph not stored on the client system 130. Alternatively, the on-device orchestrator 206 may instead select the first operational mode (i.e., on-device mode) if a sufficient version of an informational graph including requisite information for the task exists on the client system 130 (e.g., a smaller and/or bootstrapped version of a knowledge graph).

In particular embodiments, if the on-device orchestrator 206 determines at decision point (D1) 215 that processing should continue using the first operational mode (i.e., on-device mode) or the third operational mode (i.e., blended mode), the client-side process may continue as illustrated in FIG. 2. As an example and not by way of limitation, the output from the entity resolution module 212a may be sent to an on-device dialog manager 216a. In particular embodiments, the on-device dialog manager 216a may comprise a dialog state tracker 218a and an action selector 222a. The on-device dialog manager 216a may have complex dialog logic and product-related business logic to manage the dialog state and flow of the conversation between the user and the assistant system 140. The on-device dialog manager 216a may include full functionality for end-to-end integration and multi-turn support (e.g., confirmation, disambiguation). The on-device dialog manager 216a may also be lightweight with respect to computing limitations and resources including memory, computation (CPU), and binary size constraints. The on-device dialog manager 216a may also be scalable to improve developer experience. In particular embodiments, the on-device dialog manager 216a may benefit the assistant system 140, for example, by providing offline support to alleviate network connectivity issues (e.g., unstable or unavailable network connections), by using client-side processes to prevent privacy-sensitive information from being transmitted off of client system 130, and by providing a stable user experience in high-latency sensitive scenarios.

In particular embodiments, the on-device dialog manager 216a may further conduct false trigger mitigation. Implementation of false trigger mitigation may detect and prevent false triggers from user inputs which would otherwise invoke the assistant system 140 (e.g., an unintended wake-word) and may further prevent the assistant system 140 from generating data records based on the false trigger that may be inaccurate and/or subject to privacy constraints. As an example and not by way of limitation, if a user is in a voice call, the user's conversation during the voice call may be considered private, and the false trigger mitigation may limit detection of wake-words to audio user inputs received locally by the user's client system 130. In particular embodiments, the on-device dialog manager 216a may implement false trigger mitigation based on a nonsense detector. If the nonsense detector determines with a high confidence that a received wake-word is not logically and/or contextually sensible at the point in time at which it was received from the user, the on-device dialog manager 216a may determine that the user did not intend to invoke the assistant system 140.

In particular embodiments, due to a limited computing power of the client system 130, the on-device dialog manager 216a may conduct on-device learning based on learning algorithms particularly tailored for client system 130. As an example and not by way of limitation, federated learning techniques may be implemented by the on-device dialog manager 216a. Federated learning is a specific category of distributed machine learning techniques which may train machine-learning models using decentralized data stored on end devices (e.g., mobile phones). In particular embodiments, the on-device dialog manager 216a may use federated user representation learning model to extend existing neural-network personalization techniques to implementation of federated learning by the on-device dialog manager 216a. Federated user representation learning may personalize federated learning models by learning task-specific user representations (i.e., embeddings) and/or by personalizing model weights. Federated user representation learning is a simple, scalable, privacy-preserving, and resource-efficient. Federated user representation learning may divide model parameters into federated and private parameters. Private parameters, such as private user embeddings, may be trained locally on a client system 130 instead of being transferred to or averaged by a remote server (e.g., the server associated with assistant system 140). Federated parameters, by contrast, may be trained remotely on the server. In particular embodiments, the on-device dialog manager 216a may use an active federated learning model, which may transmit a global model trained on the remote server to client systems 130 and calculate gradients locally on the client systems 130. Active federated learning may enable the on-device dialog manager 216a to minimize the transmission costs associated with downloading models and uploading gradients. For active federated learning, in each round, client systems 130 may be selected in a semi-random manner based at least in part on a probability conditioned on the current model and the data on the client systems 130 in order to optimize efficiency for training the federated learning model.

In particular embodiments, the dialog state tracker 218a may track state changes over time as a user interacts with the world and the assistant system 140 interacts with the user. As an example and not by way of limitation, the dialog state tracker 218a may track, for example, what the user is talking about, whom the user is with, where the user is, what tasks are currently in progress, and where the user's gaze is at subject to applicable privacy policies.

In particular embodiments, at decision point (D1) 215, the on-device orchestrator 206 may determine to forward the user input to the server for either the second operational mode (i.e., cloud mode) or the third operational mode (i.e., blended mode). As an example and not by way of limitation, if particular functionalities or processes (e.g., messaging) are not supported by on the client system 130, the on-device orchestrator 206 may determine at decision point (D1) 215 to use the third operational mode (i.e., blended mode). In particular embodiments, the on-device orchestrator 206 may cause the outputs from the NLU module 210a, the context engine 220a, and the entity resolution module 212a, via a dialog manager proxy 224, to be forwarded to an entity resolution module 212b of the remote dialog manager 216b to continue the processing. The dialog manager proxy 224 may be a communication channel for information/events exchange between the client system 130 and the server. In particular embodiments, the dialog manager 216b may additionally comprise a remote arbitrator 226b, a remote dialog state tracker 218b, and a remote action selector 222b. In particular embodiments, the assistant system 140 may have started processing a user input with the second operational mode (i.e., cloud mode) at decision point (DO) 205 and the on-device orchestrator 206 may determine to continue processing the user input based on the second operational mode (i.e., cloud mode) at decision point (D1) 215. Accordingly, the output from the NLU module 210b and the context engine 220b may be received at the remote entity resolution module 212b. The remote entity resolution module 212b may have similar functionality as the local entity resolution module 212a, which may comprise resolving entities associated with the slots. In particular embodiments, the entity resolution module 212b may access one or more of the social graph, the knowledge graph, or the concept graph when resolving the entities. The output from the entity resolution module 212b may be received at the arbitrator 226b.

In particular embodiments, the remote arbitrator 226b may be responsible for choosing between client-side and server-side upstream results (e.g., results from the NLU module 210a/b, results from the entity resolution module 212a/b, and results from the context engine 220a/b). The arbitrator 226b may send the selected upstream results to the remote dialog state tracker 218b. In particular embodiments, similarly to the local dialog state tracker 218a, the remote dialog state tracker 218b may convert the upstream results into candidate tasks using task specifications and resolve arguments with entity resolution.

In particular embodiments, at decision point (D2) 225, the on-device orchestrator 206 may determine whether to continue processing the user input based on the first operational mode (i.e., on-device mode) or forward the user input to the server for the third operational mode (i.e., blended mode). The decision may depend on, for example, whether the client-side process is able to resolve the task and slots successfully, whether there is a valid task policy with a specific feature support, and/or the context differences between the client-side process and the server-side process. In particular embodiments, decisions made at decision point (D2) 225 may be for multi-turn scenarios. In particular embodiments, there may be at least two possible scenarios. In a first scenario, the assistant system 140 may have started processing a user input in the first operational mode (i.e., on-device mode) using client-side dialog state. If at some point the assistant system 140 decides to switch to having the remote server process the user input, the assistant system 140 may create a programmatic/predefined task with the current task state and forward it to the remote server. For subsequent turns, the assistant system 140 may continue processing in the third operational mode (i.e., blended mode) using the server-side dialog state. In another scenario, the assistant system 140 may have started processing the user input in either the second operational mode (i.e., cloud mode) or the third operational mode (i.e., blended mode) and may substantially rely on server-side dialog state for all subsequent turns. If the on-device orchestrator 206 determines to continue processing the user input based on the first operational mode (i.e., on-device mode), the output from the dialog state tracker 218a may be received at the action selector 222a.

In particular embodiments, at decision point (D2) 225, the on-device orchestrator 206 may determine to forward the user input to the remote server and continue processing the user input in either the second operational mode (i.e., cloud mode) or the third operational mode (i.e., blended mode). The assistant system 140 may create a programmatic/predefined task with the current task state and forward it to the server, which may be received at the action selector 222b. In particular embodiments, the assistant system 140 may have started processing the user input in the second operational mode (i.e., cloud mode), and the on-device orchestrator 206 may determine to continue processing the user input in the second operational mode (i.e., cloud mode) at decision point (D2) 225. Accordingly, the output from the dialog state tracker 218b may be received at the action selector 222b.

In particular embodiments, the action selector 222a/b may perform interaction management. The action selector 222a/b may determine and trigger a set of general executable actions. The actions may be executed either on the client system 130 or at the remote server. As an example and not by way of limitation, these actions may include providing information or suggestions to the user. In particular embodiments, the actions may interact with agents 228a/b, users, and/or the assistant system 140 itself. These actions may comprise actions including one or more of a slot request, a confirmation, a disambiguation, or an agent execution. The actions may be independent of the underlying implementation of the action selector 222a/b. For more complicated scenarios such as, for example, multi-turn tasks or tasks with complex business logic, the local action selector 222a may call one or more local agents 228a, and the remote action selector 222b may call one or more remote agents 228b to execute the actions. Agents 228a/b may be invoked via task ID, and any actions may be routed to the correct agent 228a/b using that task ID. In particular embodiments, an agent 228a/b may be configured to serve as a broker across a plurality of content providers for one domain. A content provider may be an entity responsible for carrying out an action associated with an intent or completing a task associated with the intent. In particular embodiments, agents 228a/b may provide several functionalities for the assistant system 140 including, for example, native template generation, task specific business logic, and querying external APIs. When executing actions for a task, agents 228a/b may use context from the dialog state tracker 218a/b, and may also update the dialog state tracker 218a/b. In particular embodiments, agents 228a/b may also generate partial payloads from a dialog act.

In particular embodiments, the local agents 228a may have different implementations to be compiled/registered for different platforms (e.g., smart glasses versus a VR headset). In particular embodiments, multiple device-specific implementations (e.g., real-time calls for a client system 130 or a messaging application on the client system 130) may be handled internally by a single agent 228a. Alternatively, device-specific implementations may be handled by multiple agents 228a associated with multiple domains. As an example and not by way of limitation, calling an agent 228a on smart glasses may be implemented in a different manner than calling an agent 228a on a smart phone. Different platforms may also utilize varying numbers of agents 228a. The agents 228a may also be cross-platform (i.e., different operating systems on the client system 130). In addition, the agents 228a may have minimized startup time or binary size impact. Local agents 228a may be suitable for particular use cases. As an example and not by way of limitation, one use case may be emergency calling on the client system 130. As another example and not by way of limitation, another use case may be responding to a user input without network connectivity. As yet another example and not by way of limitation, another use case may be that particular domains/tasks may be privacy sensitive and may prohibit user inputs being sent to the remote server.

In particular embodiments, the local action selector 222a may call a local delivery system 230a for executing the actions, and the remote action selector 222b may call a remote delivery system 230b for executing the actions. The delivery system 230a/b may deliver a predefined event upon receiving triggering signals from the dialog state tracker 218a/b by executing corresponding actions. The delivery system 230a/b may ensure that events get delivered to a host with a living connection. As an example and not by way of limitation, the delivery system 230a/b may broadcast to all online devices that belong to one user. As another example and not by way of limitation, the delivery system 230a/b may deliver events to target-specific devices. The delivery system 230a/b may further render a payload using up-to-date device context.

In particular embodiments, the on-device dialog manager 216a may additionally comprise a separate local action execution module, and the remote dialog manager 216b may additionally comprise a separate remote action execution module. The local execution module and the remote action execution module may have similar functionality. In particular embodiments, the action execution module may call the agents 228a/b to execute tasks. The action execution module may additionally perform a set of general executable actions determined by the action selector 222a/b. The set of executable actions may interact with agents 228a/b, users, and the assistant system 140 itself via the delivery system 230a/b.

In particular embodiments, if the user input is handled using the first operational mode (i.e., on-device mode), results from the agents 228a and/or the delivery system 230a may be returned to the on-device dialog manager 216a. The on-device dialog manager 216a may then instruct a local arbitrator 226a to generate a final response based on these results. The arbitrator 226a may aggregate the results and evaluate them. As an example and not by way of limitation, the arbitrator 226a may rank and select a best result for responding to the user input. If the user request is handled in the second operational mode (i.e., cloud mode), the results from the agents 228b and/or the delivery system 230b may be returned to the remote dialog manager 216b. The remote dialog manager 216b may instruct, via the dialog manager proxy 224, the arbitrator 226a to generate the final response based on these results. Similarly, the arbitrator 226a may analyze the results and select the best result to provide to the user. If the user input is handled based on the third operational mode (i.e., blended mode), the client-side results and server-side results (e.g., from agents 228a/b and/or delivery system 230a/b) may both be provided to the arbitrator 226a by the on-device dialog manager 216a and remote dialog manager 216b, respectively. The arbitrator 226 may then choose between the client-side and server-side side results to determine the final result to be presented to the user. In particular embodiments, the logic to decide between these results may depend on the specific use-case.

In particular embodiments, the local arbitrator 226a may generate a response based on the final result and send it to a render output module 232. The render output module 232 may determine how to render the output in a way that is suitable for the client system 130. As an example and not by way of limitation, for a VR headset or AR smart glasses, the render output module 232 may determine to render the output using a visual-based modality (e.g., an image or a video clip) that may be displayed via the VR headset or AR smart glasses. As another example, the response may be rendered as audio signals that may be played by the user via a VR headset or AR smart glasses. As yet another example, the response may be rendered as augmented-reality data for enhancing user experience.

In particular embodiments, in addition to determining an operational mode to process the user input, the on-device orchestrator 206 may also determine whether to process the user input on the rendering device 137, process the user input on the companion device 138, or process the user request on the remote server. The rendering device 137 and/or the companion device 138 may each use the assistant stack in a similar manner as disclosed above to process the user input. As an example and not by, the on-device orchestrator 206 may determine that part of the processing should be done on the rendering device 137, part of the processing should be done on the companion device 138, and the remaining processing should be done on the remote server.

In particular embodiments, the assistant system 140 may have a variety of capabilities including audio cognition, visual cognition, signals intelligence, reasoning, and memories. In particular embodiments, the capability of audio cognition may enable the assistant system 140 to, for example, understand a user's input associated with various domains in different languages, understand and summarize a conversation, perform on-device audio cognition for complex commands, identify a user by voice, extract topics from a conversation and auto-tag sections of the conversation, enable audio interaction without a wake-word, filter and amplify user voice from ambient noise and conversations, and/or understand which client system 130 a user is talking to if multiple client systems 130 are in vicinity.

In particular embodiments, the capability of visual cognition may enable the assistant system 140 to, for example, recognize interesting objects in the world through a combination of existing machine-learning models and one-shot learning, recognize an interesting moment and auto-capture it, achieve semantic understanding over multiple visual frames across different episodes of time, provide platform support for additional capabilities in places or objects recognition, recognize a full set of settings and micro-locations including personalized locations, recognize complex activities, recognize complex gestures to control a client system 130, handle images/videos from egocentric cameras (e.g., with motion, capture angles, resolution), accomplish similar levels of accuracy and speed regarding images with lower resolution, conduct one-shot registration and recognition of places and objects, and/or perform visual recognition on a client system 130.

In particular embodiments, the assistant system 140 may leverage computer vision techniques to achieve visual cognition. Besides computer vision techniques, the assistant system 140 may explore options that may supplement these techniques to scale up the recognition of objects. In particular embodiments, the assistant system 140 may use supplemental signals such as, for example, optical character recognition (OCR) of an object's labels, GPS signals for places recognition, and/or signals from a user's client system 130 to identify the user. In particular embodiments, the assistant system 140 may perform general scene recognition (e.g., home, work, public spaces) to set a context for the user and reduce the computer-vision search space to identify likely objects or people. In particular embodiments, the assistant system 140 may guide users to train the assistant system 140. For example, crowdsourcing may be used to get users to tag objects and help the assistant system 140 recognize more objects over time. As another example, users may register their personal objects as part of an initial setup when using the assistant system 140. The assistant system 140 may further allow users to provide positive/negative signals for objects they interact with to train and improve personalized models for them.

In particular embodiments, the capability of signals intelligence may enable the assistant system 140 to, for example, determine user location, understand date/time, determine family locations, understand users' calendars and future desired locations, integrate richer sound understanding to identify setting/context through sound alone, and/or build signals intelligence models at runtime which may be personalized to a user's individual routines.

In particular embodiments, the capability of reasoning may enable the assistant system 140 to, for example, pick up previous conversation threads at any point in the future, synthesize all signals to understand micro and personalized context, learn interaction patterns and preferences from users' historical behavior and accurately suggest interactions that they may value, generate highly predictive proactive suggestions based on micro-context understanding, understand what content a user may want to see at what time of a day, and/or understand the changes in a scene and how that may impact the user's desired content.

In particular embodiments, the capabilities of memories may enable the assistant system 140 to, for example, remember which social connections a user previously called or interacted with, write into memory and query memory at will (i.e., open dictation and auto tags), extract richer preferences based on prior interactions and long-term learning, remember a user's life history, extract rich information from egocentric streams of data and auto catalog, and/or write to memory in structured form to form rich short, episodic and long-term memories.

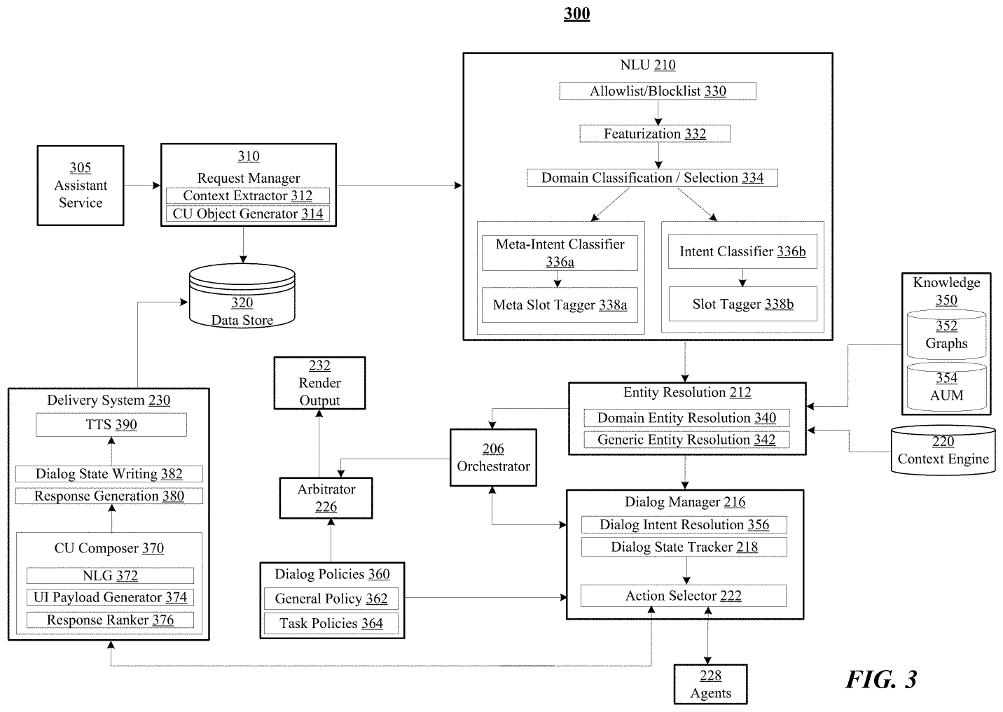

FIG. 3 illustrates an example flow diagram 300 of the assistant system 140. In particular embodiments, an assistant service module 305 may access a request manager 310 upon receiving a user input. In particular embodiments, the request manager 310 may comprise a context extractor 312 and a conversational understanding object generator (CU object generator) 314. The context extractor 312 may extract contextual information associated with the user input. The context extractor 312 may also update contextual information based on the assistant application 136 executing on the client system 130. As an example and not by way of limitation, the update of contextual information may comprise content items are displayed on the client system 130. As another example and not by way of limitation, the update of contextual information may comprise whether an alarm is set on the client system 130. As another example and not by way of limitation, the update of contextual information may comprise whether a song is playing on the client system 130. The CU object generator 314 may generate particular CU objects relevant to the user input. The CU objects may comprise dialog-session data and features associated with the user input, which may be shared with all the modules of the assistant system 140. In particular embodiments, the request manager 310 may store the contextual information and the generated CU objects in a data store 320 which is a particular data store implemented in the assistant system 140.

In particular embodiments, the request manger 310 may send the generated CU objects to the NLU module 210. The NLU module 210 may perform a plurality of steps to process the CU objects. The NLU module 210 may first run the CU objects through an allowlist/blocklist 330. In particular embodiments, the allowlist/blocklist 330 may comprise interpretation data matching the user input. The NLU module 210 may then perform a featurization 332 of the CU objects. The NLU module 210 may then perform domain classification/selection 334 on user input based on the features resulted from the featurization 332 to classify the user input into predefined domains. In particular embodiments, a domain may denote a social context of interaction (e.g., education), or a namespace for a set of intents (e.g., music). The domain classification/selection results may be further processed based on two related procedures. In one procedure, the NLU module 210 may process the domain classification/selection results using a meta-intent classifier 336a. The meta-intent classifier 336a may determine categories that describe the user's intent. An intent may be an element in a pre-defined taxonomy of semantic intentions, which may indicate a purpose of a user interaction with the assistant system 140. The NLU module 210a may classify a user input into a member of the pre-defined taxonomy. For example, the user input may be “Play Beethoven's 5th,” and the NLU module 210a may classify the input as having the intent [IN:play_music]. In particular embodiments, intents that are common to multiple domains may be processed by the meta-intent classifier 336a. As an example and not by way of limitation, the meta-intent classifier 336a may be based on a machine-learning model that may take the domain classification/selection results as input and calculate a probability of the input being associated with a particular predefined meta-intent. The NLU module 210 may then use a meta slot tagger 338a to annotate one or more meta slots for the classification result from the meta-intent classifier 336a. A slot may be a named sub-string corresponding to a character string within the user input representing a basic semantic entity. For example, a slot for “pizza” may be [SL:dish]. In particular embodiments, a set of valid or expected named slots may be conditioned on the classified intent. As an example and not by way of limitation, for the intent [IN:play_music], a valid slot may be [SL:song_name]. In particular embodiments, the meta slot tagger 338a may tag generic slots such as references to items (e.g., the first), the type of slot, the value of the slot, etc. In particular embodiments, the NLU module 210 may process the domain classification/selection results using an intent classifier 336b. The intent classifier 336b may determine the user's intent associated with the user input. In particular embodiments, there may be one intent classifier 336b for each domain to determine the most possible intents in a given domain. As an example and not by way of limitation, the intent classifier 336b may be based on a machine-learning model that may take the domain classification/selection results as input and calculate a probability of the input being associated with a particular predefined intent. The NLU module 210 may then use a slot tagger 338b to annotate one or more slots associated with the user input. In particular embodiments, the slot tagger 338b may annotate the one or more slots for the n-grams of the user input. As an example and not by way of limitation, a user input may comprise “change 500 dollars in my account to Japanese yen.” The intent classifier 336b may take the user input as input and formulate it into a vector. The intent classifier 336b may then calculate probabilities of the user input being associated with different predefined intents based on a vector comparison between the vector representing the user input and the vectors representing different predefined intents. In a similar manner, the slot tagger 338b may take the user input as input and formulate each word into a vector. The slot tagger 338b may then calculate probabilities of each word being associated with different predefined slots based on a vector comparison between the vector representing the word and the vectors representing different predefined slots. The intent of the user may be classified as “changing money”. The slots of the user input may comprise “500”, “dollars”, “account”, and “Japanese yen”. The meta-intent of the user may be classified as “financial service”. The meta slot may comprise “finance”.

In particular embodiments, the natural-language understanding (NLU) module 210 may additionally extract information from one or more of a social graph, a knowledge graph, or a concept graph, and may retrieve a user's profile stored locally on the client system 130. The NLU module 210 may additionally consider contextual information when analyzing the user input. The NLU module 210 may further process information from these different sources by identifying and aggregating information, annotating n-grams of the user input, ranking the n-grams with confidence scores based on the aggregated information, and formulating the ranked n-grams into features that may be used by the NLU module 210 for understanding the user input. In particular embodiments, the NLU module 210 may identify one or more of a domain, an intent, or a slot from the user input in a personalized and context-aware manner. As an example and not by way of limitation, a user input may comprise “show me how to get to the coffee shop.” The NLU module 210 may identify a particular coffee shop that the user wants to go to based on the user's personal information and the associated contextual information. In particular embodiments, the NLU module 210 may comprise a lexicon of a particular language, a parser, and grammar rules to partition sentences into an internal representation. The NLU module 210 may also comprise one or more programs that perform naive semantics or stochastic semantic analysis, and may further use pragmatics to understand a user input. In particular embodiments, the parser may be based on a deep learning architecture comprising multiple long-short term memory (LSTM) networks. As an example and not by way of limitation, the parser may be based on a recurrent neural network grammar (RNNG) model, which is a type of recurrent and recursive LSTM algorithm. More information on natural-language understanding (NLU) may be found in U.S. patent application Ser. No. 16/011,062, filed 18 Jun. 2018, U.S. patent application Ser. No. 16/025,317, filed 2 Jul. 2018, and U.S. patent application Ser. No. 16/038,120, filed 17 Jul. 2018, each of which is incorporated by reference.

In particular embodiments, the output of the NLU module 210 may be sent to the entity resolution module 212 to resolve relevant entities. Entities may include, for example, unique users or concepts, each of which may have a unique identifier (ID). The entities may include one or more of a real-world entity (from general knowledge base), a user entity (from user memory), a contextual entity (device context/dialog context), or a value resolution (numbers, datetime, etc.). In particular embodiments, the entity resolution module 212 may comprise domain entity resolution 340 and generic entity resolution 342. The entity resolution module 212 may execute generic and domain-specific entity resolution. The generic entity resolution 342 may resolve the entities by categorizing the slots and meta slots into different generic topics. The domain entity resolution 340 may resolve the entities by categorizing the slots and meta slots into different domains. As an example and not by way of limitation, in response to the input of an inquiry of the advantages of a particular brand of electric car, the generic entity resolution 342 may resolve the referenced brand of electric car as vehicle and the domain entity resolution 340 may resolve the referenced brand of electric car as electric car.

In particular embodiments, entities may be resolved based on knowledge 350 about the world and the user. The assistant system 140 may extract ontology data from the graphs 352. As an example and not by way of limitation, the graphs 352 may comprise one or more of a knowledge graph, a social graph, or a concept graph. The ontology data may comprise the structural relationship between different slots/meta-slots and domains. The ontology data may also comprise information of how the slots/meta-slots may be grouped, related within a hierarchy where the higher level comprises the domain, and subdivided according to similarities and differences. For example, the knowledge graph may comprise a plurality of entities. Each entity may comprise a single record associated with one or more attribute values. The particular record may be associated with a unique entity identifier. Each record may have diverse values for an attribute of the entity. Each attribute value may be associated with a confidence probability and/or a semantic weight. A confidence probability for an attribute value represents a probability that the value is accurate for the given attribute. A semantic weight for an attribute value may represent how the value semantically appropriate for the given attribute considering all the available information. For example, the knowledge graph may comprise an entity of a book titled “BookName”, which may include information extracted from multiple content sources (e.g., an online social network, online encyclopedias, book review sources, media databases, and entertainment content sources), which may be deduped, resolved, and fused to generate the single unique record for the knowledge graph. In this example, the entity titled “BookName” may be associated with a “fantasy” attribute value for a “genre” entity attribute. More information on the knowledge graph may be found in U.S. patent application Ser. No. 16/048,049, filed 27 Jul. 2018, and U.S. patent application Ser. No. 16/048,101, filed 27 Jul. 2018, each of which is incorporated by reference.

In particular embodiments, the assistant user memory (AUM) 354 may comprise user episodic memories which help determine how to assist a user more effectively. The AUM 354 may be the central place for storing, retrieving, indexing, and searching over user data. As an example and not by way of limitation, the AUM 354 may store information such as contacts, photos, reminders, etc. Additionally, the AUM 354 may automatically synchronize data to the server and other devices (only for non-sensitive data). As an example and not by way of limitation, if the user sets a nickname for a contact on one device, all devices may synchronize and get that nickname based on the AUM 354. In particular embodiments, the AUM 354 may first prepare events, user state, reminder, and trigger state for storing in a data store. Memory node identifiers (ID) may be created to store entry objects in the AUM 354, where an entry may be some piece of information about the user (e.g., photo, reminder, etc.) As an example and not by way of limitation, the first few bits of the memory node ID may indicate that this is a memory node ID type, the next bits may be the user ID, and the next bits may be the time of creation. The AUM 354 may then index these data for retrieval as needed. Index ID may be created for such purpose. In particular embodiments, given an “index key” (e.g., PHOTO_LOCATION) and “index value” (e.g., “San Francisco”), the AUM 354 may get a list of memory IDs that have that attribute (e.g., photos in San Francisco). As an example and not by way of limitation, the first few bits may indicate this is an index ID type, the next bits may be the user ID, and the next bits may encode an “index key” and “index value”. The AUM 354 may further conduct information retrieval with a flexible query language. Relation index ID may be created for such purpose. In particular embodiments, given a source memory node and an edge type, the AUM 354 may get memory IDs of all target nodes with that type of outgoing edge from the source. As an example and not by way of limitation, the first few bits may indicate this is a relation index ID type, the next bits may be the user ID, and the next bits may be a source node ID and edge type. In particular embodiments, the AUM 354 may help detect concurrent updates of different events. More information on episodic memories may be found in U.S. patent application Ser. No. 16/552,559, filed 27 Aug. 2019, which is incorporated by reference.

In particular embodiments, the entity resolution module 212 may use different techniques to resolve different types of entities. For real-world entities, the entity resolution module 212 may use a knowledge graph to resolve the span to the entities, such as “music track”, “movie”, etc. For user entities, the entity resolution module 212 may use user memory or some agents to resolve the span to user-specific entities, such as “contact”, “reminders”, or “relationship”. For contextual entities, the entity resolution module 212 may perform coreference based on information from the context engine 220 to resolve the references to entities in the context, such as “him”, “her”, “the first one”, or “the last one”. In particular embodiments, for coreference, the entity resolution module 212 may create references for entities determined by the NLU module 210. The entity resolution module 212 may then resolve these references accurately. As an example and not by way of limitation, a user input may comprise “find me the nearest grocery store and direct me there”. Based on coreference, the entity resolution module 212 may interpret “there” as “the nearest grocery store”. In particular embodiments, coreference may depend on the information from the context engine 220 and the dialog manager 216 so as to interpret references with improved accuracy. In particular embodiments, the entity resolution module 212 may additionally resolve an entity under the context (device context or dialog context), such as, for example, the entity shown on the screen or an entity from the last conversation history. For value resolutions, the entity resolution module 212 may resolve the mention to exact value in standardized form, such as numerical value, date time, address, etc.

In particular embodiments, the entity resolution module 212 may first perform a check on applicable privacy constraints in order to guarantee that performing entity resolution does not violate any applicable privacy policies. As an example and not by way of limitation, an entity to be resolved may be another user who specifies in their privacy settings that their identity should not be searchable on the online social network. In this case, the entity resolution module 212 may refrain from returning that user's entity identifier in response to a user input. By utilizing the described information obtained from the social graph, the knowledge graph, the concept graph, and the user profile, and by complying with any applicable privacy policies, the entity resolution module 212 may resolve entities associated with a user input in a personalized, context-aware, and privacy-protected manner.

In particular embodiments, the entity resolution module 212 may work with the ASR module 208 to perform entity resolution. The following example illustrates how the entity resolution module 212 may resolve an entity name. The entity resolution module 212 may first expand names associated with a user into their respective normalized text forms as phonetic consonant representations which may be phonetically transcribed using a double metaphone algorithm. The entity resolution module 212 may then determine an n-best set of candidate transcriptions and perform a parallel comprehension process on all of the phonetic transcriptions in the n-best set of candidate transcriptions. In particular embodiments, each transcription that resolves to the same intent may then be collapsed into a single intent. Each intent may then be assigned a score corresponding to the highest scoring candidate transcription for that intent. During the collapse, the entity resolution module 212 may identify various possible text transcriptions associated with each slot, correlated by boundary timing offsets associated with the slot's transcription. The entity resolution module 212 may then extract a subset of possible candidate transcriptions for each slot from a plurality (e.g., 1000) of candidate transcriptions, regardless of whether they are classified to the same intent. In this manner, the slots and intents may be scored lists of phrases. In particular embodiments, a new or running task capable of handling the intent may be identified and provided with the intent (e.g., a message composition task for an intent to send a message to another user). The identified task may then trigger the entity resolution module 212 by providing it with the scored lists of phrases associated with one of its slots and the categories against which it should be resolved. As an example and not by way of limitation, if an entity attribute is specified as “friend,” the entity resolution module 212 may run every candidate list of terms through the same expansion that may be run at matcher compilation time. Each candidate expansion of the terms may be matched in the precompiled trie matching structure. Matches may be scored using a function based at least in part on the transcribed input, matched form, and friend name. As another example and not by way of limitation, if an entity attribute is specified as “celebrity/notable person,” the entity resolution module 212 may perform parallel searches against the knowledge graph for each candidate set of terms for the slot output from the ASR module 208. The entity resolution module 212 may score matches based on matched person popularity and ASR-provided score signal. In particular embodiments, when the memory category is specified, the entity resolution module 212 may perform the same search against user memory. The entity resolution module 212 may crawl backward through user memory and attempt to match each memory (e.g., person recently mentioned in conversation, or seen and recognized via visual signals, etc.). For each entity, the entity resolution module 212 may employ matching similarly to how friends are matched (i.e., phonetic). In particular embodiments, scoring may comprise a temporal decay factor associated with a recency with which the name was previously mentioned. The entity resolution module 212 may further combine, sort, and dedupe all matches. In particular embodiments, the task may receive the set of candidates. When multiple high scoring candidates are present, the entity resolution module 212 may perform user-facilitated disambiguation (e.g., getting real-time user feedback from users on these candidates).

In particular embodiments, the context engine 220 may help the entity resolution module 212 improve entity resolution. The context engine 220 may comprise offline aggregators and an online inference service. The offline aggregators may process a plurality of data associated with the user that are collected from a prior time window. As an example and not by way of limitation, the data may include news feed posts/comments, interactions with news feed posts/comments, search history, etc., that are collected during a predetermined timeframe (e.g., from a prior 90-day window). The processing result may be stored in the context engine 220 as part of the user profile. The user profile of the user may comprise user profile data including demographic information, social information, and contextual information associated with the user. The user profile data may also include user interests and preferences on a plurality of topics, aggregated through conversations on news feed, search logs, messaging platforms, etc. The usage of a user profile may be subject to privacy constraints to ensure that a user's information can be used only for his/her benefit, and not shared with anyone else. More information on user profiles may be found in U.S. patent application Ser. No. 15/967,239, filed 30 Apr. 2018, which is incorporated by reference. In particular embodiments, the online inference service may analyze the conversational data associated with the user that are received by the assistant system 140 at a current time. The analysis result may be stored in the context engine 220 also as part of the user profile. In particular embodiments, both the offline aggregators and online inference service may extract personalization features from the plurality of data. The extracted personalization features may be used by other modules of the assistant system 140 to better understand user input. In particular embodiments, the entity resolution module 212 may process the information from the context engine 220 (e.g., a user profile) in the following steps based on natural-language processing (NLP). In particular embodiments, the entity resolution module 212 may tokenize text by text normalization, extract syntax features from text, and extract semantic features from text based on NLP. The entity resolution module 212 may additionally extract features from contextual information, which is accessed from dialog history between a user and the assistant system 140. The entity resolution module 212 may further conduct global word embedding, domain-specific embedding, and/or dynamic embedding based on the contextual information. The processing result may be annotated with entities by an entity tagger. Based on the annotations, the entity resolution module 212 may generate dictionaries. In particular embodiments, the dictionaries may comprise global dictionary features which can be updated dynamically offline. The entity resolution module 212 may rank the entities tagged by the entity tagger. In particular embodiments, the entity resolution module 212 may communicate with different graphs 352 including one or more of the social graph, the knowledge graph, or the concept graph to extract ontology data that is relevant to the retrieved information from the context engine 220. In particular embodiments, the entity resolution module 212 may further resolve entities based on the user profile, the ranked entities, and the information from the graphs 352.

In particular embodiments, the entity resolution module 212 may be driven by the task (corresponding to an agent 228). This inversion of processing order may make it possible for domain knowledge present in a task to be applied to pre-filter or bias the set of resolution targets when it is obvious and appropriate to do so. As an example and not by way of limitation, for the utterance “who is John?” no clear category is implied in the utterance. Therefore, the entity resolution module 212 may resolve “John” against everything. As another example and not by way of limitation, for the utterance “send a message to John”, the entity resolution module 212 may easily determine “John” refers to a person that one can message. As a result, the entity resolution module 212 may bias the resolution to a friend. As another example and not by way of limitation, for the utterance “what is John's most famous album?” To resolve “John”, the entity resolution module 212 may first determine the task corresponding to the utterance, which is finding a music album. The entity resolution module 212 may determine that entities related to music albums include singers, producers, and recording studios. Therefore, the entity resolution module 212 may search among these types of entities in a music domain to resolve “John.”

In particular embodiments, the output of the entity resolution module 212 may be sent to the dialog manager 216 to advance the flow of the conversation with the user. The dialog manager 216 may be an asynchronous state machine that repeatedly updates the state and selects actions based on the new state. The dialog manager 216 may additionally store previous conversations between the user and the assistant system 140. In particular embodiments, the dialog manager 216 may conduct dialog optimization. Dialog optimization relates to the challenge of understanding and identifying the most likely branching options in a dialog with a user. As an example and not by way of limitation, the assistant system 140 may implement dialog optimization techniques to obviate the need to confirm who a user wants to call because the assistant system 140 may determine a high confidence that a person inferred based on context and available data is the intended recipient. In particular embodiments, the dialog manager 216 may implement reinforcement learning frameworks to improve the dialog optimization. The dialog manager 216 may comprise dialog intent resolution 356, the dialog state tracker 218, and the action selector 222. In particular embodiments, the dialog manager 216 may execute the selected actions and then call the dialog state tracker 218 again until the action selected requires a user response, or there are no more actions to execute. Each action selected may depend on the execution result from previous actions. In particular embodiments, the dialog intent resolution 356 may resolve the user intent associated with the current dialog session based on dialog history between the user and the assistant system 140. The dialog intent resolution 356 may map intents determined by the NLU module 210 to different dialog intents. The dialog intent resolution 356 may further rank dialog intents based on signals from the NLU module 210, the entity resolution module 212, and dialog history between the user and the assistant system 140.

In particular embodiments, the dialog state tracker 218 may use a set of operators to track the dialog state. The operators may comprise necessary data and logic to update the dialog state. Each operator may act as delta of the dialog state after processing an incoming user input. In particular embodiments, the dialog state tracker 218 may a comprise a task tracker, which may be based on task specifications and different rules. The dialog state tracker 218 may also comprise a slot tracker and coreference component, which may be rule based and/or recency based. The coreference component may help the entity resolution module 212 to resolve entities. In alternative embodiments, with the coreference component, the dialog state tracker 218 may replace the entity resolution module 212 and may resolve any references/mentions and keep track of the state. In particular embodiments, the dialog state tracker 218 may convert the upstream results into candidate tasks using task specifications and resolve arguments with entity resolution. Both user state (e.g., user's current activity) and task state (e.g., triggering conditions) may be tracked. Given the current state, the dialog state tracker 218 may generate candidate tasks the assistant system 140 may process and perform for the user. As an example and not by way of limitation, candidate tasks may include “show suggestion,” “get weather information,” or “take photo.” In particular embodiments, the dialog state tracker 218 may generate candidate tasks based on available data from, for example, a knowledge graph, a user memory, and a user task history. In particular embodiments, the dialog state tracker 218 may then resolve the triggers object using the resolved arguments. As an example and not by way of limitation, a user input “remind me to call mom when she's online and I'm home tonight” may perform the conversion from the NLU output to the triggers representation by the dialog state tracker 218 as illustrated in Table 1 below:

TABLE 1
Example Conversion from NLU Output to Triggers Representation

| NLU Ontology | | Triggers |
|---|---|---|
| Representation: | | Representation: |
| [IN:CREATE_SMART_REMINDER | → | Triggers: { |
| Remind me to | | andTriggers: [ |
| [SL:TODO call mom] when | | condition: {ContextualEvent(mom is |
| [SL:TRIGGER_CONJUNCTION | | online)}, |
| [IN:GET_TRIGGER | | condition: {ContextualEvent(location is |
| [SL:TRIGGER_SOCIAL_UPDATE | | home)}, |
| she's online] and I'm | | condition: {ContextualEvent(time is |
| [SL:TRIGGER_LOCATION home] | | tonight)}]))]} |
| [SL:DATE_TIME tonight] | | |
| ] | | |
| ] | | |
| ] | | |

In the above example, “mom,” “home,” and “tonight” are represented by their respective entities: personEntity, locationEntity, datetimeEntity.

In particular embodiments, the dialog manager 216 may map events determined by the context engine 220 to actions. As an example and not by way of limitation, an action may be a natural-language generation (NLG) action, a display or overlay, a device action, or a retrieval action. The dialog manager 216 may also perform context tracking and interaction management. Context tracking may comprise aggregating real-time stream of events into a unified user state. Interaction management may comprise selecting optimal action in each state. In particular embodiments, the dialog state tracker 218 may perform context tracking (i.e., tracking events related to the user). To support processing of event streams, the dialog state tracker 218a may use an event handler (e.g., for disambiguation, confirmation, request) that may consume various types of events and update an internal assistant state. Each event type may have one or more handlers. Each event handler may be modifying a certain slice of the assistant state. In particular embodiments, the event handlers may be operating on disjoint subsets of the state (i.e., only one handler may have write-access to a particular field in the state). In particular embodiments, all event handlers may have an opportunity to process a given event. As an example and not by way of limitation, the dialog state tracker 218 may run all event handlers in parallel on every event, and then may merge the state updates proposed by each event handler (e.g., for each event, most handlers may return a NULL update).

In particular embodiments, the dialog state tracker 218 may work as any programmatic handler (logic) that requires versioning. In particular embodiments, instead of directly altering the dialog state, the dialog state tracker 218 may be a side-effect free component and generate n-best candidates of dialog state update operators that propose updates to the dialog state. The dialog state tracker 218 may comprise intent resolvers containing logic to handle different types of NLU intent based on the dialog state and generate the operators. In particular embodiments, the logic may be organized by intent handler, such as a disambiguation intent handler to handle the intents when the assistant system 140 asks for disambiguation, a confirmation intent handler that comprises the logic to handle confirmations, etc. Intent resolvers may combine the turn intent together with the dialog state to generate the contextual updates for a conversation with the user. A slot resolution component may then recursively resolve the slots in the update operators with resolution providers including the knowledge graph and domain agents. In particular embodiments, the dialog state tracker 218 may update/rank the dialog state of the current dialog session. As an example and not by way of limitation, the dialog state tracker 218 may update the dialog state as “completed” if the dialog session is over. As another example and not by way of limitation, the dialog state tracker 218 may rank the dialog state based on a priority associated with it.

In particular embodiments, the dialog state tracker 218 may communicate with the action selector 222 about the dialog intents and associated content objects. In particular embodiments, the action selector 222 may rank different dialog hypotheses for different dialog intents. The action selector 222 may take candidate operators of dialog state and consult the dialog policies 360 to decide what actions should be executed. In particular embodiments, a dialog policy 360 may a tree-based policy, which is a pre-constructed dialog plan. Based on the current dialog state, a dialog policy 360 may choose a node to execute and generate the corresponding actions. As an example and not by way of limitation, the tree-based policy may comprise topic grouping nodes and dialog action (leaf) nodes. In particular embodiments, a dialog policy 360 may also comprise a data structure that describes an execution plan of an action by an agent 228. A dialog policy 360 may further comprise multiple goals related to each other through logical operators. In particular embodiments, a goal may be an outcome of a portion of the dialog policy and it may be constructed by the dialog manager 216. A goal may be represented by an identifier (e.g., string) with one or more named arguments, which parameterize the goal. As an example and not by way of limitation, a goal with its associated goal argument may be represented as {confirm_artist, args:{artist: “Madonna” }}. In particular embodiments, goals may be mapped to leaves of the tree of the tree-structured representation of the dialog policy 360.

In particular embodiments, the assistant system 140 may use hierarchical dialog policies 360 with general policy 362 handling the cross-domain business logic and task policies 364 handling the task/domain specific logic. The general policy 362 may be used for actions that are not specific to individual tasks. The general policy 362 may be used to determine task stacking and switching, proactive tasks, notifications, etc. The general policy 362 may comprise handling low-confidence intents, internal errors, unacceptable user response with retries, and/or skipping or inserting confirmation based on ASR or NLU confidence scores. The general policy 362 may also comprise the logic of ranking dialog state update candidates from the dialog state tracker 218 output and pick the one to update (such as picking the top ranked task intent). In particular embodiments, the assistant system 140 may have a particular interface for the general policy 362, which allows for consolidating scattered cross-domain policy/business-rules, especial those found in the dialog state tracker 218, into a function of the action selector 222. The interface for the general policy 362 may also allow for authoring of self-contained sub-policy units that may be tied to specific situations or clients (e.g., policy functions that may be easily switched on or off based on clients, situation). The interface for the general policy 362 may also allow for providing a layering of policies with back-off, i.e., multiple policy units, with highly specialized policy units that deal with specific situations being backed up by more general policies 362 that apply in wider circumstances. In this context the general policy 362 may alternatively comprise intent or task specific policy.

In particular embodiments, a task policy 364 may comprise the logic for action selector 222 based on the task and current state. The task policy 364 may be dynamic and ad-hoc. In particular embodiments, the types of task policies 364 may include one or more of the following types: (1) manually crafted tree-based dialog plans; (2) coded policy that directly implements the interface for generating actions; (3) configurator-specified slot-filling tasks; or (4) machine-learning model based policy learned from data. In particular embodiments, the assistant system 140 may bootstrap new domains with rule-based logic and later refine the task policies 364 with machine-learning models. In particular embodiments, the general policy 362 may pick one operator from the candidate operators to update the dialog state, followed by the selection of a user facing action by a task policy 364. Once a task is active in the dialog state, the corresponding task policy 364 may be consulted to select right actions.

In particular embodiments, the action selector 222 may select an action based on one or more of the event determined by the context engine 220, the dialog intent and state, the associated content objects, and the guidance from dialog policies 360. Each dialog policy 360 may be subscribed to specific conditions over the fields of the state. After an event is processed and the state is updated, the action selector 222 may run a fast search algorithm (e.g., similarly to the Boolean satisfiability) to identify which policies should be triggered based on the current state. In particular embodiments, if multiple policies are triggered, the action selector 222 may use a tie-breaking mechanism to pick a particular policy. Alternatively, the action selector 222 may use a more sophisticated approach which may dry-run each policy and then pick a particular policy which may be determined to have a high likelihood of success. In particular embodiments, mapping events to actions may result in several technical advantages for the assistant system 140. One technical advantage may include that each event may be a state update from the user or the user's physical/digital environment, which may or may not trigger an action from assistant system 140. Another technical advantage may include possibilities to handle rapid bursts of events (e.g., user enters a new building and sees many people) by first consuming all events to update state, and then triggering action(s) from the final state. Another technical advantage may include consuming all events into a single global assistant state.

In particular embodiments, the action selector 222 may take the dialog state update operators as part of the input to select the dialog action. The execution of the dialog action may generate a set of expectations to instruct the dialog state tracker 218 to handle future turns. In particular embodiments, an expectation may be used to provide context to the dialog state tracker 218 when handling the user input from next turn. As an example and not by way of limitation, slot request dialog action may have the expectation of proving a value for the requested slot. In particular embodiments, both the dialog state tracker 218 and the action selector 222 may not change the dialog state until the selected action is executed. This may allow the assistant system 140 to execute the dialog state tracker 218 and the action selector 222 for processing speculative ASR results and to do n-best ranking with dry runs.

In particular embodiments, the action selector 222 may call different agents 228 for task execution. Meanwhile, the dialog manager 216 may receive an instruction to update the dialog state. As an example and not by way of limitation, the update may comprise awaiting agents' 228 response. An agent 228 may select among registered content providers to complete the action. The data structure may be constructed by the dialog manager 216 based on an intent and one or more slots associated with the intent. In particular embodiments, the agents 228 may comprise first-party agents and third-party agents. In particular embodiments, first-party agents may comprise internal agents that are accessible and controllable by the assistant system 140 (e.g. agents associated with services provided by the online social network, such as messaging services or photo-share services). In particular embodiments, third-party agents may comprise external agents that the assistant system 140 has no control over (e.g., third-party online music application agents, ticket sales agents). The first-party agents may be associated with first-party providers that provide content objects and/or services hosted by the social-networking system 160. The third-party agents may be associated with third-party providers that provide content objects and/or services hosted by the third-party system 170. In particular embodiments, each of the first-party agents or third-party agents may be designated for a particular domain. As an example and not by way of limitation, the domain may comprise weather, transportation, music, shopping, social, videos, photos, events, locations, and/or work. In particular embodiments, the assistant system 140 may use a plurality of agents 228 collaboratively to respond to a user input. As an example and not by way of limitation, the user input may comprise “direct me to my next meeting.” The assistant system 140 may use a calendar agent to retrieve the location of the next meeting. The assistant system 140 may then use a navigation agent to direct the user to the next meeting.

In particular embodiments, the dialog manager 216 may support multi-turn compositional resolution of slot mentions. For a compositional parse from the NLU module 210, the resolver may recursively resolve the nested slots. The dialog manager 216 may additionally support disambiguation for the nested slots. As an example and not by way of limitation, the user input may be “remind me to call Alex”. The resolver may need to know which Alex to call before creating an actionable reminder to-do entity. The resolver may halt the resolution and set the resolution state when further user clarification is necessary for a particular slot. The general policy 362 may examine the resolution state and create corresponding dialog action for user clarification. In dialog state tracker 218, based on the user input and the last dialog action, the dialog manager 216 may update the nested slot. This capability may allow the assistant system 140 to interact with the user not only to collect missing slot values but also to reduce ambiguity of more complex/ambiguous utterances to complete the task. In particular embodiments, the dialog manager 216 may further support requesting missing slots in a nested intent and multi-intent user inputs (e.g., “take this photo and send it to Dad”). In particular embodiments, the dialog manager 216 may support machine-learning models for more robust dialog experience. As an example and not by way of limitation, the dialog state tracker 218 may use neural network based models (or any other suitable machine-learning models) to model belief over task hypotheses. As another example and not by way of limitation, for action selector 222, highest priority policy units may comprise white-list/black-list overrides, which may have to occur by design; middle priority units may comprise machine-learning models designed for action selection; and lower priority units may comprise rule-based fallbacks when the machine-learning models elect not to handle a situation. In particular embodiments, machine-learning model based general policy unit may help the assistant system 140 reduce redundant disambiguation or confirmation steps, thereby reducing the number of turns to execute the user input.

In particular embodiments, the determined actions by the action selector 222 may be sent to the delivery system 230. The delivery system 230 may comprise a CU composer 370, a response generation component 380, a dialog state writing component 382, and a text-to-speech (TTS) component 390. Specifically, the output of the action selector 222 may be received at the CU composer 370. In particular embodiments, the output from the action selector 222 may be formulated as a <k,c,u,d> tuple, in which k indicates a knowledge source, c indicates a communicative goal, u indicates a user model, and d indicates a discourse model.

In particular embodiments, the CU composer 370 may generate a communication content for the user using a natural-language generation (NLG) component 372. In particular embodiments, the NLG component 372 may use different language models and/or language templates to generate natural-language outputs. The generation of natural-language outputs may be application specific. The generation of natural-language outputs may be also personalized for each user. In particular embodiments, the NLG component 372 may comprise a content determination component, a sentence planner, and a surface realization component. The content determination component may determine the communication content based on the knowledge source, communicative goal, and the user's expectations. As an example and not by way of limitation, the determining may be based on a description logic. The description logic may comprise, for example, three fundamental notions which are individuals (representing objects in the domain), concepts (describing sets of individuals), and roles (representing binary relations between individuals or concepts). The description logic may be characterized by a set of constructors that allow the natural-language generator to build complex concepts/roles from atomic ones. In particular embodiments, the content determination component may perform the following tasks to determine the communication content. The first task may comprise a translation task, in which the input to the NLG component 372 may be translated to concepts. The second task may comprise a selection task, in which relevant concepts may be selected among those resulted from the translation task based on the user model. The third task may comprise a verification task, in which the coherence of the selected concepts may be verified. The fourth task may comprise an instantiation task, in which the verified concepts may be instantiated as an executable file that can be processed by the NLG component 372. The sentence planner may determine the organization of the communication content to make it human understandable. The surface realization component may determine specific words to use, the sequence of the sentences, and the style of the communication content.

In particular embodiments, the CU composer 370 may also determine a modality of the generated communication content using the UI payload generator 374. Since the generated communication content may be considered as a response to the user input, the CU composer 370 may additionally rank the generated communication content using a response ranker 376. As an example and not by way of limitation, the ranking may indicate the priority of the response. In particular embodiments, the CU composer 370 may comprise a natural-language synthesis (NLS) component that may be separate from the NLG component 372. The NLS component may specify attributes of the synthesized speech generated by the CU composer 370, including gender, volume, pace, style, or register, in order to customize the response for a particular user, task, or agent. The NLS component may tune language synthesis without engaging the implementation of associated tasks. In particular embodiments, the CU composer 370 may check privacy constraints associated with the user to make sure the generation of the communication content follows the privacy policies. More information on customizing natural-language generation (NLG) may be found in U.S. patent application Ser. No. 15/967,279, filed 30 Apr. 2018, and U.S. patent application Ser. No. 15/966,455, filed 30 Apr. 2018, which is incorporated by reference.

In particular embodiments, the delivery system 230 may perform different tasks based on the output of the CU composer 370. These tasks may include writing (i.e., storing/updating) the dialog state into the data store 330 using the dialog state writing component 382 and generating responses using the response generation component 380. In particular embodiments, the output of the CU composer 370 may be additionally sent to the TTS component 390 if the determined modality of the communication content is audio. In particular embodiments, the output from the delivery system 230 comprising one or more of the generated responses, the communication content, or the speech generated by the TTS component 390 may be then sent back to the dialog manager 216.

In particular embodiments, the orchestrator 206 may determine, based on the output of the entity resolution module 212, whether to processing a user input on the client system 130 or on the server, or in the third operational mode (i.e., blended mode) using both. Besides determining how to process the user input, the orchestrator 206 may receive the results from the agents 228 and/or the results from the delivery system 230 provided by the dialog manager 216. The orchestrator 206 may then forward these results to the arbitrator 226. The arbitrator 226 may aggregate these results, analyze them, select the best result, and provide the selected result to the render output module 232. In particular embodiments, the arbitrator 226 may consult with dialog policies 360 to obtain the guidance when analyzing these results. In particular embodiments, the render output module 232 may generate a response that is suitable for the client system 130.

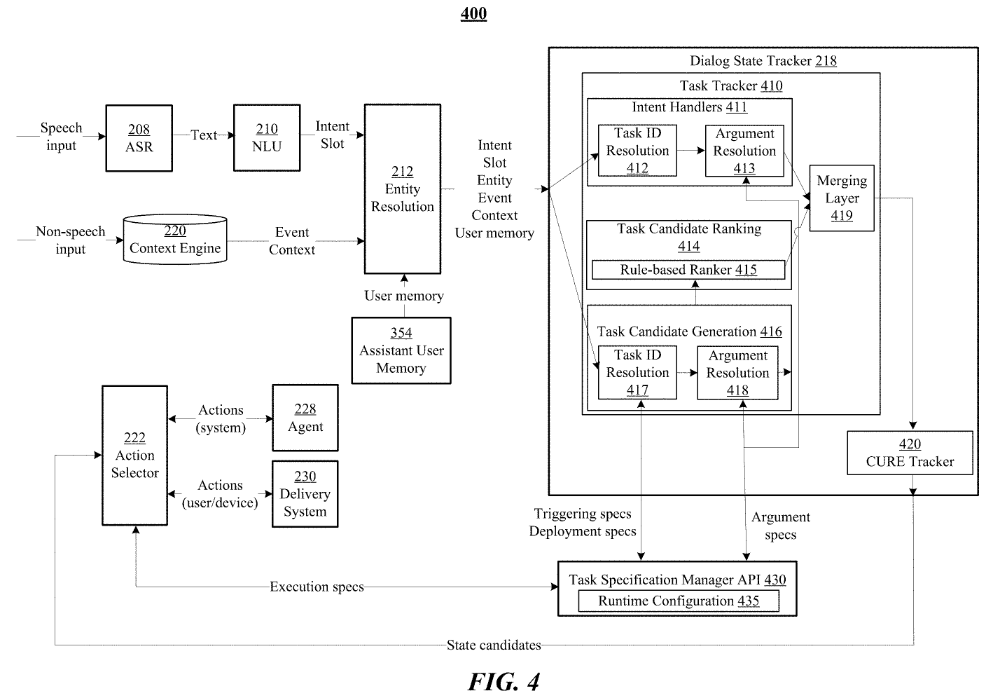

FIG. 4 illustrates an example task-centric flow diagram 400 of processing a user input. In particular embodiments, the assistant system 140 may assist users not only with voice-initiated experiences but also more proactive, multi-modal experiences that are initiated on understanding user context. In particular embodiments, the assistant system 140 may rely on assistant tasks for such purpose. An assistant task may be a central concept that is shared across the whole assistant stack to understand user intention, interact with the user and the world to complete the right task for the user. In particular embodiments, an assistant task may be the primitive unit of assistant capability. It may comprise data fetching, updating some state, executing some command, or complex tasks composed of a smaller set of tasks. Completing a task correctly and successfully to deliver the value to the user may be the goal that the assistant system 140 is optimized for. In particular embodiments, an assistant task may be defined as a capability or a feature. The assistant task may be shared across multiple product surfaces if they have exactly the same requirements so it may be easily tracked. It may also be passed from device to device, and easily picked up mid-task by another device since the primitive unit is consistent. In addition, the consistent format of the assistant task may allow developers working on different modules in the assistant stack to more easily design around it. Furthermore, it may allow for task sharing. As an example and not by way of limitation, if a user is listening to music on smart glasses, the user may say “play this music on my phone.” In the event that the phone hasn't been woken or has a task to execute, the smart glasses may formulate a task that is provided to the phone, which may then be executed by the phone to start playing music. In particular embodiments, the assistant task may be retained by each surface separately if they have different expected behaviors. In particular embodiments, the assistant system 140 may identify the right task based on user inputs in different modality or other signals, conduct conversation to collect all necessary information, and complete that task with action selector 222 implemented internally or externally, on server or locally product surfaces. In particular embodiments, the assistant stack may comprise a set of processing components from wake-up, recognizing user inputs, understanding user intention, reasoning about the tasks, fulfilling a task to generate natural-language response with voices.

In particular embodiments, the user input may comprise speech input. The speech input may be received at the ASR module 208 for extracting the text transcription from the speech input. The ASR module 208 may use statistical models to determine the most likely sequences of words that correspond to a given portion of speech received by the assistant system 140 as audio input. The models may include one or more of hidden Markov models, neural networks, deep learning models, or any combination thereof. The received audio input may be encoded into digital data at a particular sampling rate (e.g., 16, 44.1, or 96 kHz) and with a particular number of bits representing each sample (e.g., 8, 16, of 24 bits).

In particular embodiments, the ASR module 208 may comprise one or more of a grapheme-to-phoneme (G2P) model, a pronunciation learning model, a personalized acoustic model, a personalized language model (PLM), or an end-pointing model. In particular embodiments, the grapheme-to-phoneme (G2P) model may be used to determine a user's grapheme-to-phoneme style (i.e., what it may sound like when a particular user speaks a particular word). In particular embodiments, the personalized acoustic model may be a model of the relationship between audio signals and the sounds of phonetic units in the language. Therefore, such personalized acoustic model may identify how a user's voice sounds. The personalized acoustical model may be generated using training data such as training speech received as audio input and the corresponding phonetic units that correspond to the speech. The personalized acoustical model may be trained or refined using the voice of a particular user to recognize that user's speech. In particular embodiments, the personalized language model may then determine the most likely phrase that corresponds to the identified phonetic units for a particular audio input. The personalized language model may be a model of the probabilities that various word sequences may occur in the language. The sounds of the phonetic units in the audio input may be matched with word sequences using the personalized language model, and greater weights may be assigned to the word sequences that are more likely to be phrases in the language. The word sequence having the highest weight may be then selected as the text that corresponds to the audio input. In particular embodiments, the personalized language model may also be used to predict what words a user is most likely to say given a context. In particular embodiments, the end-pointing model may detect when the end of an utterance is reached. In particular embodiments, based at least in part on a limited computing power of the client system 130, the assistant system 140 may optimize the personalized language model at runtime during the client-side process. As an example and not by way of limitation, the assistant system 140 may pre-compute a plurality of personalized language models for a plurality of possible subjects a user may talk about. When a user input is associated with a request for assistance, the assistant system 140 may promptly switch between and locally optimize the pre-computed language models at runtime based on user activities. As a result, the assistant system 140 may preserve computational resources while efficiently identifying a subject matter associated with the user input. In particular embodiments, the assistant system 140 may also dynamically re-learn user pronunciations at runtime.

In particular embodiments, the user input may comprise non-speech input. The non-speech input may be received at the context engine 220 for determining events and context from the non-speech input. The context engine 220 may determine multi-modal events comprising voice/text intents, location updates, visual events, touch, gaze, gestures, activities, device/application events, and/or any other suitable type of events. The voice/text intents may depend on the ASR module 208 and the NLU module 210. The location updates may be consumed by the dialog manager 216 to support various proactive/reactive scenarios. The visual events may be based on person or object appearing in the user's field of view. These events may be consumed by the dialog manager 216 and recorded in transient user state to support visual co-reference (e.g., resolving “that” in “how much is that shirt?” and resolving “him” in “send him my contact”). The gaze, gesture, and activity may result in flags being set in the transient user state (e.g., user is running) which may condition the action selector 222. For the device/application events, if an application makes an update to the device state, this may be published to the assistant system 140 so that the dialog manager 216 may use this context (what is currently displayed to the user) to handle reactive and proactive scenarios. As an example and not by way of limitation, the context engine 220 may cause a push notification message to be displayed on a display screen of the user's client system 130. The user may interact with the push notification message, which may initiate a multi-modal event (e.g., an event workflow for replying to a message received from another user). Other example multi-modal events may include seeing a friend, seeing a landmark, being at home, running, starting a call with touch, taking a photo with touch, opening an application, etc. In particular embodiments, the context engine 220 may also determine world/social events based on world/social updates (e.g., weather changes, a friend getting online). The social updates may comprise events that a user is subscribed to, (e.g., friend's birthday, posts, comments, other notifications). These updates may be consumed by the dialog manager 216 to trigger proactive actions based on context (e.g., suggesting a user call a friend on their birthday, but only if the user is not focused on something else). As an example and not by way of limitation, receiving a message may be a social event, which may trigger the task of reading the message to the user.

In particular embodiments, the text transcription from the ASR module 208 may be sent to the NLU module 210. The NLU module 210 may process the text transcription and extract the user intention (i.e., intents) and parse the slots or parsing result based on the linguistic ontology. In particular embodiments, the intents and slots from the NLU module 210 and/or the events and contexts from the context engine 220 may be sent to the entity resolution module 212. In particular embodiments, the entity resolution module 212 may resolve entities associated with the user input based on the output from the NLU module 210 and/or the context engine 220. The entity resolution module 212 may use different techniques to resolve the entities, including accessing user memory from the assistant user memory (AUM) 354. In particular embodiments, the AUM 354 may comprise user episodic memories helpful for resolving the entities by the entity resolution module 212. The AUM 354 may be the central place for storing, retrieving, indexing, and searching over user data.

In particular embodiments, the entity resolution module 212 may provide one or more of the intents, slots, entities, events, context, or user memory to the dialog state tracker 218. The dialog state tracker 218 may identify a set of state candidates for a task accordingly, conduct interaction with the user to collect necessary information to fill the state, and call the action selector 222 to fulfill the task. In particular embodiments, the dialog state tracker 218 may comprise a task tracker 410. The task tracker 410 may track the task state associated with an assistant task. In particular embodiments, a task state may be a data structure persistent cross interaction turns and updates in real time to capture the state of the task during the whole interaction. The task state may comprise all the current information about a task execution status, such as arguments, confirmation status, confidence score, etc. Any incorrect or outdated information in the task state may lead to failure or incorrect task execution. The task state may also serve as a set of contextual information for many other components such as the ASR module 208, the NLU module 210, etc.

In particular embodiments, the task tracker 410 may comprise intent handlers 411, task candidate ranking module 414, task candidate generation module 416, and merging layer 419. In particular embodiments, a task may be identified by its ID name. The task ID may be used to associate corresponding component assets if it is not explicitly set in the task specification, such as dialog policy 360, agent execution, NLG dialog act, etc. Therefore, the output from the entity resolution module 212 may be received by a task ID resolution component 417 of the task candidate generation module 416 to resolve the task ID of the corresponding task. In particular embodiments, the task ID resolution component 417 may call a task specification manager API 430 to access the triggering specifications and deployment specifications for resolving the task ID. Given these specifications, the task ID resolution component 417 may resolve the task ID using intents, slots, dialog state, context, and user memory.

In particular embodiments, the technical specification of a task may be defined by a task specification. The task specification may be used by the assistant system 140 to trigger a task, conduct dialog conversation, and find a right execution module (e.g., agents 228) to execute the task. The task specification may be an implementation of the product requirement document. It may serve as the general contract and requirements that all the components agreed on. It may be considered as an assembly specification for a product, while all development partners deliver the modules based on the specification. In particular embodiments, an assistant task may be defined in the implementation by a specification. As an example and not by way of limitation, the task specification may be defined as the following categories. One category may be a basic task schema which comprises the basic identification information such as ID, name, and the schema of the input arguments. Another category may be a triggering specification, which is about how a task can be triggered, such as intents, event message ID, etc. Another category may be a conversational specification, which is for dialog manager 216 to conduct the conversation with users and systems. Another category may be an execution specification, which is about how the task will be executed and fulfilled. Another category may be a deployment specification, which is about how a feature will be deployed to certain surfaces, local, and group of users.

In particular embodiments, the task specification manager API 430 may be an API for accessing a task specification manager. The task specification manager may be a module in the runtime stack for loading the specifications from all the tasks and providing interfaces to access all the tasks specifications for detailed information or generating task candidates. In particular embodiments, the task specification manager may be accessible for all components in the runtime stack via the task specification manager API 430. The task specification manager may comprise a set of static utility functions to manage tasks with the task specification manager, such as filtering task candidates by platform. Before landing the task specification, the assistant system 140 may also dynamically load the task specifications to support end-to-end development on the development stage.

In particular embodiments, the task specifications may be grouped by domains and stored in runtime configurations 435. The runtime stack may load all the task specifications from the runtime configurations 435 during the building time. In particular embodiments, in the runtime configurations 435, for a domain, there may be a cconffile and a cinc file (e.g., sidechef_task.cconf and sidechef_task.inc). As an example and not by way of limitation, <domain>_tasks.cconf may comprise all the details of the task specifications. As another example and not by way of limitation, <domain>_tasks.cinc may provide a way to override the generated specification if there is no support for that feature yet.

In particular embodiments, a task execution may require a set of arguments to execute. Therefore, an argument resolution component 418 may resolve the argument names using the argument specifications for the resolved task ID. These arguments may be resolved based on NLU outputs (e.g., slot [SL:contact]), dialog state (e.g., short-term calling history), user memory (such as user preferences, location, long-term calling history, etc.), or device context (such as timer states, screen content, etc.). In particular embodiments, the argument modality may be text, audio, images or other structured data. The slot to argument mapping may be defined by a filling strategy and/or language ontology. In particular embodiments, given the task triggering specifications, the task candidate generation module 416 may look for the list of tasks to be triggered as task candidates based on the resolved task ID and arguments.

In particular embodiments, the generated task candidates may be sent to the task candidate ranking module 414 to be further ranked. The task candidate ranking module 414 may use a rule-based ranker 415 to rank them. In particular embodiments, the rule-based ranker 415 may comprise a set of heuristics to bias certain domain tasks. The ranking logic may be described as below with principles of context priority. In particular embodiments, the priority of a user specified task may be higher than an on-foreground task. The priority of the on-foreground task may be higher than a device-domain task when the intent is a meta intent. The priority of the device-domain task may be higher than a task of a triggering intent domain. As an example and not by way of limitation, the ranking may pick the task if the task domain is mentioned or specified in the utterance, such as “create a timer in TIMER app”. As another example and not by way of imitation, the ranking may pick the task if the task domain is on foreground or active state, such as “stop the timer” to stop the timer while the TIMER app is on foreground and there is an active timer. As yet another example and not by way of imitation, the ranking may pick the task if the intent is general meta intent, and the task is device control while there is no other active application or active state. As yet another example and not by way of imitation, the ranking may pick the task if the task is the same as the intent domain. In particular embodiments, the task candidate ranking module 414 may customize some more logic to check the match of intent/slot/entity types. The ranked task candidates may be sent to the merging layer 419.

In particular embodiments, the output from the entity resolution module 212 may also sent to a task ID resolution component 412 of the intent handlers 411. The task ID resolution component 412 may resolve the task ID of the corresponding task similarly to the task ID resolution component 417. In particular embodiments, the intent handlers 411 may additionally comprise an argument resolution component 413. The argument resolution component 413 may resolve the argument names using the argument specifications for the resolved task ID similarly to the argument resolution component 418. In particular embodiments, intent handlers 411 may deal with task agnostic features and may not be expressed within the task specifications which are task specific. Intent handlers 411 may output state candidates other than task candidates such as argument update, confirmation update, disambiguation update, etc. In particular embodiments, some tasks may require very complex triggering conditions or very complex argument filling logic that may not be reusable by other tasks even if they were supported in the task specifications (e.g., in-call voice commands, media tasks via [IN:PLAY_MEDIA], etc.). Intent handlers 411 may be also suitable for such type of tasks. In particular embodiments, the results from the intent handlers 411 may take precedence over the results from the task candidate ranking module 414. The results from the intent handlers 411 may be also sent to the merging layer 419.

In particular embodiments, the merging layer 419 may combine the results from the intent handlers 411 and the results from the task candidate ranking module 414. The dialog state tracker 218 may suggest each task as a new state for the dialog policies 360 to select from, thereby generating a list of state candidates. The merged results may be further sent to a conversational understanding reinforcement engine (CURE) tracker 420. In particular embodiments, the CURE tracker 420 may be a personalized learning process to improve the determination of the state candidates by the dialog state tracker 218 under different contexts using real-time user feedback. More information on conversational understanding reinforcement engine may be found in U.S. patent application Ser. No. 17/186,459, filed 26 Feb. 2021, which is incorporated by reference.

In particular embodiments, the state candidates generated by the CURE tracker 420 may be sent to the action selector 222. The action selector 222 may consult with the task policies 364, which may be generated from execution specifications accessed via the task specification manager API 430. In particular embodiments, the execution specifications may describe how a task should be executed and what actions the action selector 222 may need to take to complete the task.

In particular embodiments, the action selector 222 may determine actions associated with the system. Such actions may involve the agents 228 to execute. As a result, the action selector 222 may send the system actions to the agents 228 and the agents 228 may return the execution results of these actions. In particular embodiments, the action selector may determine actions associated with the user or device. Such actions may need to be executed by the delivery system 230. As a result, the action selector 222 may send the user/device actions to the delivery system 230 and the delivery system 230 may return the execution results of these actions.

The embodiments disclosed herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### Social Graphs

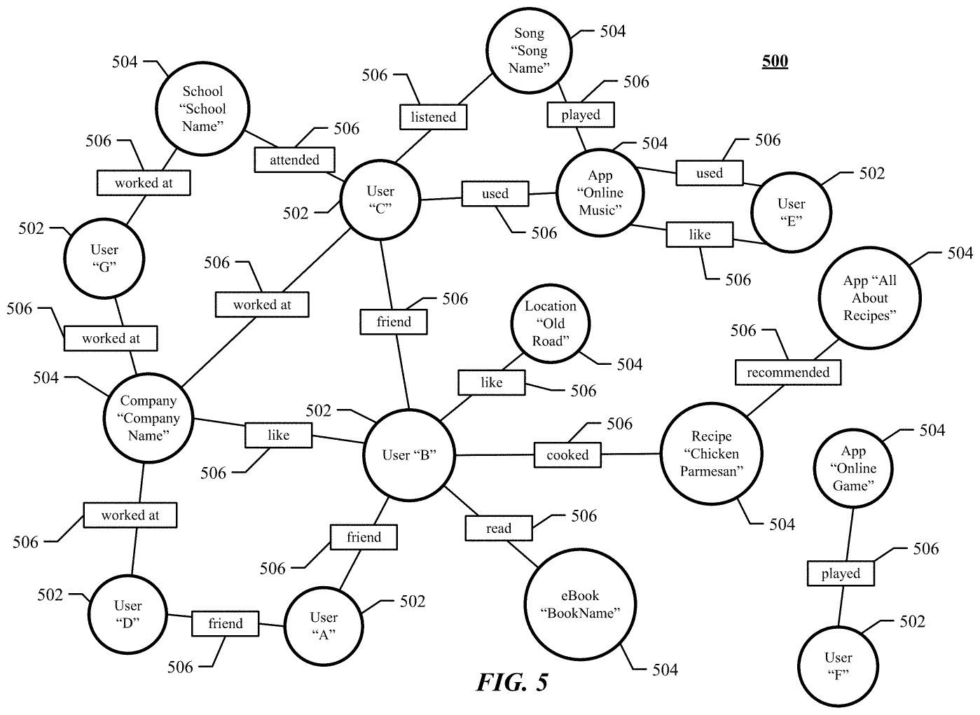

FIG. 5 illustrates an example social graph 500. In particular embodiments, the social-networking system 160 may store one or more social graphs 500 in one or more data stores. In particular embodiments, the social graph 500 may include multiple nodes—which may include multiple user nodes 502 or multiple concept nodes 504—and multiple edges 506 connecting the nodes. Each node may be associated with a unique entity (i.e., user or concept), each of which may have a unique identifier (ID), such as a unique number or username. The example social graph 500 illustrated in FIG. 5 is shown, for didactic purposes, in a two-dimensional visual map representation. In particular embodiments, a social-networking system 160, a client system 130, an assistant system 140, or a third-party system 170 may access the social graph 500 and related social-graph information for suitable applications. The nodes and edges of the social graph 500 may be stored as data objects, for example, in a data store (such as a social-graph database). Such a data store may include one or more searchable or queryable indexes of nodes or edges of the social graph 500.

In particular embodiments, a user node 502 may correspond to a user of the social-networking system 160 or the assistant system 140. As an example and not by way of limitation, a user may be an individual (human user), an entity (e.g., an enterprise, business, or third-party application), or a group (e.g., of individuals or entities) that interacts or communicates with or over the social-networking system 160 or the assistant system 140. In particular embodiments, when a user registers for an account with the social-networking system 160, the social-networking system 160 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with the social-networking system 160. In particular embodiments, a user node 502 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more web interfaces.

In particular embodiments, a concept node 504 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 504 may be associated with information of a concept provided by a user or information gathered by various systems, including the social-networking system 160 and the assistant system 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more web interfaces.

In particular embodiments, a node in the social graph 500 may represent or be represented by a web interface (which may be referred to as a “profile interface”). Profile interfaces may be hosted by or accessible to the social-networking system 160 or the assistant system 140. Profile interfaces may also be hosted on third-party websites associated with a third-party system 170. As an example and not by way of limitation, a profile interface corresponding to a particular external web interface may be the particular external web interface and the profile interface may correspond to a particular concept node 504. Profile interfaces may be viewable by all or a selected subset of other users. As an example and not by way of limitation, a user node 502 may have a corresponding user-profile interface in which the corresponding user may add content, make declarations, or otherwise express himself or herself. As another example and not by way of limitation, a concept node 504 may have a corresponding concept-profile interface in which one or more users may add content, make declarations, or express themselves, particularly in relation to the concept corresponding to concept node 504.

In particular embodiments, a concept node 504 may represent a third-party web interface or resource hosted by a third-party system 170. The third-party web interface or resource may include, among other elements, content, a selectable or other icon, or other inter-actable object representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 502 corresponding to the user and a concept node 504 corresponding to the third-party web interface or resource and store edge 506 in one or more data stores.

In particular embodiments, a pair of nodes in the social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 506 connecting the first user's user node 502 to the second user's user node 502 in the social graph 500 and store edge 506 as social-graph information in one or more of data stores 164. In the example of FIG. 5, the social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 500 by one or more edges 506. The degree of separation between two objects represented by two nodes, respectively, is a count of edges in a shortest path connecting the two nodes in the social graph 500. As an example and not by way of limitation, in the social graph 500, the user node 502 of user “C” is connected to the user node 502 of user “A” via multiple paths including, for example, a first path directly passing through the user node 502 of user “B,” a second path passing through the concept node 504 of company “CompanyName” and the user node 502 of user “D,” and a third path passing through the user nodes 502 and concept nodes 504 representing school “SchoolName,” user “G,” company “CompanyName,” and user “D.” User “C” and user “A” have a degree of separation of two because the shortest path connecting their corresponding nodes (i.e., the first path) includes two edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “read” a concept, each of which may correspond to an edge type or subtype. A concept-profile interface corresponding to a concept node 504 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“SongName”) using a particular application (a third-party online music application). In this case, the social-networking system 160 may create a “listened” edge 506 and a “used” edge (as illustrated in FIG. 5) between user nodes 502 corresponding to the user and concept nodes 504 corresponding to the song and application to indicate that the user listened to the song and used the application. Moreover, the social-networking system 160 may create a “played” edge 506 (as illustrated in FIG. 5) between concept nodes 504 corresponding to the song and the application to indicate that the particular song was played by the particular application. In this case, “played” edge 506 corresponds to an action performed by an external application (the third-party online music application) on an external audio file (the song “SongName”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “online music application”).

In particular embodiments, the social-networking system 160 may create an edge 506 between a user node 502 and a concept node 504 in the social graph 500. As an example and not by way of limitation, a user viewing a concept-profile interface (such as, for example, by using a web browser or a special-purpose application hosted by the user's client system 130) may indicate that he or she likes the concept represented by the concept node 504 by clicking or selecting a “Like” icon, which may cause the user's client system 130 to send to the social-networking system 160 a message indicating the user's liking of the concept associated with the concept-profile interface. In response to the message, the social-networking system 160 may create an edge 506 between user node 502 associated with the user and concept node 504, as illustrated by “like” edge 506 between the user and concept node 504. In particular embodiments, the social-networking system 160 may store an edge 506 in one or more data stores. In particular embodiments, an edge 506 may be automatically formed by the social-networking system 160 in response to a particular user action. As an example and not by way of limitation, if a first user uploads a picture, reads a book, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

### Vector Spaces and Embeddings

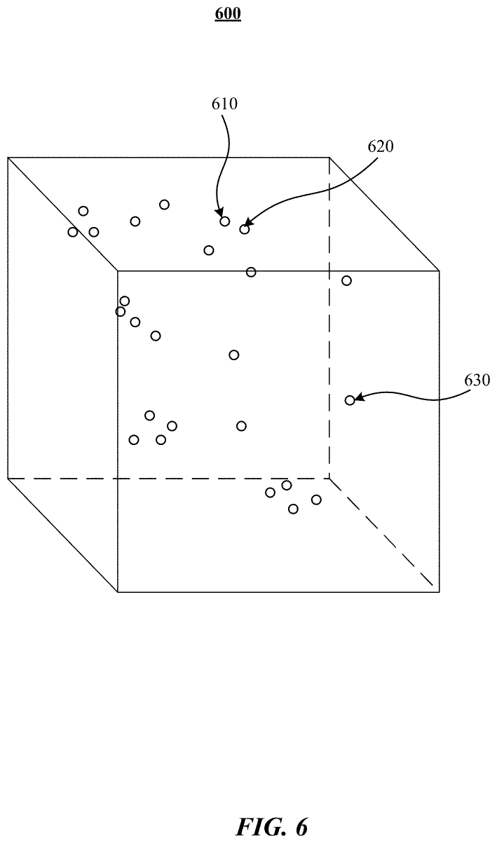

FIG. 6 illustrates an example view of a vector space 600. In particular embodiments, an object or an n-gram may be represented in a d-dimensional vector space, where d denotes any suitable number of dimensions. Although the vector space 600 is illustrated as a three-dimensional space, this is for illustrative purposes only, as the vector space 600 may be of any suitable dimension. In particular embodiments, an n-gram may be represented in the vector space 600 as a vector referred to as a term embedding. Each vector may comprise coordinates corresponding to a particular point in the vector space 600 (i.e., the terminal point of the vector). As an example and not by way of limitation, vectors 610, 620, and 630 may be represented as points in the vector space 600, as illustrated in FIG. 6. An n-gram may be mapped to a respective vector representation. As an example and not by way of limitation, n-grams t₁ and t₂ may be mapped to vectors \vec{v₁} and \vec{v₂} in the vector space 600, respectively, by applying a function \vec{π}defined by a dictionary, such that \vec{v₁}=\vec{π}(t₁) and \vec{v₂}=\vec{π}(t₂). As another example and not by way of limitation, a dictionary trained to map text to a vector representation may be utilized, or such a dictionary may be itself generated via training. As another example and not by way of limitation, a word-embeddings model may be used to map an n-gram to a vector representation in the vector space 600. In particular embodiments, an n-gram may be mapped to a vector representation in the vector space 600 by using a machine leaning model (e.g., a neural network). The machine learning model may have been trained using a sequence of training data (e.g., a corpus of objects each comprising n-grams).

In particular embodiments, an object may be represented in the vector space 600 as a vector referred to as a feature vector or an object embedding. As an example and not by way of limitation, objects e₁ and e₂ may be mapped to vectors \vec{v₁} and \vec{v₂} in the vector space 600, respectively, by applying a function \vec{π}, such that \vec{v₁}=\vec{π}(e₁) and \vec{v₂}=\vec{π}(e₂). In particular embodiments, an object may be mapped to a vector based on one or more properties, attributes, or features of the object, relationships of the object with other objects, or any other suitable information associated with the object. As an example and not by way of limitation, a function \vec{π} may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function \vec{π} may map the object to a vector using a transformed reduced set of features (e.g., feature selection). In particular embodiments, a function \vec{π} may map an object e to a vector \vec{π}(e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 600. A similarity metric may be a cosine similarity, a Minkowski distance, a Mahalanobis distance, a Jaccard similarity coefficient, or any suitable similarity metric. As an example and not by way of limitation, a similarity metric of \vec{v₁} and \vec{v₂} may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of \vec{v₁} and \vec{v₂} may be a Euclidean distance ∥\vec{v₁}−\vec{v₂}∥. A similarity metric of two vectors may represent how similar the two objects or n-grams corresponding to the two vectors, respectively, are to one another, as measured by the distance between the two vectors in the vector space 600. As an example and not by way of limitation, vector 610 and vector 620 may correspond to objects that are more similar to one another than the objects corresponding to vector 610 and vector 630, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Artificial Neural Networks

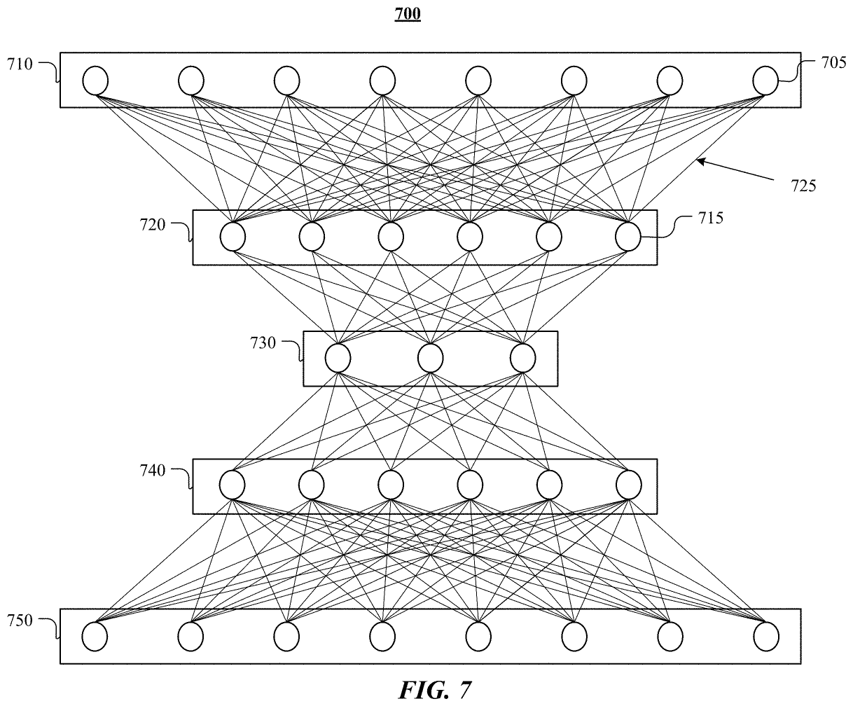

FIG. 7 illustrates an example artificial neural network (“ANN”) 700. In particular embodiments, an ANN may refer to a computational model comprising one or more nodes. Example ANN 700 may comprise an input layer 710, hidden layers 720, 730, 740, and an output layer 750. Each layer of the ANN 700 may comprise one or more nodes, such as a node 705 or a node 715. In particular embodiments, each node of an ANN may be connected to another node of the ANN. As an example and not by way of limitation, each node of the input layer 710 may be connected to one of more nodes of the hidden layer 720. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 7 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 7 depicts a connection between each node of the input layer 710 and each node of the hidden layer 720, one or more nodes of the input layer 710 may not be connected to one or more nodes of the hidden layer 720.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 720 may comprise the output of one or more nodes of the input layer 710. As another example and not by way of limitation, the input to each node of the output layer 750 may comprise the output of one or more nodes of the hidden layer 740. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max (0,sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 725 between the node 705 and the node 715 may have a weighting coefficient of 0.4, which may indicate that 0.4 multiplied by the output of the node 705 is used as an input to the node 715. As another example and not by way of limitation, the output yₖ of node k may be yₖ Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 700 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a client system 130, an assistant system 140, a third-party system 170, a social-networking application, an assistant application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or assistant system 140 or shared with other systems (e.g., a third-party system 170). Although this disclosure describes using particular privacy settings in a particular manner, this disclosure contemplates using any suitable privacy settings in any suitable manner.

In particular embodiments, privacy settings may be based on one or more nodes or edges of a social graph 500. A privacy setting may be specified for one or more edges 506 or edge-types of the social graph 500, or with respect to one or more nodes 502, 504 or node-types of the social graph 500. The privacy settings applied to a particular edge 506 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 160. The object may be associated with a concept node 504 connected to a user node 502 of the first user by an edge 506. The first user may specify privacy settings that apply to a particular edge 506 connecting to the concept node 504 of the object, or may specify privacy settings that apply to all edges 506 connecting to the concept node 504. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 160 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or assistant system 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or assistant system 140 may access such information in order to provide a particular function or service to the first user, without the social-networking system 160 or assistant system 140 having access to that information for any other purposes. Before accessing, storing, or using such objects or information, the social-networking system 160 or assistant system 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or assistant system 140.

In particular embodiments, a user may specify whether particular types of objects or information associated with the first user may be accessed, stored, or used by the social-networking system 160 or assistant system 140. As an example and not by way of limitation, the first user may specify that images sent by the first user through the social-networking system 160 or assistant system 140 may not be stored by the social-networking system 160 or assistant system 140. As another example and not by way of limitation, a first user may specify that messages sent from the first user to a particular second user may not be stored by the social-networking system 160 or assistant system 140. As yet another example and not by way of limitation, a first user may specify that all objects sent via a particular application may be saved by the social-networking system 160 or assistant system 140.

In particular embodiments, privacy settings may allow a first user to specify whether particular objects or information associated with the first user may be accessed from particular client systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or assistant system 140 may provide default privacy settings with respect to each device, system, or application, and/or the first user may be prompted to specify a particular privacy setting for each context. As an example and not by way of limitation, the first user may utilize a location-services feature of the social-networking system 160 or assistant system 140 to provide recommendations for restaurants or other places in proximity to the user. The first user's default privacy settings may specify that the social-networking system 160 or assistant system 140 may use location information provided from a client system 130 of the first user to provide the location-based services, but that the social-networking system 160 or assistant system 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or assistant system 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or assistant system 140. The user's privacy settings may specify that such information may be used only for particular processes, such as authentication, and further specify that such information may not be shared with any third-party system 170 or used for other processes or applications associated with the social-networking system 160 or assistant system 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Systems and Methods

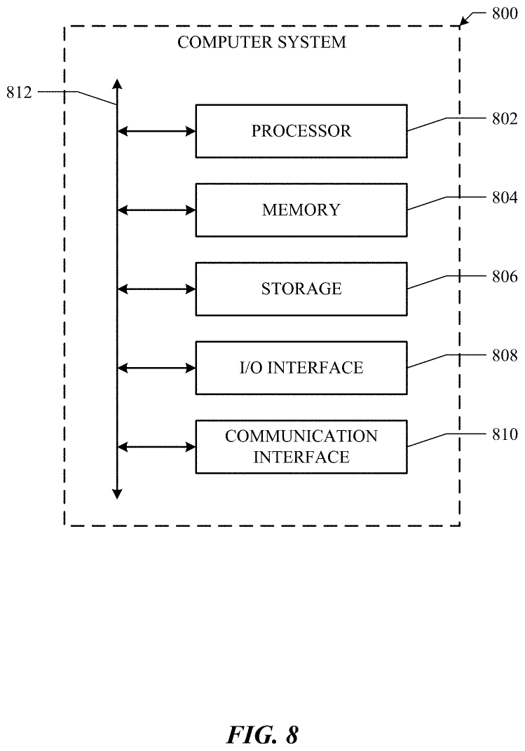

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Generic Visual Editor for Designing Responses

In particular embodiments, the assistant system 140 may enable developers (users) to render responses using appropriate formatting and modalities. The assistant system 140 may be run on various types of devices with different form factors and rendering capabilities. As an example and not by way of limitation, a smart tablet may output both audio and visual responses on a larger screen, while smart glasses may only output audio responses, and an AR headset may be able to output audio and full field-of-view AR (visual) responses. To make it easy for developers to configure user-interface (UI) responses to render appropriately on various types of smart devices, the assistant may provide a user-experience (UX) framework with unified templates in an assistant-based software tool that may be used on different surfaces. In addition to the existing functionality of customizing audio responses, developers may choose the set of UX templates they want to associate with the visual part of the experience (e.g., card view, list view, etc.). Then the assistant system 140 may configure responses based on these various UX templates selected by the developers. The assistant system 140 may then produce a UX response that is appropriately rendered on the client system 130 (i.e., a smart device) based on its form factor and modalities. Although this disclosure describes enabling particular configurations for rendering particular responses by particular systems in a particular manner, this disclosure contemplates enabling any suitable configuration for rendering any suitable response by any suitable system in any suitable manner.

Assistant experiences developers may need to implement different logic to render the UI for different surfaces (i.e., different client systems 130). It may be difficult for developers to bootstrap a new feature provided by the assistant system 140 quickly with the UI. In addition, the UI design different features may be different. To address these issues, the assistant system 140 may integrate a UI authoring tool in the assistant-based software tool to guide developers to select the suitable UI template for the domain/agent development. The assistant system 140 may implement UI authoring tool to design the assistant UI. In particular embodiments, the assistant system 140 may further integrate the UI authoring tool with the assistant dialog authoring tool to design the multi-turn conversations UI. As an example and not by way of limitation, the assistant system 140 may define a thrift structure (e.g., assistant_template.thrift) to describe the UI. As another example and not by way of limitation, the assistant system 40 may provide agent or UI configurations that generate assistant_template.thrift data. As yet another example and not by way of limitation, the assistant system 140 may translate assistant_template.thrift data to different assistant actions for different surfaces.

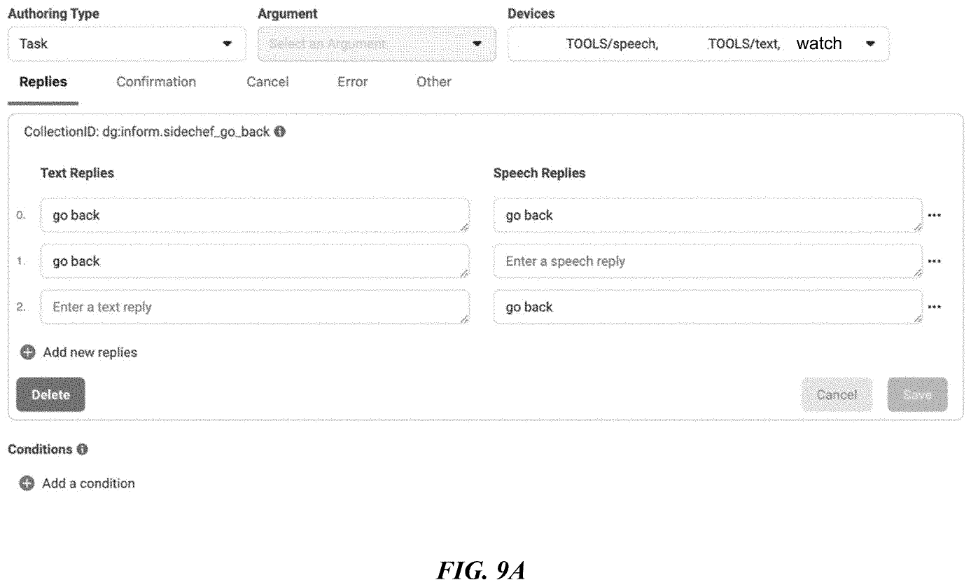

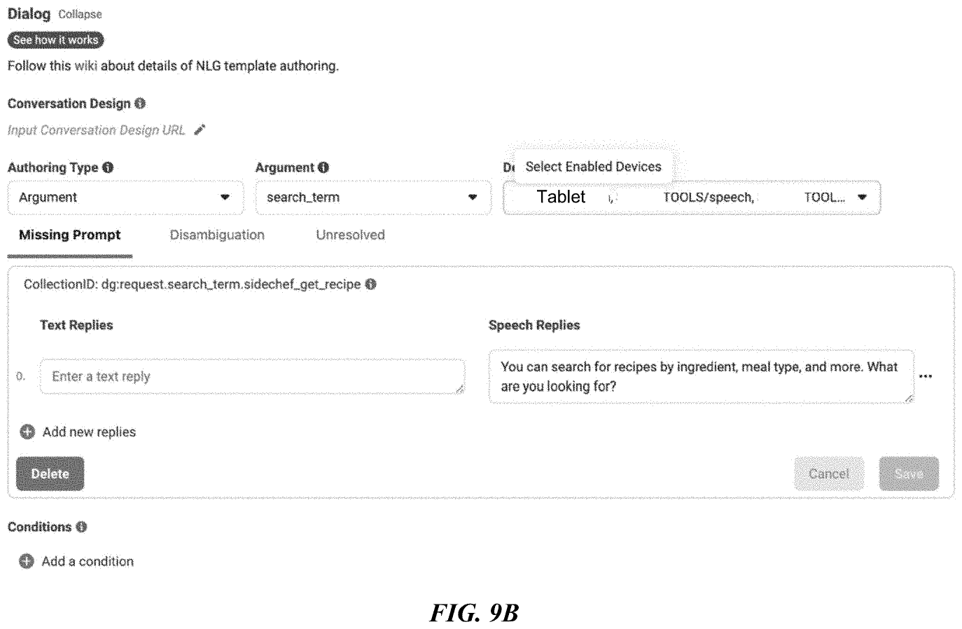

FIGS. 9A-9B illustrate an example integration of the UI configuration into the “response” section of the assistant-based software tool. FIG. 9A illustrates an example interface of NLG configuration in the “response” section. FIG. 9B illustrates an example interface of NLG configuration indicating a selection of enabled devices in the “response” section. In particular embodiments, the assistant system 140 may support NLG configurations in the “response” section.

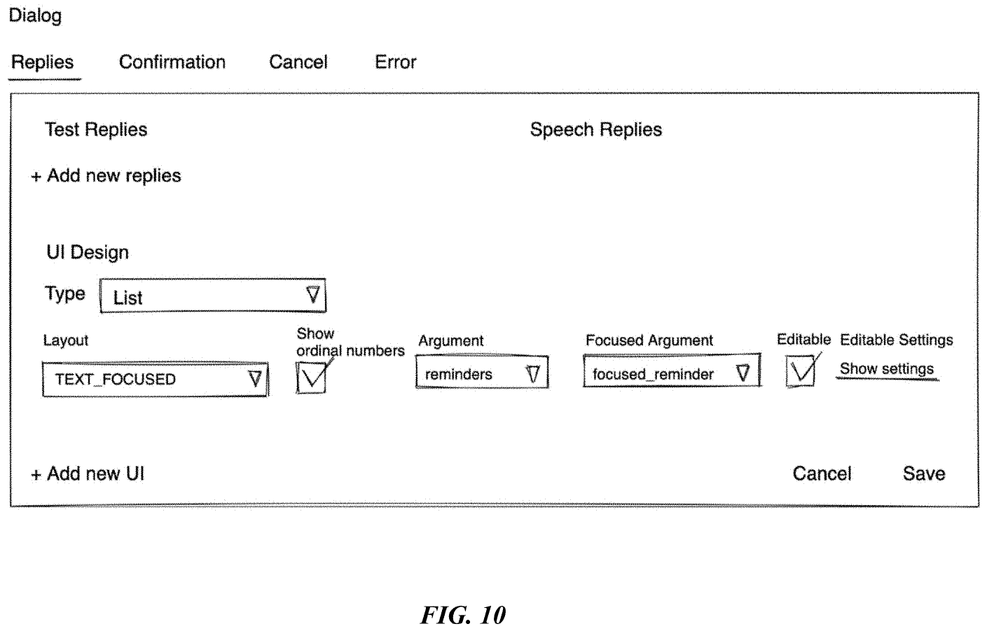

FIG. 10 illustrates an example section allowing developers to select the UI template type and set the argument identifier for the card/cards in the UI template.

In particular embodiments, a user may configure the UI in the assistant-based software tool as follows. The user may first go to the “response” section and select the task/argument and the tabs for UI configuration. The user may configure different UI for reply, confirmation, error, etc. The user may also configure different UI for argument disambiguation, missing prompt, or unresolved issue. Then user may then go to the UI settings section and select the assistant template type. The user may also update the devices to enable the UI modality for surfaces. If the user wants to show the entity/entities as the card/cards within the assistant template, the user may perform the following procedures. First, the user may go to the “output arguments” section. Second, the user may create the output argument with an argument identifier (ID) and specify the entity type. Third, the user may go to the UI settings section. For the argument(s) selector, from the dropdown list, the user may see the newly defined argument ID and select it. Lastly, in agent, the assistant-based software tool may return the output argument for the argument ID with the entity/entities.

In particular embodiments, the user may configure multi-turn conversations with the UI authoring tool as follows. The user may first add a new configuration to skip building the payload in agent. When skipping building the payload, the dialog may not send requests to agent to build the payload. Instead, the dialog may directly construct the dialog act and go to the NLG module and UI rendering module. For all the existing domains with multi-turn conversations, the field may be false. In this case, the assistant runtime may still send requests to agent to build the payload and agent may be still able to return UI related assistant actions. For the new tasks created in the assistant-based software tool, the field may be set to true. In this case, developers may disable the field to build the payload in agent. But if the field is enabled, developers may not need to build the payload in agent. Furthermore, the UI configurations may be used to render the UI in the UI rendering module. The UI may be configured under the “response” section.

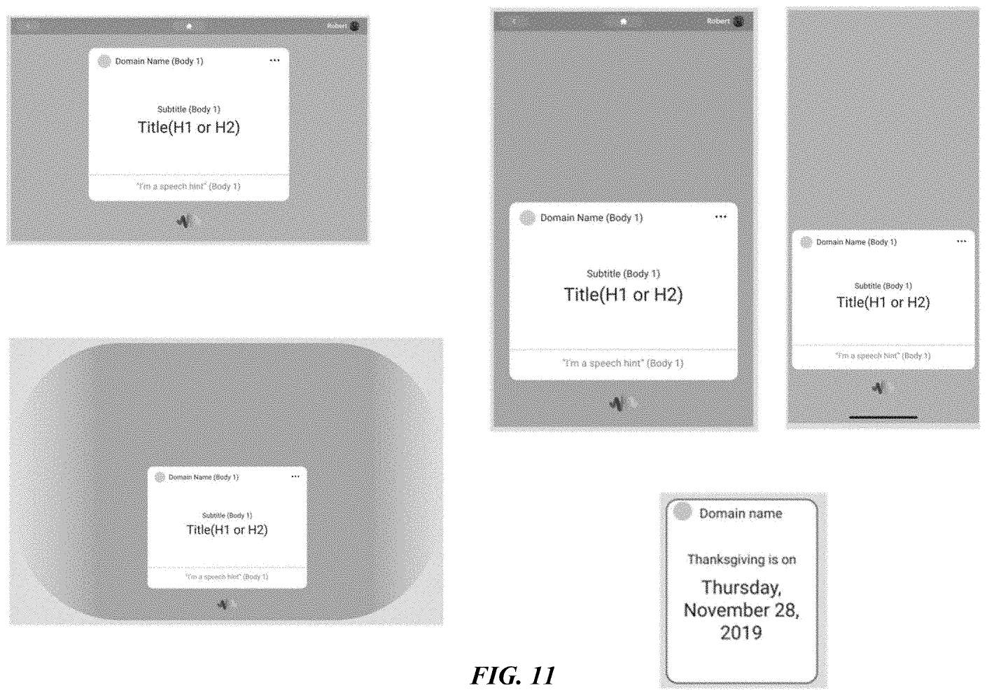

FIG. 11 illustrates example different layout a developer may be able to configure for five different types of client systems. As indicated in FIG. 11, these configurations may be for text only. Each layout may comprise one or more of an attention system, an app/domain icon, or an app/domain name.

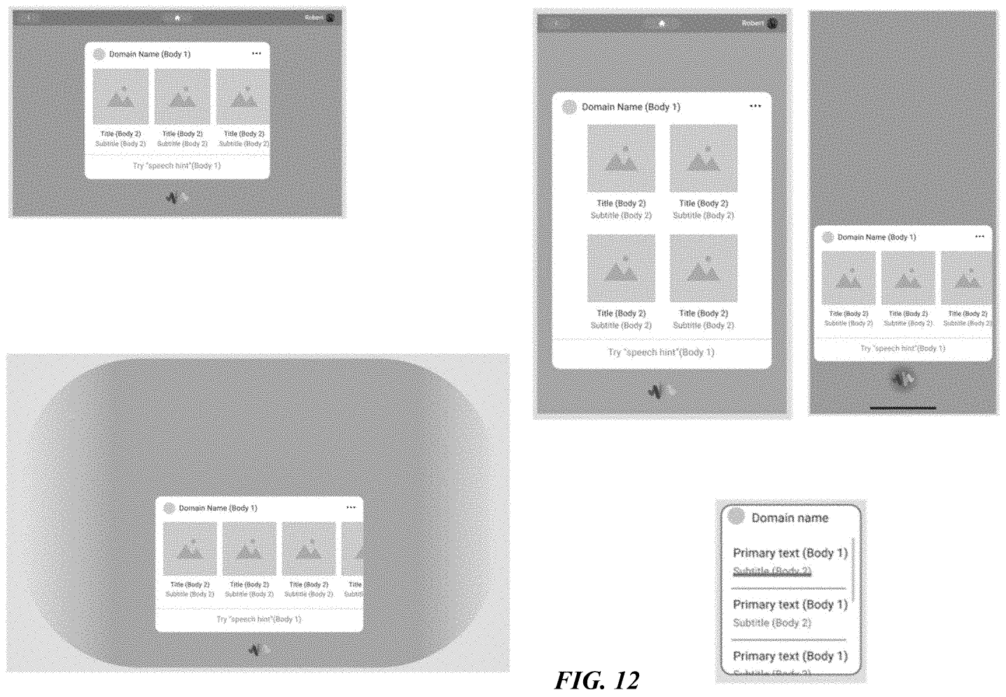

FIG. 12 illustrates example different layout a developer may be able to configure for five different types of client systems. As indicated in FIG. 12, these configurations may be for images and text. Each layout may comprise one or more of an attention system, an app/domain icon, or an app/domain name.

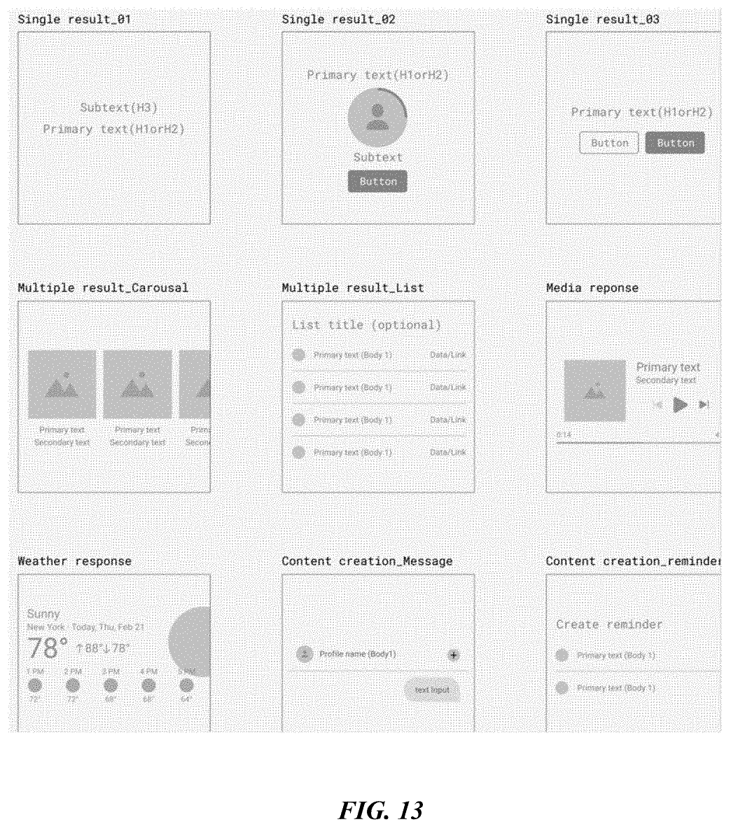

FIG. 13 illustrates example templates for configuring responses. As indicated in FIG. 13, the templates may comprise one or more of templates for single result, templates for multiple results, templates for creating message content, templates for creating reminder content, customized templates, media templates, or weather templates.

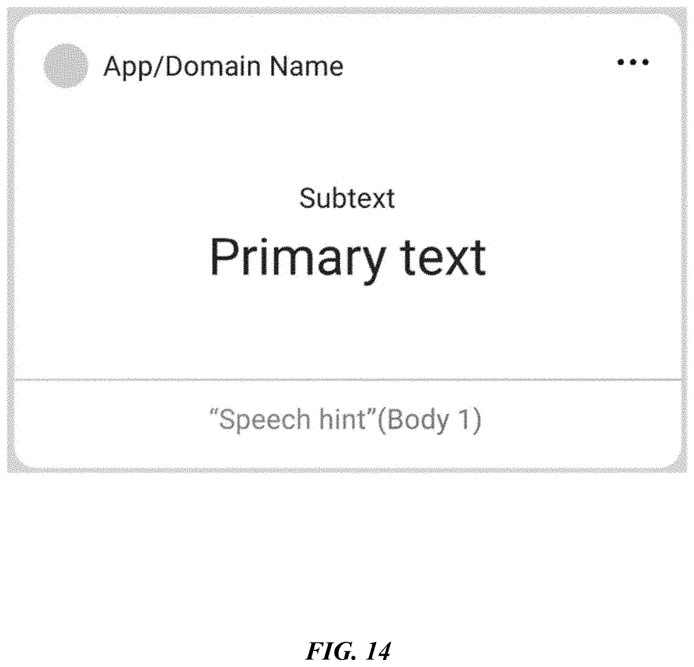

FIG. 14 illustrates an example template for a single response. As indicated in FIG. 14, the single response may comprise text of two lines. In the template, both the primary text and subtext may be required. Image may be required if there is no description. The description may be required when there is no image. Call to action may be not required. As an example and not by way of limitation, this configuration may be suitable for responding to user queries such as “how many days until easter,” “what day is it”, or “when is Dan's birthday.”

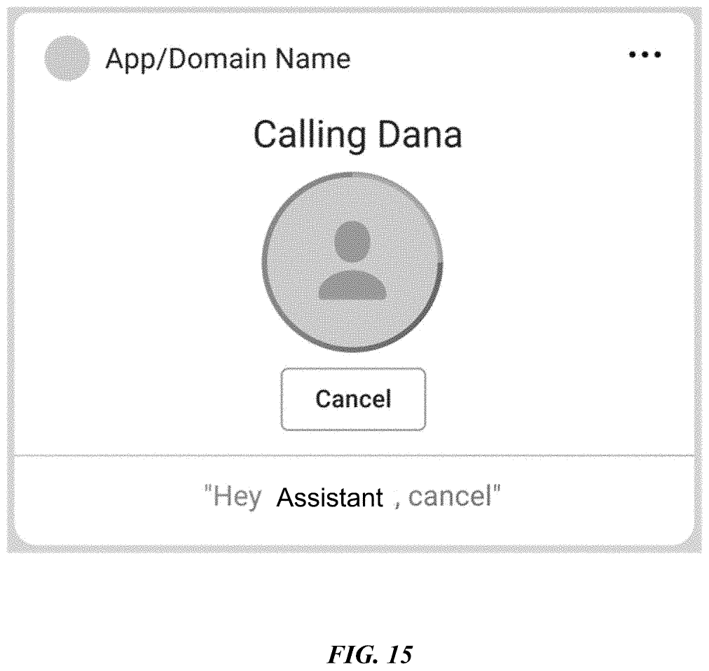

FIG. 15 illustrates an example configuration of a single response. As indicated in FIG. 15, the single response may comprise text, graph and a button. In the configuration, both the primary text and subtext may be required. Image may be required if there is no description. The description may be required when there is no image. As an example and not by way of limitation, this configuration may be suitable for a confirmation such as “calling Dana now.”

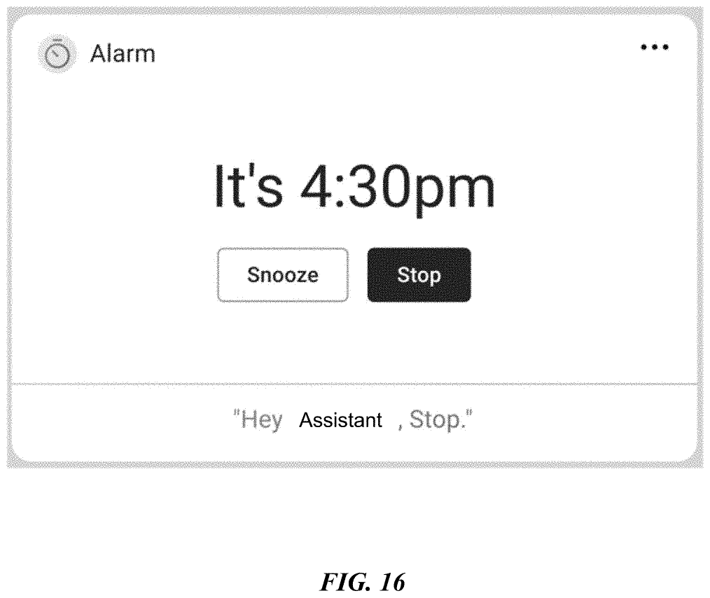

FIG. 16 illustrates an example configuration of an alarm. As indicated in FIG. 16, the alarm may comprise text, graph and a button. In the configuration, both the primary text and subtext may be required. Image may be required if there is no description. The description may be required when there is no image.

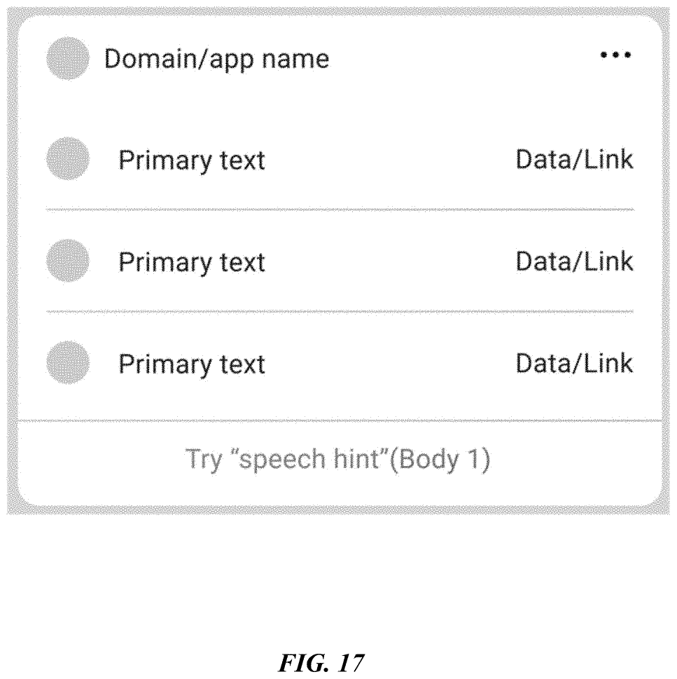

FIG. 17 illustrates an example template for multiple responses. As indicated in FIG. 17, the template may comprise primary text. Secondary text, image, data/link, or call to action may be not required.

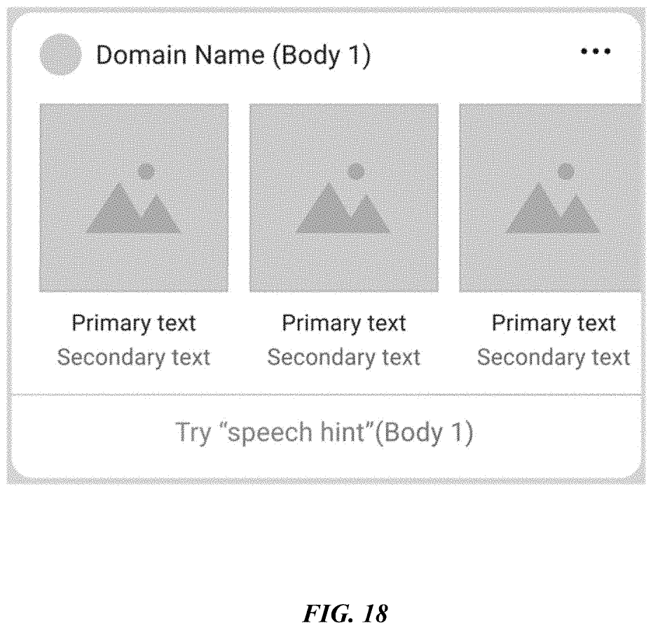

FIG. 18 illustrates an example configuration of multiple responses with image focused. As indicated in FIG. 18, the primary text and image may be both required. As an example and not by way of limitation, such configuration may be suitable for disambiguation (e.g., “which Dana?”) or search results.

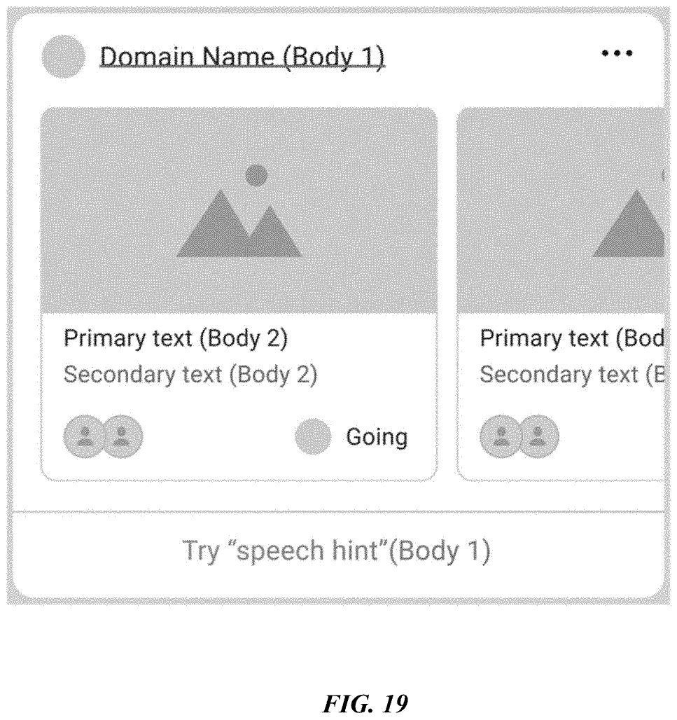

FIG. 19 illustrates an example configuration of multiple responses with people focused. As indicated in FIG. 19, the primary text and secondary text may be both required. Image may be required if there is no description and description may be required if there is no image.

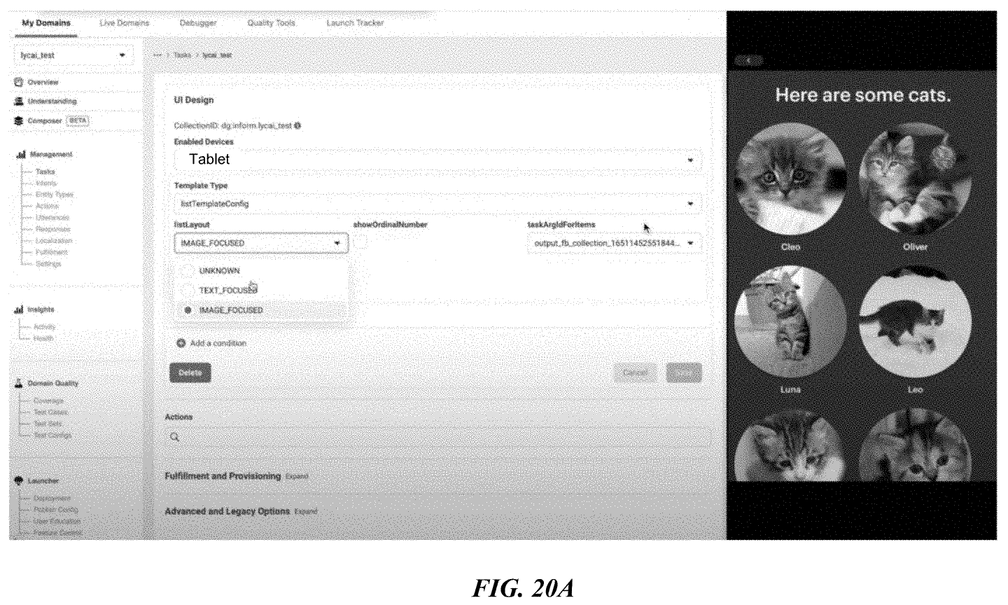

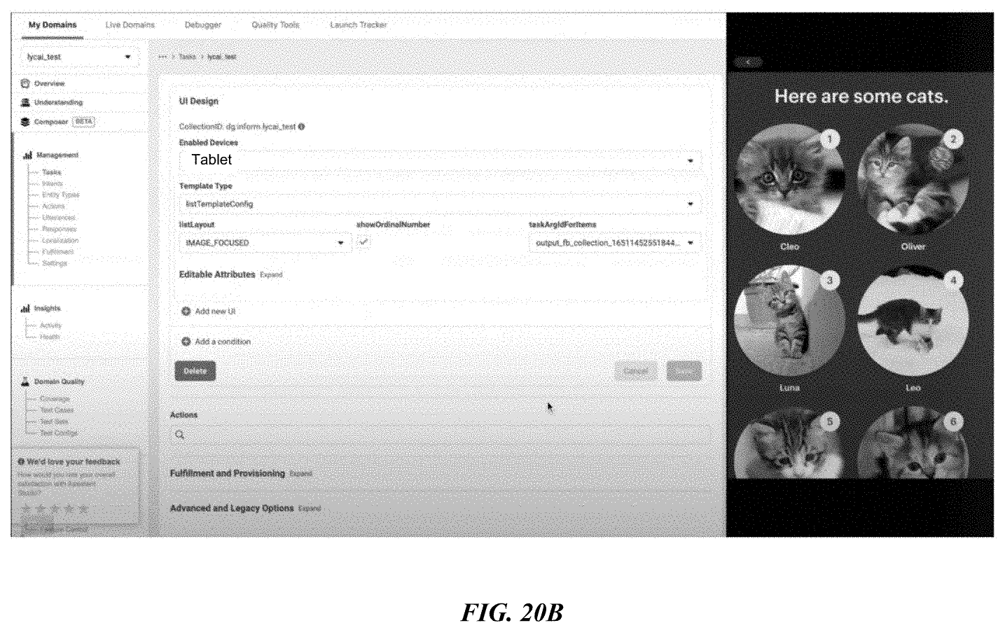

FIG. 20A illustrates an example user interface showing a configuration of image focused layout. As indicated in FIG. 20A, the user may be configuration a response for showing cats. FIG. 20B illustrates the example user interface showing the configuration of image focused layout with a selection of showing ordinal number. As indicated in FIG. 20B, after the user selects to show the ordinal number, there are numbers added to the pictures of cats, respectively.

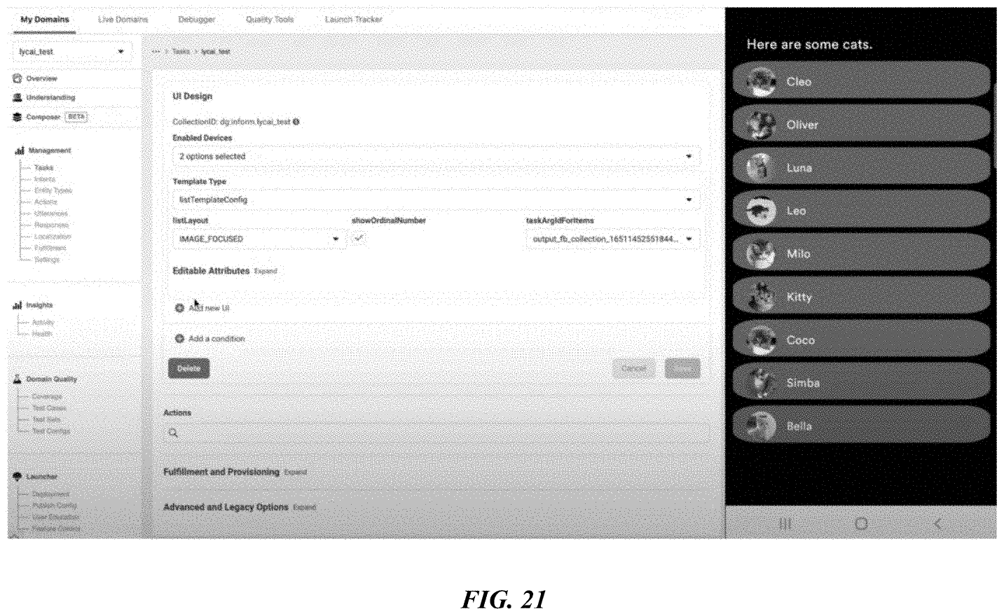

FIG. 21 illustrates an example user interface showing a configuration of multiple devices. As indicated in FIG. 21, two options corresponding to two devices may be selected by the user. The configuration may be image focused layout for showing pictures of cats.

In particular embodiments, the assistant system may have the backend design for enable developers to render responses using appropriate formatting and modalities as follows. The main configuration unit of the assistant UX framework may be the UI scenario configurations thrift struct which comprises a list of UI scenario configuration (singular) and a filter condition, and is mapped to a unique scenario ID. Both scenario configurations and template collections may comprise the filter conditions definition. Scenario configuration or the template sets may have the actual configuration data. In particular embodiments, UI scenario configuration may differ from the template sets by only needing to handle the text or visual modality instead of all of them, and not needing any translation due to its nature as visual layout configuration. Therefore, the simplest approach may be to implement a single configuration schema to contain a list of UI scenario configuration thrift fields, a filter condition field and various getters and setters to interface between subfields and any graphic API integrations that are necessary.

In particular embodiments, based on the filter conditions, UI scenario configurations may reuse the NLG template struct as a field which simplifies the backend design requirements greatly. The NLG template struct may be passed to the backend through a graph template collection post and therefore once the relevant react components are modified to support UX framework, the resultant NLG template struct may be passed as is.

In particular embodiments, the assistant-based software tool may provide APIs. Most of the assistant-based software tool may interface to the backend via autogenerated and custom graphical API endpoints. Similarly, an additional accessor and modifier may be needed for the schema for scenario configurations. The autogenerated versions may be feasible with the custom fields of the schema and create and/or update relevant actions.

In particular embodiments, the UI authoring tool integrated into the assistant-based software tool may comprise lists. Lists may be scrollable containers that present a linear index of objects for the user to interact with. List components may be used for disambiguation as well as answer patterns. Not every list item may need to be conveyed at the same level of detail if used as part of the summary presentation pattern. As an example and not by way of limitation, lists may be used for when the assistant system 140 needs the user to choose between several defined options (i.e., disambiguation), when the assistant system 140 recalls a category of items, or when the assistant system 140 presents an overview of items. Lists and list items may be suited for referencing objects and data that exists within the information architecture. The properties and data presented in a list may be inherited from its source structure. This may comprise domains that are both surface-agnostic and surface-specific.

In particular embodiments, users may order list items by relevance to use case and priority. Users may also try to keep list item quantity to three items or less. Users may additionally show controls on list items that may exit the layer on tap.

In particular embodiments, lists may have particular behaviors. Depending on the context of list presentation, tapping on a list item may result in two different transitional behaviors. Each type of list item may need to visually distinguished to help users understand what may happen when they tap on them. When the user taps on a list item in disambiguation, they may be making a selection to proceed as if they made the selection with their voice. For all other use cases, when the user taps on a list item, the object may deep link to a specified location within the host application of the object and the assistant layer may close.

In particular embodiments, lists may offer the ability for users to scroll to see more list items indeterminately. However, it is generally recommended to follow the rules of progressive disclosure and diminishing returns. Scrollable content that exists beyond the fold may be rarely seen or interacted with, and with it carries lower confidence that it may satisfy the user's goals. Instead of indeterminate scrolling, the assistant system 140 may offer links to see more in an application outside of the assistant layer

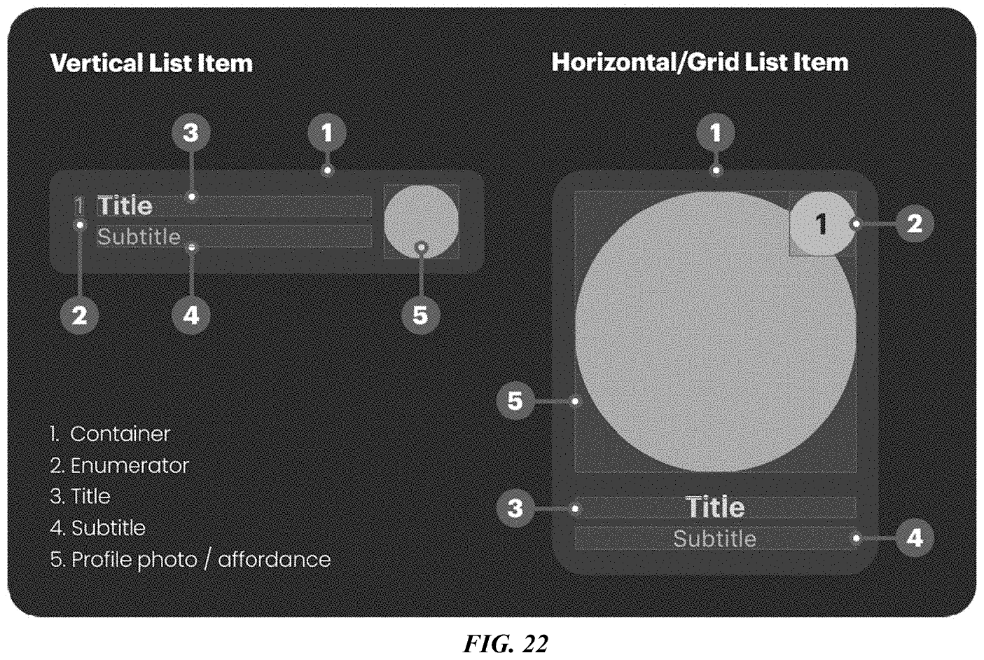

FIG. 22 illustrates an example anatomy of the list items. As indicated in FIG. 22, there may be vertical list items and/or horizontal/grid list items. As an example and not by way of limitation, these list items may correspond to container, enumerator, title, subtitle, or profile photo/affordance.

### Discourse Representation Graphs

In particular embodiments, the assistant system 140 may conduct dialog state tracking to effectively track dialog and how each turn of dialog is connected to the previous turns during conversationally complex interactions between a user and the assistant system 140. Users may often seek to naturally re-use contextually relevant information from a large distance from their current position. This may comprise returning from sub-dialogues to a larger base conversation, but also the concept of a shared world knowledge between interlocutors. The assistant system 140 may use a graph representation of conversational and semantic information which can track the knowledge inherent to discourse. In particular, the assistant system 140 may add discourse relational information, which may describe how two segments of discourse (either within a given turn or between turns) are logically connected to one another. The dialog state tracking may use the discourse relationship to understand how a portion of a turn relates to either another portion of the same turn or a portion of a prior turn during the same session. The discourse relations may also be used during the generation of natural language responses by inserting relational markers in the text output. The graph representation may provide an overlaid structure for the discourse structures that would allow the assistant system 140 access to the internal knowledge and connect to external sources. Access to this information may enable an end-to-end representation that could be directly acted upon and serve as the evolving, unified ground truth for the conversation as a whole. By using such a structure, the assistant system 140 may be able to engage in a more natural conversation with contextual awareness and the ability to resolve ambiguities in a natural manner without adding additional cognitive load on the user. Although this disclosure describes using particular graphs for particular state tracking by particular systems in a particular manner, this disclosure contemplates using any suitable graph for any suitable state tracking by any suitable system in any suitable manner.

Discourse may comprise the creation and organization of the segments of a language above as well as below the sentence. It may comprise segments of language which may be bigger or smaller than a single sentence but the adduced meaning may be always beyond the sentence. Discourse in context may comprise only one or two words as in stop or no smoking. Alternatively, a piece of discourse may be hundreds of thousands of words in length. A typical piece of discourse may be somewhere between these two extremes. The term discourse may apply to both spoken and written language, in fact to any sample of language used for any purpose. Any series of speech events or any combination of sentences in written form wherein successive sentences or utterances hang together may be discourse. Discourse may not be confined to sentential boundaries. It may be something that goes beyond the limits of sentence. In other words, discourse may be any coherent succession of sentences, spoken or written. The links between sentences in connected discourse may be as much important as the links between clauses in a sentence. Discourse may be relevant in more advanced features for the assistant system 140. This may comprise being able to parse an entire post and responses to collect valuable topics, recommendations, and other information on the parsing side while also being able to stitch together a coherent, relevant response.

As we advance our understanding of AI assistants and the impact they can make on users' lives, we also become more aware of the problems and deficits that current approaches to their development face. One area where this has become more apparent may be in the naturalness and conversational abilities of AI assistants. This may comprise contextual awareness and current dialogue state tracking systems which focus on tracking the user's goal at each step of a dialogue and aggregating additional information over subsequent turns. This approach to dialogue may miss out on some of the intrinsic information contained within and may be heavily focused on a single intent carried out in multiple steps as opposed to an ongoing conversation.

Additionally, current semantic labelling representations may be heavily focused on entities and semantic values, paired with user intentions encoded in single-turn utterances. Newer, more complex scenarios with broader focus and a higher reliance on shared contextual information may benefit from the additional discourse and pragmatic information of an ongoing conversation to make a more natural and coherent user experience.

One area we can see discourse evaluations playing a much larger role may be in conversationally complex interactions. Users may often seek to naturally re-use contextually relevant information from a large distance from their current position. This may comprise returning from sub-dialogues to a larger base conversation, but also the concept of a shared world knowledge between interlocutors. For example, a user may be engaged with the assistant system 140 in the following dialogue. At the first turn, the user may ask “are there any updates from my fashionista shopping and swapping group? At the second turn, the assistant system 140 may reply “the most recent post is from Erika, which says ‘where should we go this weekend?’” At the third turn, the user may ask “what are the suggestions so far?” At the fourth turn, the assistant system 140 may reply “Mohammed suggested ‘let's take a trip to the university village, it's great for walking in the sun.’ Would you like to see more?” At the fifth turn, the user may ask “has Sam suggested anything yet?” At the sixth turn, the assistant system 140 may reply “no, Sam has not replied.” At the seventh turn, the user may ask “why does my foodies of Seattle group is the best restaurant around there?” At the eighth turn, the assistant system 140 may reply “I couldn't find any answers from the group Foodies of Seattle for restaurants near University Village Shopping Center.” At the ninth turn, the user may say “well what about Natalie, she's got good taste.” At the tenth turn, the assistant system 140 may reply “your friend Natalie Woods mentioned in the group Bougie Taste At Dive Prices that ‘University Village has some great places to grab a bite. Delfino's for pizza, Veggie Grill for vegetarians, or Hokkaido Ramen for some tasty noodles.” At the eleventh turn, the user may say “reply to Erika and Mohammed with that and say it's a friend's recommendation.” The above conversation may include a large amount of information pulled from sources that would be seen as disconnected by current dialogue and semantic understanding systems.

The length of the above dialogue may fit within the theoretical framework of a dialog state tracker 218, but the breadth and distance of connections as well as the actual content to be accessed may become overwhelming in practice. Not only would the dialog state tracker 218 need to make broad assumptions about the likelihood of past turns coming up very far down the line in the conversation, it would also need to track sub-dialogues and the access to contextually relevant information. In the above sample dialogue, this may mean needing to keep track of all turns present in the dialogue with very fuzzy and poorly delineated boundaries between unique conversations. If they happen within a close amount of time, the user may assume some shared knowledge that is lost because of a reset to the dialog state tracker 218. It may also mean tracking and retaining the parses of the groups mentioned, the posts parsed, the people involved, and their relation to the user.

In particular embodiments, the assistant system 140 may use a graph representation of conversational and semantic information which can track the knowledge inherent to discourse. The aim of this representation may be to provide an overlaid structure for the discourse structures that would allow the assistant system 140 access to the internal knowledge and connect to external sources. Access to this information may enable an end-to-end representation that could be directly acted upon and serve as the evolving, unified ground truth for the conversation as a whole. By using such a structure, the assistant system 140 may act as a more natural conversational AI with contextual awareness and the ability to resolve ambiguities in a natural manner without adding additional cognitive load on the user.

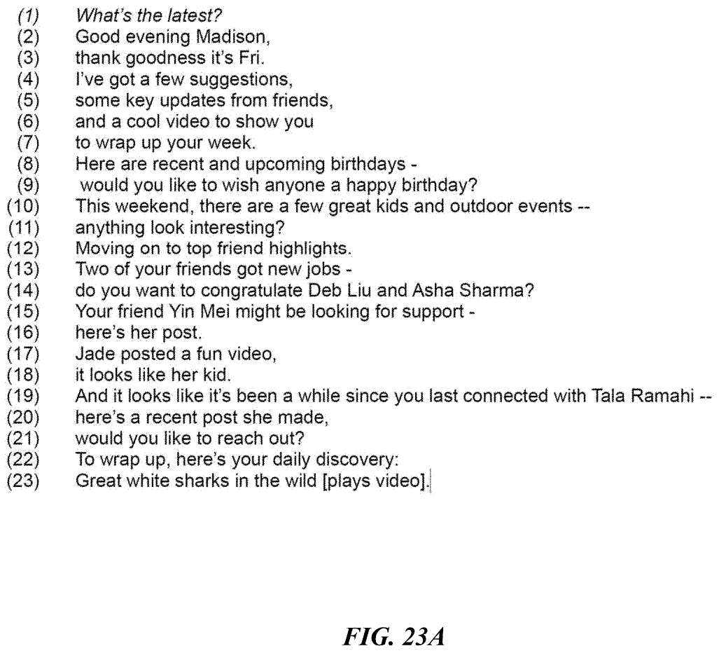

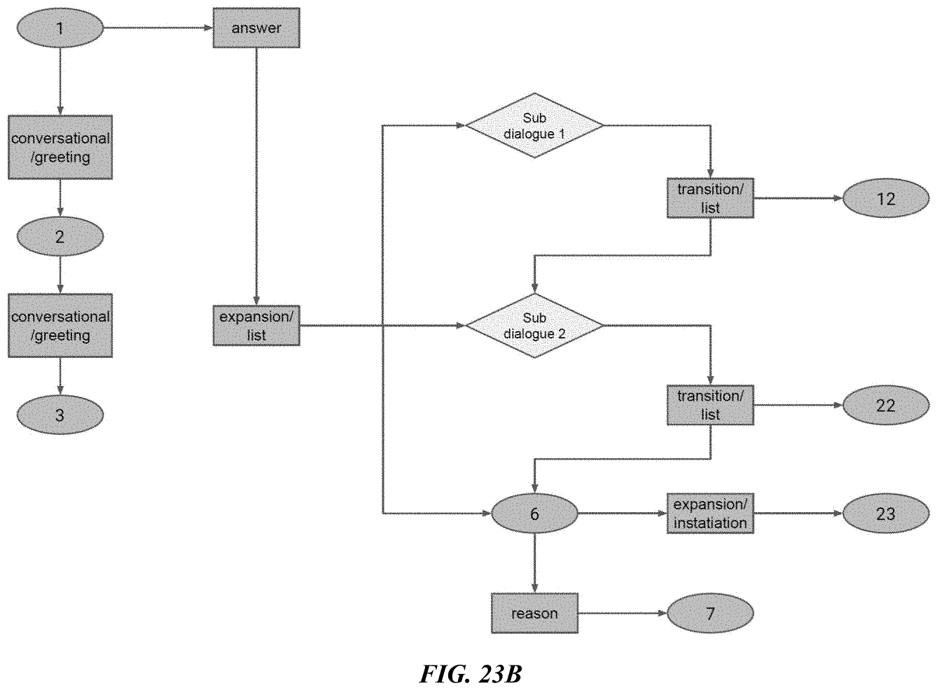

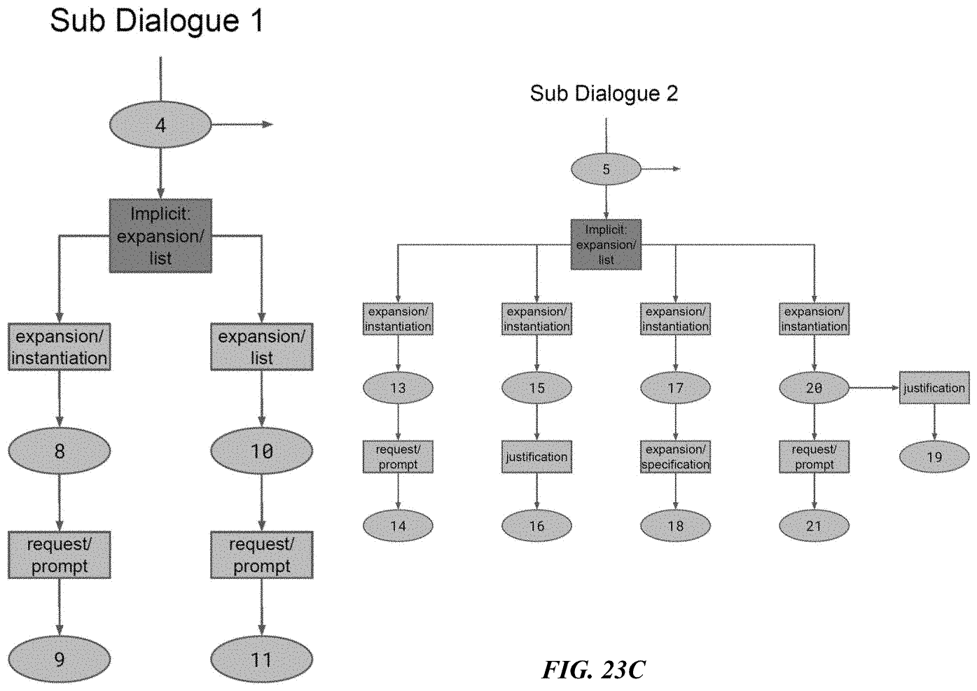

FIGS. 23A-23C illustrate an example social dialog with corresponding discourse representation graphs. FIG. 23A illustrates an example social dialog. The first turn may be “what's the latest?” from the user. The assistant system 140 may then respond to the user question with a long response which may be treated as multiple turns. These turns are enumerated as follows. (2) Good evening Madison, (3) thank goodness it's Friday. (4) I've got a few suggestions, (5) some key updates from friends, (6) and a cool video to show you (7) to wrap up your week. (8) Here are recent and upcoming birthdays—(9) would you like to wish anyone a happy birthday? (10) This weekend, there are a few great kids and outdoor events—(11) anything look interesting? (12) Moving on to top friend highlights. (13) Two of your friends got new jobs—(14) do you want to congratulate Deb Liu and Asha Sharma? (15) Your friend Yin Mei might be looking for support—(16) here's her post. (17) Jade posted a fun video, (18) it looks like her kid. (19) And it looks like it's been a while since you last connected with Tala Ramahi—(20) here's a recent post she made, (21) would you like to reach out? (22) To wrap up, here's your daily discovery: (23) Great white sharks in the wild [plays video].

FIG. 23B illustrates an example discourse representation graph. The discourse representation graph corresponds to FIG. 23A. After the first turn, the discourse representation graph may use a “conversational/greeting” relationship to connect the first turn to the second turn. There may be another “conversational/greeting” relationship connecting the second turn and the third turn. On the other hand, after the first turn, the discourse representation graph may have an “answer” relationship, on top of which there may be an “expansion/list” relationship, which may be further connected to sub-dialogue 1, sub-dialogue 2 and the sixth turn.

FIG. 23C illustrates example sub-dialogues. Going from FIG. 23B to FIG. 23C, the sub-dialogue 1 may start with the fourth turn. After the fourth turn, there may be an “implicit: expansion/list” relationship, which may be further divided into “expansion/instantiation” and “expansion/list”. Under “expansion/instantiation”, there may come the eighth turn. Under “expansion/list”, there may come the tenth turn. After the eighth turn, there may be “request/prompt” connecting it to the ninth turn. After the tenth turn, there may be “request/prompt” connecting it to the eleventh turn.

Going from FIG. 23B to FIG. 23C, the sub-dialogue 2 may start with the fifth turn. After the fifth turn, there may be an “implicit: expansion/list” relationship, which may be further divided into four “expansion/instantiation” branches. Under the first branch, there may be the thirteenth turn connected to the fifth turn. After the thirteenth turn, there may be “request/prompt” connecting it to the fourteenth turn. Under the second branch, there may be the fifteenth turn connected to the fifth turn. After the fifteenth turn, there may be “justification” connecting it to the sixteenth turn. Under the third branch, there may be the seventeenth turn connected to the fifth turn. After the seventeenth turn, there may be “expansion/specification” connecting it to the eighteenth turn. Under the fourth branch, there may be the twentieth turn connected to the fifth turn. After the twentieth turn, there may be “request/prompt” connecting it to the twenty-first turn and “justification” connecting it to the nineteenth turn.

Going back to FIG. 23B, the two sub-dialogues may be connected by “transition/list”, after which there may come the twelfth turn. After sub-dialogue 2, there may be “transition/list” connecting to the sixth turn and the twenty-second turn, respectively. The sixth turn may be connected to the seventh turn via “reason” and connected to the twenty-third turn via “expansion/instantiation”.

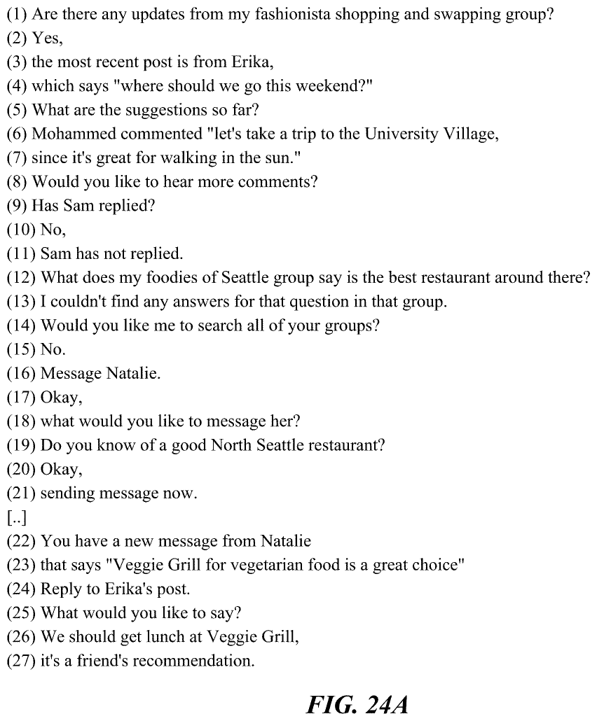

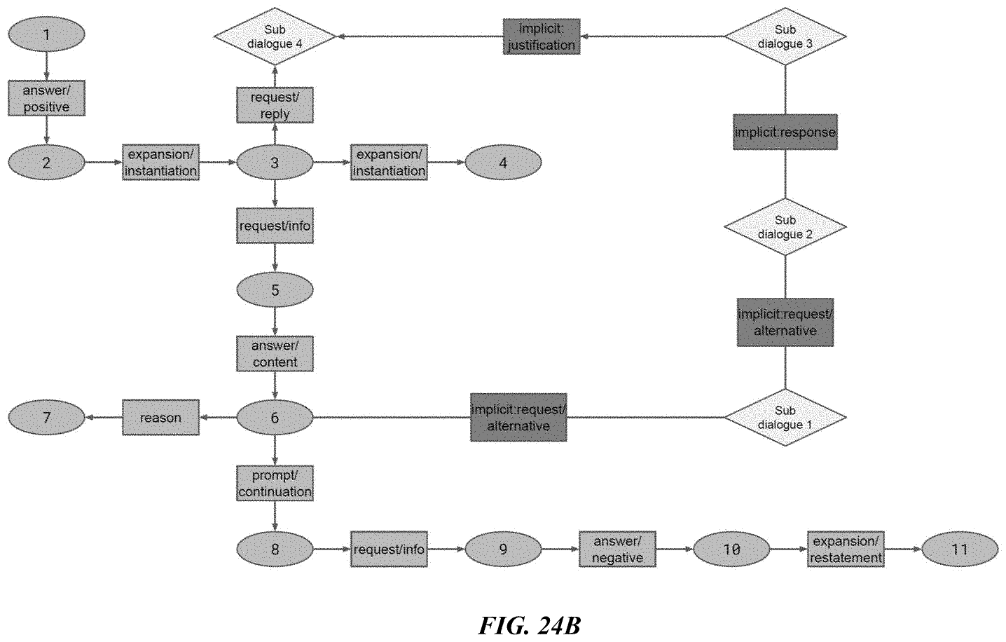

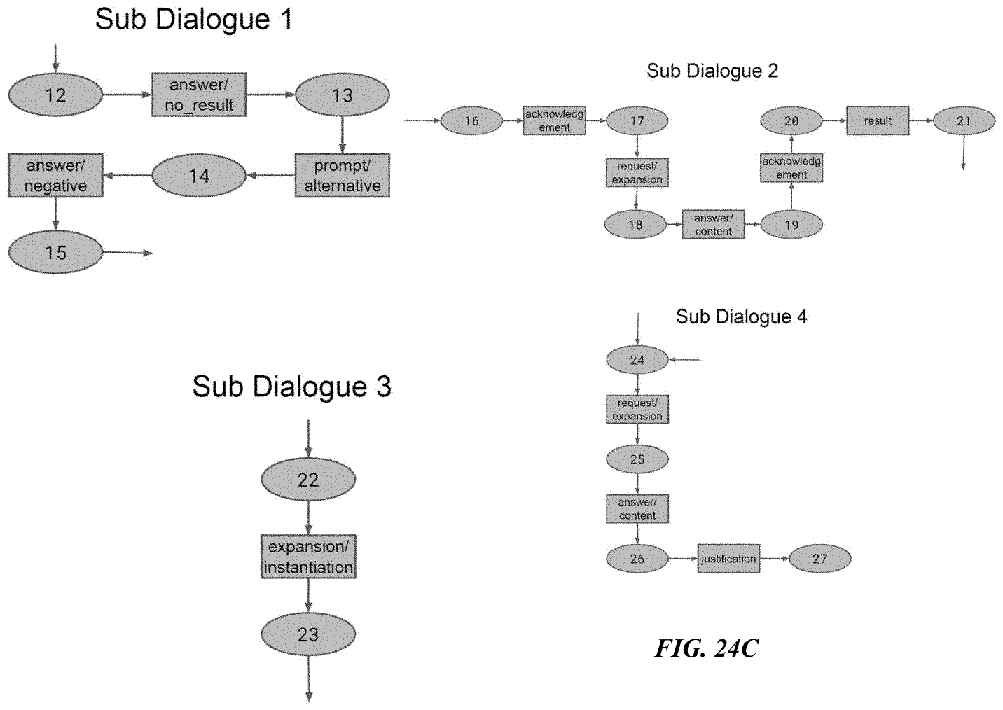

FIGS. 24A-24C illustrate another example social dialog with corresponding discourse representation graphs. FIG. 24A illustrates another example social dialog. At the first turn, the user may ask “are there any updates from my fashionista shopping and swapping group? From the second to fourth turn, the assistant system 140 may reply “yes,” “the most recent post is from Erika,” “which says ‘where should we go this weekend?’” At the fifth turn, the user may ask “what are the suggestions so far?” From the sixth to eighth turn, the assistant system 140 may reply “Mohammed commented ‘let's take a trip to the University Village,” “since it's great for walking in the sun.” “Would you like to hear more comments?” At the ninth turn, the user may ask “has Sam replied?” From the tenth to eleventh turn, the assistant system 140 may reply “no,” Sam has not replied.” At the twelfth turn, the user may ask “what does my foodies of Seattle group say is the best restaurant around there?” From the thirteenth to fourteenth turn, the assistant system 140 may reply “I couldn't find any answers for that question in that group.” “Would you like me to search all of your groups?” From the fifteenth to sixteenth turn, the user may say “No.” “Message Natalie.” From the seventeenth to eighteenth turn, the assistant system 140 may reply “okay,” “what would you like to message her?” At the nineteenth turn, the user may ask “do you know of a good North Seattle Restaurant?” From the twentieth to twenty-first turn, the assistant system 140 may reply “okay.” “sending message now.” After sending the message, the assistant system 140 may further say to the user from the twenty-second to twenty-third turn as “you have a new message from Natalie” “that says ‘Veggie Grill for vegetarian food is a great choice.” At twenty-fourth turn, the user may say “reply to Erika's post.” At twenty-fifth turn, the assistant system 140 may ask “what would you like to say?” From the twenty-sixth to twenty-seventh turn, the user may say “we should get lunch at Veggie Grill,” “it's a friend's recommendation.”

FIG. 24B illustrates another example discourse representation graph. The discourse representation graph corresponds to FIG. 24A. After the first turn, the discourse representation graph may use a “answer/positive” relationship to connect the first turn to the second turn. There may be an “expansion/instantiation” relationship connecting the second turn and the third turn. The third turn may be connected to the fourth turn via “expansion/instantiation”, the fifth turn via “request/info”, and sub-dialogue 4 via “request/reply”. The fifth turn may be connected to the sixth turn via “answer/content”. The sixth turn may be connected to the seventh turn via “reason” and the eighth turn via “prompt/continuation”. After the eighth turn, the dialog flow may go to the nineth turn via “request/info”. The nineth turn may be connected to the tenth turn via “answer/negative”. The tenth turn may be connected to the eleventh turn via “expansion/restatement”. On the other hand, the sixth turn may be connected to sub-dialogue 1 via “implicit: request/alternative”.

FIG. 24C illustrates example sub-dialogues. Going from FIG. 24B to FIG. 24C, the sub-dialogue 1 may start with the twelfth turn. The twelfth turn may be connected to the thirteenth turn via “answer/no_result”. The thirteenth turn may be connected to the fourteenth turn via “prompt/alternative”. The fourteenth turn may be connected to the fifteenth turn via “answer/negative”. Going back to FIG. 24B, after sub-dialogue 1, “implicit: request/alternative” may direct the dialog flow to sub-dialogue 2. Going back to FIG. 24C, sub-dialogue 2 may start with the sixteenth turn, which is from the fifteenth turn. The sixteenth turn may be connected to the seventeenth turn via “acknowledgement”. The seventeenth turn may be connected to the eighteenth turn via “request/expansion”. The eighteenth turn may be connected to the nineteenth turn via “answer/content”. The nineteenth turn may be connected to the twentieth turn via “acknowledgement”. The twentieth turn may be connected to the twenty-first turn via “result”. Going back to FIG. 24B, after sub-dialogue 2, “implicit: response” may direct the dialog flow to sub-dialogue 3. Going back to FIG. 24C, sub-dialogue 3 may start with the twenty-second turn, which is from the twenty-first turn. The twenty-second turn may be connected to the twenty-third turn via “expansion/instantiation”. Going back to FIG. 24B, after sub-dialogue 3, “implicit: justification” may direct the dialog flow to sub-dialogue 4. Going back to FIG. 24C, sub-dialogue 4 may start with the twenty-fourth turn, which is from both the third turn and the twenty-third turn. The twenty-fourth turn may be connected to the twenty-fifth turn via “request/expansion”. The twenty-fifth turn may be connected to the twenty-sixth turn via “answer/content”. The twenty-sixth turn may be connected to the twenty-seventh turn via “justification”.

The graph structures in FIG. 23B and FIG. 24B show how tracking each turn with contextual information may be achieved through the discourse and sub-graphs for sub-dialogues. It may be seen that the larger conversation may comprise a subgraph which produces relevant information bringing it back to the larger graph as its resolution of the multi-turn interaction between the user and the assistant system 140.

In particular embodiments, the assistant system 140 may use different approaches to represent discourse for parsing and analysis. As an example and not by way of limitation, such approaches may comprise rhetorical structure theory (RST), the Penn discourse treebank framework (PDBT), and question under discussion (QUD). RST, QUD, and PDTB each present their own representations either as a theory agnostic representation or tied to their own theories of discourse and pragmatics.

The embodiments disclosed herein first evaluated these approaches to discourse analysis and relations that have been used represent discourse in either analytical papers or computational methods. Each of these representations may have potential, but none may fit perfectly with our goal for AI assistants. The embodiments disclosed herein further discuss where these approaches excel and where they may have issues, and how we can incorporate their successes while avoiding their potential problems. With what being learned, the embodiments disclosed herein create a conversational and semantic parsing representation which may unify extant semantic parsing with the pragmatic and discourse information present in discourse and rhetorical structures. In particular embodiments, the assistant system 140 may incorporate these approaches and many of their principles into a more comprehensive representation of discourse, pragmatics, and semantics.

Rhetorical structure theory may describe discourse in terms of a recursive, binary tree structure with discourse units as terminal nodes connected by coherence relations as edges. The theory described an initial open set of 24 relations that were observed in the texts analyzed by researchers. These relations may be used to describe how and why two or more discourse units are related and thus occur adjacent to each other in the texts. This initial set has been expanded to include additional relations over the years that have been observed. The term discourse units may be often interpreted as clauses. However, many machine-learning works that used RST opted instead to use smaller units that would allow for easier translation as clausal structures were either mismatched or not effective separations.

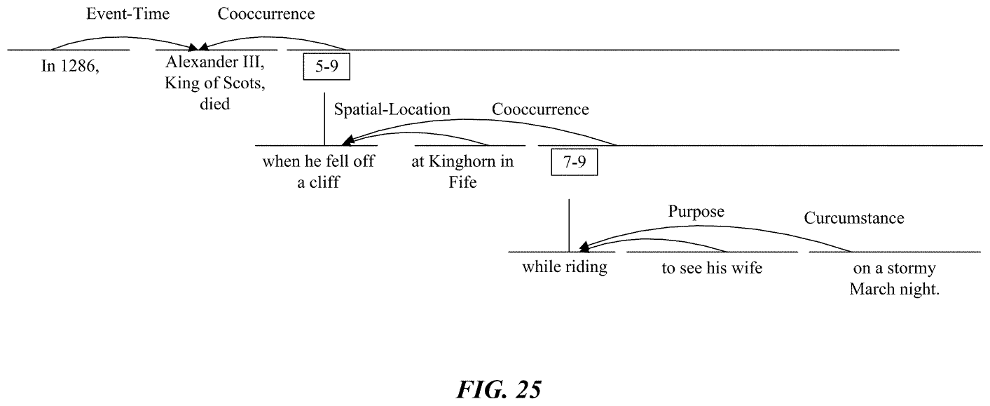

The relations in RST may operate on a nucleus-satellite connective structure. A nucleus in this sense may be considered to be the primary focus of a relation, while the satellite may be a modification or additive piece of information. The distinction between the two may be also used as a way of explaining overall text coherence. RST claims that a nucleus is core to the overall coherence of the discourse or rhetoric under analysis. FIG. 25 illustrates an example RST tree. The example RST tree may be used to show what is meant by coherence in this sense.

In the tree in FIG. 25, satellites are indicated by arcing arrows directed towards the nucleus they are tied to, with the relation name provided above the arrow. Nuclei themselves are indicated by either a straight line indicating they serve as the nucleus of a larger structure that is a satellite to another, or by the omission of arrows originating from their node (i.e. being the head of the tree). As such, if we read just the nuclei of the tree we have the text “Alexander III, King of Scots, died when he fell off a cliff while riding,” an arguable coherent statement. By contrast the satellites alone produce “in 1286, at Kinghorn in Fife to see his wife on a stormy March night” which is harder to argue is coherent.

There may be, however, issues with RST which make the theory as it stands problematic and potentially not the best decision for a modern AI assistant. First, there may be some issues behind the theory that it builds off of. As an extension of RST's construction of its nucleus/satellite distinction as a required piece of information for discourse, it also claimed that all coherent rhetorical discourses should have a definable RST tree structure. However, this claim as well as the absolute necessity of the nucleus/satellite construction for coherence has been viewed as questionable and unfalsifiable.

The definition of nucleus and satellite structure as necessary to the coherence and construction of the discourse may be problematic in another way. Many parses in RST may be annotated in multiple ways, with different relations being assigned over the same set of discourse units and these different interpretations can result in conflicting, mutually exclusive representations.

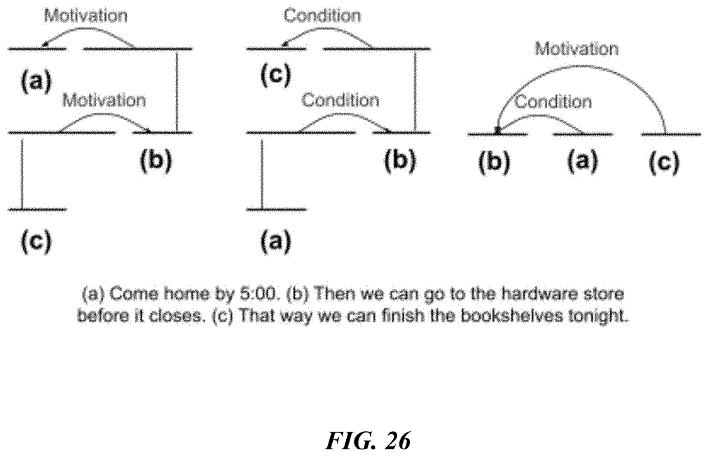

FIG. 26 illustrates example interpretations in RST. As we can see in FIG. 26, it may be often the case with relations in RST that there are multiple interpretations. The varying interpretability of these utterances may be problematic for computational discourse parsing, and may potentially result in reduced ability to recognize relations. In particular, when so many possible interpretations are possible and of equal standing it may be difficult or even impossible to adequately score predictions, i.e., is the prediction incorrect, or is it just an underrepresented interpretation?

While these issues may make RST non-viable for a direct representation of AI assistant conversations, there may be some aspects we can learn and reuse from it. The concept of a central nucleus may be repurposed to provide some additional direction for a conversation, and the general concept of relations as defined between clauses or discourse units may be a useful way to represent nodes in a graph (though this may be better represented in other ways, as we will see later). A structure created in the embodiments disclosed herein may do well to incorporate these aspects of RST.

Question under discussion (QUD) has recently been proposed as a parallel structure that may provide informative explanations about discourse relations aimed at simultaneous analysis of discourse and information structure. The information structure of a conversation may be the way in which speakers structure and represent information, discourse referents, and the overall shared universe of the conversation during the course of it. QUD may be based on an assumption that each relation in discourse is implicitly the answer to a question, referred to as a question under discussion. However, these recent approaches to QUD may be based on a graph structure that outlines the connections between question and answer information and how this forms the discourse structure.

In QUD, no discourse relations may be outright outlined, the questions (and information contained in their answers) instead being used as the justification for structural connections between discourse segments. Rather than a purpose relationship seen in FIG. 25 between the segments “while riding” and “to see his wife,” QUD may instead ask the question of “why was he riding?” to achieve the same connection.

This may differ slightly from the representations seen in PDTB and RST, which may focus on describing the type of relation made between the segments as a way ofunderstanding what supplemental information is meant to be relayed by their connection. QUD may instead focus on the information itself acting as the connection and may not make an attempt to describe or categorize it as a relation but just ask what the information is. QUD has been found to be able to work in conjunction with RST relations, with QUD providing a slightly more fine-grained informational layer to a graph with both QUD questions and RST relations than RST alone would be able to capture.

However, QUD may be also the most untested of the three evaluated here in the computational space. While a promising theoretical approach, there may be not a lot to base the computational reviews off of. Additionally, the annotation and data collection expense of annotating with questions as a relation in discourse may run the risk of being expensive and time consuming, potentially prohibitively so. This may effectively limit the ability to use QUD as an “out of the box” solution, and that those portions the assistant system 140 may incorporate in the discourse representation graph may need to be carefully considered beforehand.

The Penn discourse treebank may be aimed at providing a large-scale research resource of annotated discourse relations, and arguments. They may derive an empirically driven representation of discourse relations that they attempt to keep theory-agnostic and may have focused on descriptive annotations of discourse.

The basic structure of PDTB may lend itself to more restricted annotations, as they provide a more structured hierarchy of a limited number of relations. These may be broadly grouped into implicit and explicit structures separated by the presence of lexical indicators. They may directly correlate subordinating conjunctions (e.g. because, since, when), coordinating conjunctions (e.g. and, or), and discourse adverbials (e.g. for example, instead) with explicit structures. Additionally, a minimality principle was enforced as the necessary information to the relation was found to be less than what remained after the discourse token and its syntactically bound sub clause were removed when the relation occurred in a single sentence.

Implicit relations may be by contrast those instances where relations can be drawn between two clauses or discourse units yet there is no identifying token which calls it out. The relation may be instead left to be inferred by the reader or listener. These may be annotated by the insertion of an implicative token, generally in the structure of Implicit=BECAUSE. This lexical encoding of implicit relations was implemented as a measure for easing the annotation effort. However, subsequent research has shown that many readers are able to recover explicit tokens in much the same manner with no prompting, indicating some concept of a pragmatic conjunctive or discourse adverbial that is generated in these cases.

The PDTB may also allow for alternate lexicalizations (AltLex), wherein the inclusion of a token may introduce some redundancy of expression to the relations. This may be typically used for cases where very verbose expressions take the place of lexical connectives. Two other special cases may be allowed, entity relations and no relations, indicating implicitly entity relations or the lack of a relation.

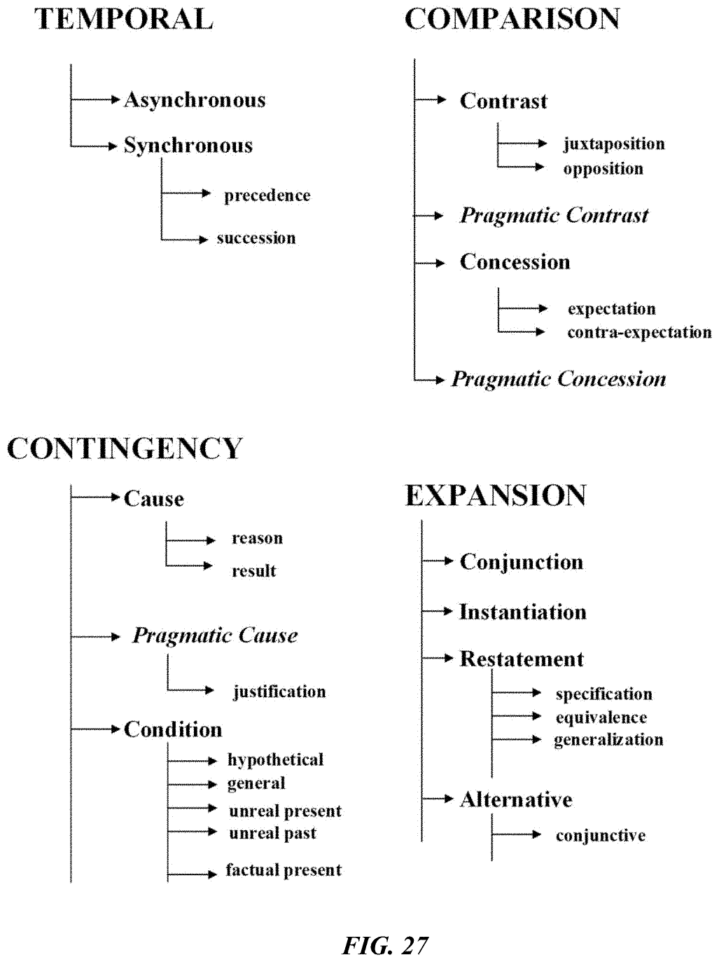

FIG. 27 illustrates an example hierarchy of QUD. For each explicit, implicit, and AltLex relation that was annotated in the corpus, PDTB may also allow the annotation of senses, and allow for multiple senses to be connected to a single relation. The senses may be separated into a three-level hierarchy, organized as class, type, and subtype. There may be four classes at the top of the hierarchy: temporal, contingency, comparison, and expansion. The rest of the hierarchy may be seen in FIG. 9.

While this structure may be useful for our purposes, and the theory-agnostic approach may make the general concepts adaptable as well, the PDTB annotation scheme may still need some further adjustments. For spoken discourse, changes have been required to properly describe the new patterns and relations seen in conversations. Additionally, it is likely that adjustments may be needed to connect the PDTB senses with our existing semantic parsing representations.

QUD, RST, and PDTB all have a history of applications or attempted applications in computational methods to either analyze, generate, or parse discourse. In the following sections we evaluate some of these previous applications and the literature surrounding each representation. Special attention was paid to spoken discourse, as it is integral to a conversational AI assistant.

The original RST used the trees present to do rhetorical analysis over numerous texts, and others continued this approach computationally, often using subsets of the relations outlined. The notion of parsing using these structures was introduced as rhetorical parsing, and parsed natural language texts into discourse trees represented through RST. This work also used RST trees to improve upon previous algorithms for cue phrase disambiguation. In fact, RST has been used as one of the more common representations for discourse analysis as a descriptive theory behind the rhetorical structures in part because of its long history.

However this and many similar studies that used RST focused on English, or occasionally another Indo-European language. RST corpora and treebanks were often adapted to suit the language chosen, but alternative selections may allow RST to be applied to data regardless of the language in question. This study also showed that multilingual models performed significantly worse than models trained on monolingual data sets. The relations may be applicable, but the manner in which languages apply and use these relations varies significantly enough that monolingual data sets seem to be the better approach, even among languages that are in the same language family.

PDTB was able to build off of previous computational work in discourse parsing, and very early after the treebank's release predictive models were being investigated by researchers that could predict Explicit relations, identify the lexical markers, and predict implicit relations. Researchers were then able to compile aspects of these into a discourse parser, built as an end-to-end pipeline connecting different methods necessary for implicit/explicit parsing.

Subsequent research has focused on producing more accurate parsers dedicated to additional discourse tasks, such as argumentation and argument parsing, or on improving discourse parsing through the inclusion of additional knowledge. Both areas found that PDTB worked well as a base to establish more elaborate methodologies on and could connect the relations outlined in discourse to external knowledge or similar labeling approaches.

The parsing and analysis of spoken discourse presents different challenges, however, in a handful of ways. The non-sequiturs more commonly produced in spoken discourse prove problematic for RST's claims of relations being necessary for coherence. We can discuss these pragmatically, as repairs and recognitions for example, and adjustments may be made to allow labeling of purposefully non-coherent discourse structures in RST. Additional relations, paraphrasing, repetition, correction, and parenthetical insertion may be used to describe spoken academic discourse within the bounds of RST in such a manner.

RST did not attempt to identify lexical markers of discourse relations like PDTB has for its explicit relations, which may increase the difficulty of identifying novel representations like those introduced for spoken discourse. However, prosodic speech components were found to play a role in discourse structure and may have been directly related to discourse relations.

Shortly after PDTB's release, there was some focus on spoken discourse in the PDTB-style. One work found that, in the course of adapting a spoken dialogue corpus to representation in PDTB-style annotations, some work was needed to adapt the structure. Their adapted approach was necessary to adequately accommodate disfluencies and implicit relations between non-adjacent segments that are very frequent in spoken language. Other adjustments were introduced to take pragmatic information into account in the sense hierarchy.

As PDTB itself is a very large resource of written discourse, only a handful of additional corpora may have been built in a similar style. The most prominent corpus to our knowledge may be the TED Multilingual Discourse Bank. Subsequent language-specific discourse banks have been drawn from TED-MDB, such as the TED Chinese Discourse Bank. While the spoken discourse corpora are relatively new in PDTB-style annotations, they show more of a propensity for transfer learning between multilingual and monolingual corpora in these extended corpora.

The Methodius corpus is a corpus that builds RST trees from information on entities like museum pieces and artifacts from which personalized descriptions related to others may be generated. It was based on M-PIRO developed during a period where RST was heavily favored for such constructions. However, Methodius was unique in making a corpus of input-output pairs available for research. The corpus was built to both elaborate on previous work, including the use of clause-combination rules, and act as a resource for learning referring expression strategies and other future research using machine learning to automate parts of the NLG process.

Recent work on the Methodius corpus focuses on the use of this corpus in neural NLG systems to reconstruct many of the generated output texts. It was found that the identification of discourse relations was useful in achieving predictions of higher quality and fewer errors. This may be surprising, as technically the discourse itself may comprise all the necessary information, but the annotation of relations may reduce errors significantly.

Conversational or explanatory discourse generation has not, to the best of our knowledge, been thoroughly examined using PDTB or PDTB-style annotations to date. However, PDTB has been used as a basis for generation of natural language, particularly in part with discourse parsers and used to generate question. There has also been some work on using PDTB-style annotations as an input for discourse planning in generative models. However, such work may have highly abstracted the PDTB inputs from the original annotation style. With entity relations treated as a subset of expansion and the rest of relations reduced to their class-level labels, the data inputs may be much less specific. They also removed the relations themselves, opting instead to use just the sense annotation as the most useful for planning discourse for generated responses.

There may be also additional approaches that may be used for discourse representation graphs in the embodiments disclosed herein, such as discourse combinatory categorical grammar and the cognitive approach to coherence relations. Each of these may follow this organizational structure and be used for different aspects of discourse analysis, parsing, and generation with different theoretical backing.

RST, QUD, and PDTB may all provide useful methods of describing or evaluating discourse and information structure. However, they may also have some issues that may arise in attempting to use any of them without modification. An awareness of the relationship and senses as defined by PDTB or RST with some understanding of the connective theories such as QUD may give us a good starting point for developing a discourse representation. Given PDTB's theory-agnostic approach and established variation between relation and senses, as well the interoperability included in its construction, it would likely serve the best as the initial starting point for development. As such, the assistant system 140 may use a discourse representation based on PDTB which may graph overall conversations, either between user and assistant or for the assistant's consumption, and potentially connect to other graph representations for knowledge, semantic parsing, co-reference, and entity recognition. This representation may then be used in many different social scenarios (such as community Q&A) and session based NLU and executable NLU.

Understanding the information built into the structure of a conversation may be key to understanding the higher flow and implementation of said information in underlying intents, utterances, and the role additional context may play within them. By having an understanding of the connections within discourse, the embodiments disclosed herein may provide insights into the incorporation of knowledge from other sources into a semantic parse and subsequent execution. This may include understanding how information relates to each other, how likely information is to be brought into a conversation, or even how likely information is to be relevant again within the same conversation. It may even be used to parse relevant and useful information from lengthy conversations, formulate a coherent response, and provide a summary of the relevant information to a user. It may also provide an ongoing representation of the discourse as a whole, which could serve as both a central representation which all pieces of the assistant pipeline may interact with directly. This may eliminate the necessity for some pieces of glue code between pipelines and their individual segments. A centralized discourse representation may also aid in some of the emerging systems which aim to provide a more accurate parse by incorporating the entirety of a dialogue in the prediction.

### Community Question and Answering (Q&A) Retrieval

In particular embodiments, the assistant system 140 may conduct community Q&A retrieval, which provides relevant opinion-based answers to a user question by utilizing all of the community resources associated with the social-networking system 160. For example, this type of user questions may be “what's the best Montessori based preschool in Menlo park?” or “what are some toddler-friendly breakfast recipes that are egg and gluten free?” Based on community Q&A, the assistant system 140 may provide the best personalized response by supplying helpful advice and creating the opportunity for new connections among users. Community Q&A may be different from what users would try to do with a public search engine or a knowledge database where users are trying to find factual answers (e.g., getting answers from a knowledge graph). The assistant system 140 may extract answers from all sources associated with the social-networking system 160 including newsfeed, groups, public posts, messages, etc. To address the challenge of finding other users' posts asking similar/same questions and finding diverse answers, the assistant system 140 may use a new machine-learning architecture for answer retrieval, extraction, and ranking. To provide diverse answers to users, the assistant system may show multiple possible answers. These possible answers may also give the querying user an understanding of the diversity of different answers. The assistant system may ensure diversity by extracting answers from different posts that are diverse/different. The assistant system may also perform semantic comparison between possible answers to make sure they are diverse. Although this disclosure describes particular retrieval by particular systems in a particular manner, this disclosure contemplates any suitable retrieval by any suitable system in any suitable manner.

The community Q&A function may enable the assistant system 140 to answer opinionated questions from social-groups posts and comments. The following is an example answer to a first user's question “What is a_fast board game for 3?” The assistant system 140 may perform community Q&A and retrieve posts from a boardgames group because a second user asked “what's the best multiplayer board game? I'm trying to find something not too long for after a dinner party.” For the second user's question, a third user may have posted “for games, I recommend: invention world, and of course, invention risk. But by far the best quick multiplayer game is Best Invention.” The third user's post may be retrieved as an answer to the first user's question.

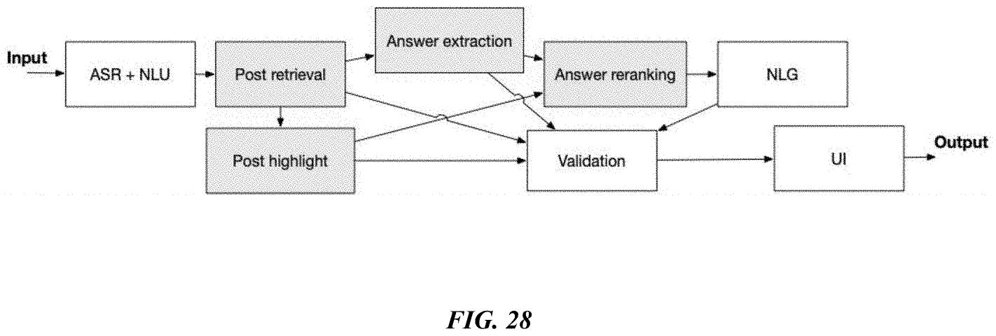

To deliver answers based on community Q&A, the assistant system 140 may use a retrieval system to find candidate similar posts, an answer selection model to find the right answer from the posts' comments, and a ranker that uses metadata to order the best results. FIG. 28 illustrates an example diagram workflow for community Q&A. A user input may be first processed by the ASR module 208 and the NLU module 210. The processing results may be sent to the retrieval system for community Q&A. As indicated in FIG. 1, the retrieval system may primarily comprise four components, i.e., post retrieval, answer extraction, answer reranking, and post highlight. In post retrieval, the assistant system 140 may determine the semantic meaning of the user input and identify semantically similar posts. This may be a challenge because standard techniques of finding semantically similar content may give similar answers about different topics and return those. For example, if a user asks “what's the best way to cook chicken?”, existing models may identify a post saying “what's the best way to cook tofu?” as a relevant result because of the similarity between the two sentences. But responses to the second question aren't relevant to the user asking the first question. Therefore, the assistant system 140 may perform entity matching between the user input and the search results to make sure the extracted results actually relate to the entity/category associated with the user input (e.g., “chicken”).

Once the assistant system 140 determines the semantic meaning of the user input along with the relevant entities/categories, the assistant system may retrieve relevant posts from the various community sources. After the assistant system 140 identifies relevant posts, an answer extraction module may extract text from each post that is relevant to answering the user's question. These extracted answers may be then ranked by an answer reranking model.

Besides generating diverse opinion-based answers from the community, the assistant system 140 may additionally generate post highlights (e.g., because the original posts may be too long). A post highlight may include a snippet of the retrieved posts that are extracted, and these highlights are what is shown to the user with the answer.

The top ranked answer may be then provided to the NLG 372 to render a response. When returning an answer to the user, the assistant system 140 may give the user context on the source(s) of the answer. For example, an answer may be like “there are 10 posts talking about this. Your friend Kevin posted in the Weight-Lifting group . . . ” The assistant system 140 may use an answer summarization process to generate the context and insert it at the beginning of the response, which means the initial part of the NLG output may be the summarization. The second half of the NLG output may be the answer, which may be the top ranked answer from the answer ranking module. Before rendering the response to the user, the results from post retrieval, post highlight, the answer extraction module, and the NLG 372 may go through validation. The validation may guarantee that these results are appropriate for the user. The validated results may be provided to the user interface (UI), which may further generate an output that is rendered to the user.

In particular embodiments, the assistant system 140 may use a combination of text search and semantic embedding search to retrieve posts. The text search may be based on a text-search model (TSM) for scoring results based on the n-gram overlap between the query and the document that is retrieved. The text-search model (TSM) may use term frequency (TF) and inverse document frequency (IDF) statistics for the score calculation.

The semantic embedding search may be based on a retrieval model (RM) that uses a bi-encoder for embedding the posts and questions such that similar pairs have a high embedding dot product. By performing search in semantic embedding space, the language meaning may be taken into account. In particular embodiments, the assistant system 140 may train the retrieval model (RM) on pairs of negative and positive group posts.

In particular embodiments, the assistant system 140 may tune parameters for the text-search model (TSM). Unlike the retrieval model (RM) which may have millions of parameters, the text-search model (TSM) may have only a few parameters to tune correctly for good results. First, the assistant system 140 may turn the average post length parameter that allowed one to reduce the retrieval bias towards longer posts. Second, the assistant system 140 may use bi-grams for better phrase scoring. The following includes two examples of the top three results before and after tuning the text-search model (TSM) for text search. Note that the baseline results are much longer and tend to over-specify. In the first example, the query may be “shepherds pie recipe suggestion.” The top-one baseline result (i.e., before tuning the text-search model) may be “made shepherds pie the other day for the time. It was okay, nothing special, stuck to a super simple, basic recipe. What's your favorite recipe for shepherds pie? Any tips/tricks?” The top-one tuned TSM result may be “what's your favorite shepherds pie recipe?!” The top-two baseline result may be “what is everybody's shepherds pie recipe?” The top-two tuned TSM result may be “what is everybody's shepherds pie recipe?” The top-three baseline result may be “can I please get a shepherds pie recipe?? I honestly feel like I live under a rock because I have no clue to what a shepherds pie is.” The top-three tuned TSM result may be “shepherds pie recipe?”

In the second example, the query may be “tips on growing tomatoes.” The top-one baseline result may be “any tips for successful growing of Husky Cherry Red tomatoes? I searched a bunch of info but looking for tips from those that have successfully grown this variety. This is my first foray into tomato growing and I don't want to screw it all up lol.” The top-one tuned TSM result may be “anyone have any tips/preferences on growing regular tomatoes and sweet tomatoes from seeds?” The top-two baseline result may be “another novice gardener question: Is there something wrong with my tomatoes? I have beautiful, growing, green tomatoes, but the tips of each of my tomato plants looks shriveled up. Is there something wrong? . . . the only thing I've put on them is a special spray.” The top-two tuned TSM result may be “tried planting Tomatoes, no luck. What are some tips for growing healthy one?” The top-three baseline result may be “I mostly grow flowering plants because vegetables intimidate me. My husband tries every year to grow tomatoes in pots in the sun but the yield is extremely poor. I am thinking of surprising him with raised planters (waist high) for Father's day, but what is the best time to plant tomatoes? Is that too late? What we eat the most of is roma and cherry, but I do miss those juicy tomato sandwiches from years ago. Any tomato growing tips are greatly appreciated.” The top-three tuned TSM result may be “does anyone have tips for growing tomatoes in containers? Edited to note, I'm in the Sunset District in San Francisco.”

In particular embodiments, the retrieval system may use a particular search engine associated with the assistant system 140 as a backend. The particular search engine (SE) may power many social experiences including music Q&A. The particular search engine (SE) may provide infrastructure for running both the text search model (TSM) and retrieval model (RM), as well as a rich querying language that allows advanced filtering on attributes like language, location, group name and group identifier. The particular search engine (SE) may also support k-nearest neighbor (KNN) search. The particular search engine (SE) may additionally support constrained search which allows us to efficiently implement fuzzy group name matching. The particular search engine (SE) may further support radius search for easier location constrained searching. For retrieval systems, there may be two distinct stages, indexing and runtime search. The indexing stage may be when the posts are preprocessed offline for fast access. The runtime search stage may deal with scoring and ranking the results of user queries.

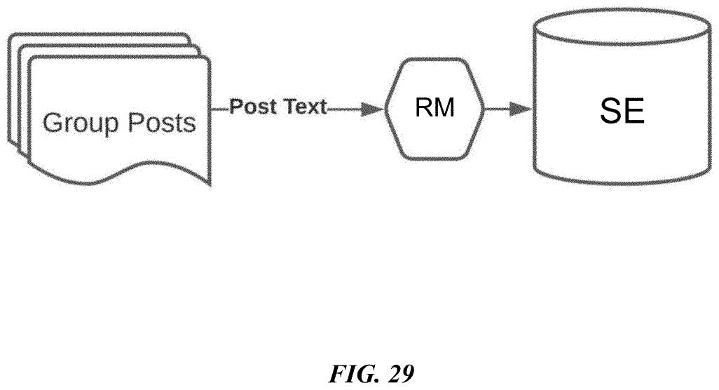

FIG. 29 illustrates an example indexing pipeline. We take post text and metadata from different social groups, create embeddings using a retrieval model (RM), and index both the post text and embeddings of the retrieval model (RM) using the particular search engine (SE).

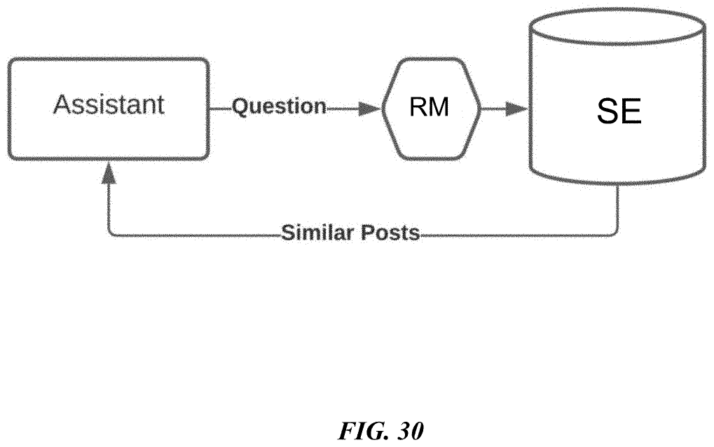

FIG. 30 illustrates an example runtime search pipeline. The assistant user may ask a question which is embedded using the retrieval model (RM). Then, we use both the embedding and text from the question to search the SE index for similar posts. The results from the embedding and text search may be ranked using the formula 1.5×RM score+TSM score. The similar posts may be returned to the assistant system 140 where the comments may be analyzed using the answer selection model and ranked to produce the final result.

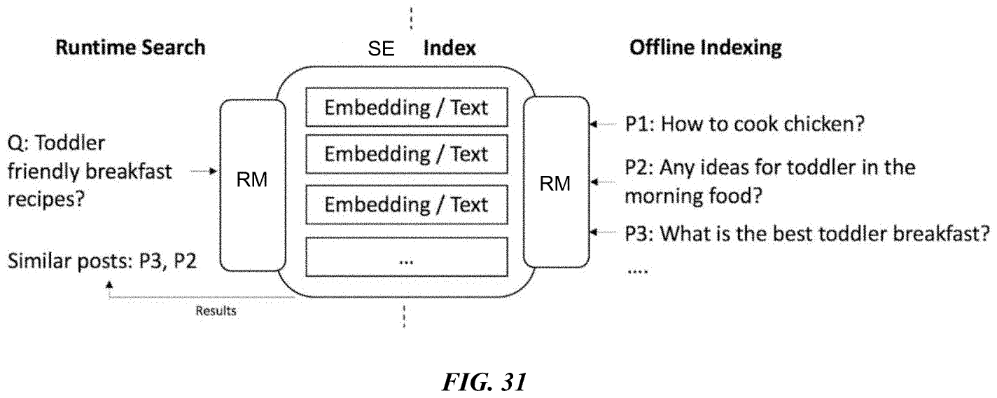

FIG. 31 illustrates an example workflow for community Q&A for an example query. During offline indexing, different posts such as P1, P2, and P3, etc. may be processed and provided to the retrieval model (RM). During runtime search, the system may receive a query as “toddler friendly breakfast recipes?” The query may be processed by the retrieval model (RM), which may search the SE index of embedding/text to find relevant post. As an example, the results may comprise similar posts as P2 and P3.

In alternative embodiments, the assistant system 140 may use KNN embedding similarity search instead of the particular search engine (SE).

In particular embodiments, the community Q&A may be applied to different use cases as the retrieval architecture based on the particular search engine (SE) allows us to efficiently implement features of community Q&A. One use case may be location-aware queries. Location may be important for some questions like “what is the best preschool in San Francisco?” To address location-aware questions, the assistant system 140 may index the post location and use the radius search of the particular search engine with the location specified in the query. This may give us results within a 500-mile radius of the specified location. Then the assistant system 140 may use the distance in some cases to rank the closer results higher. For post location, the assistant system 140 may use one or more APIs to get the group's approximate location from majority group members location and other signals like the group name.

Another use case may be group name search. With the particular search engine, we the assistant system 140 may conduct a joint search on both post text and group name and entirely avoid the overhead of using APIs to search for group names and then use the resolved group identifiers for filtering.

Another use case may be personal group result biasing. To enable personal group biasing the assistant system 140 may implement the following protocol. If the user asks for a group, the assistant system 140 may do a fuzzy search over the user's groups and use the best matching group identifier in the query as a hard constraint. This way the assistant system 140 may guarantee matches from a specific group. If the user doesn't ask for a group, i.e., cross group search, the assistant system 140 may make two queries, one for open groups, and one with all user groups based on the user's group identifiers. Then the assistant system 140 may merge the results, thereby increasing the chance that results are from the user's personal groups. For both cases, matching on group identifiers may be necessary which was efficiently implemented in the particular search engine without difference in latency.

In particular embodiments, the assistant system 140 may use an API for accessing the community Q&A search with the particular search engine. The assistant system 140 may also have a command-line interface (CLI) tool for quick testing and experimentation of the script ofr community Q&A.

### Content Stitching Graphs in Natural-Language Generation

In particular embodiments, the assistant system 140 may provide a natural-language response to a user by converting data from multiple sources into text. The multiple sources may include multiple knowledge databases, user memory, chit-chat bot, original input, etc. Alternatively, the multiple sources may also just be multiple data pieces from a single source. The assistant system 140 may then use the NLG to determine how to combine the data from different sources into a natural-language response that makes sense and is responsive to the user (i.e., a human-like answer). The assistant system 140 may generate a “content stitching graph” (CS graph) by first ingesting the intermediate graphs (raw data from knowledge databases) and converting the intermediate graphs to a CS graph, which represents the language (i.e., parts of speech) and data (i.e., entities and attributes) in a graph in a relational manner. In the CS graph, each node may have a node type, node label, and node identifier (ID). A basis CS graph may have entity nodes and predicate nodes. More complicated CS graphs may also have identifier nodes, value nodes, modifier nodes, and connector nodes. Once the CS graph is generated, the NLG may use a simple graph-to-text model to generate the natural-language response. Meanwhile, the assistant system 140 may use grammars to understand the CS graph and generate the NLG string. A “grammar” may be defined as an unambiguous set of rules for defining a structure. In this context, the grammar may comprise the rules/structures that allows us to read these graphs. Grammars may allow the assistant system 140 to read content stitching graphs using graph-to-text to generate a text string. An example use case for using CS graphs to generate natural-language responses may be as follows. A user may ask “does the Indian restaurant deliver?” The assistant system 140 may then retrieve data from knowledge databases and form an intermediate graph. The assistant system 140 may determine that the restaurant is not currently open and translate the intermediate graph data into a content stitching graph. The NLG may then use a graph-to-text model to translate this into a natural-language response like “Raj Indian Cuisine delivers, but it's currently closed.” Although this disclosure describes generating particular responses using particular graphs by particular systems in a particular manner, this disclosure contemplates generating any suitable response using any suitable graph by any suitable system in any suitable manner.

The overall objective of NLG may be to turn data into assistant text and speech responses. Data-to-text may be done in various ways, although one may need to tackle two subproblems in any case, i.e., representation (organizing and representing data) and transduction (generating surface forms from the representations). Due to the way data may vary wildly across tasks, NLG may have an input problem: How does one scalably represent an overabundance of data artifacts produced by the assistant system 140, in a way that they can then scalably generate NLG responses from these representations?

NLG may use assistant entities as inputs and make representations from a fusion of these entities with an internally defined elementary ontology. This may be enough to represent data for most of the utility domains (e.g., alarm, timer, reminder, time, weather), although the recent Q&A and communities use cases may require more complex input data types (such as relations in addition to entities) with more complex NLG responses. A particular challenge may be to support custom data inputs for a growing number of such experiences when no NLG infrastructure was in place to handle them.

For example, a user query may be “who are Rustin Famous's siblings?” For such query, the assistant system 140 may determine the assistant task data and access a knowledge graph. The query, task data, and accessed data from the knowledge graph may be formulated into representations, which may be provided to machine-learning transducers to generate the response, which may be “Rustin Famous's siblings are Jacopo Famous and Zion Famous.” However, there may be a problem at scale when the query becomes “who is Rustin Famous's eldest brother that's also a singer, and do I have any friends who are connected to him?” For this complex query, one may need a large collection of assistant artifacts to fulfill the task. In addition, the task-specific machine-learning transducers which may not scale. Furthermore, the transducers may perform template lookup but the task-specific representation libraries may output template arguments coding and template grammar that don't scale.

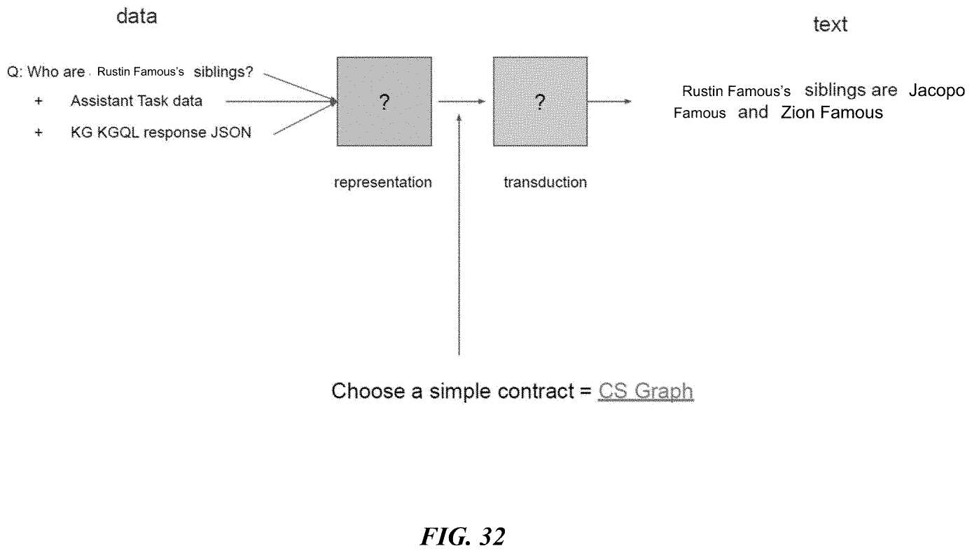

FIG. 32 illustrates an example incorporation of content stitching graph for response generation. The objective of content stitching (CS) may be to solve the above scalability problem of NLG, and to enable complex general NLG use cases by serving as a simple contract between the representation and the transduction. It may achieve that goal by tackling representation. In content stitching, representation may be stored as a single dynamic object, namely a CS graph. The graph may serve as a bottleneck between data and text, and allow to: 1) build representation infrastructure once, and use it to map any input data type to graphs for any task; and 2) keep input dependencies away from transduction, allowing it to be universal (a.k.a. task-agnostic).

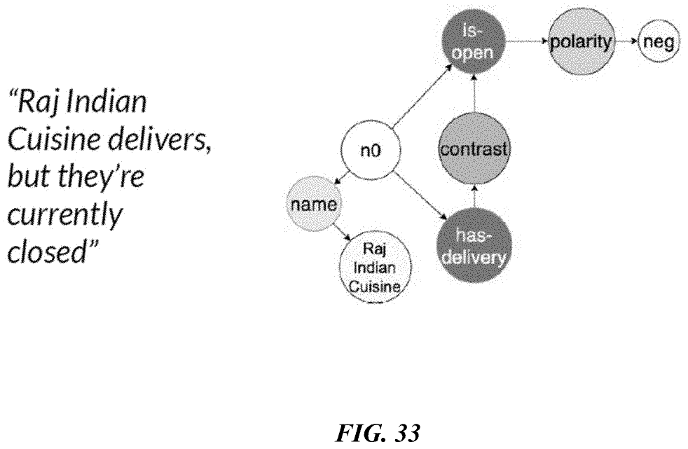

FIG. 33 illustrates an example CS graph. In particular embodiments, the assistant system 140 may represent language and data together in CS graphs. The assistant system 140 may then perform data processing and use end-to-end (E2E) data to generate text, e.g., “Raj Indian Cuisine delivers, but they're currently closed.”

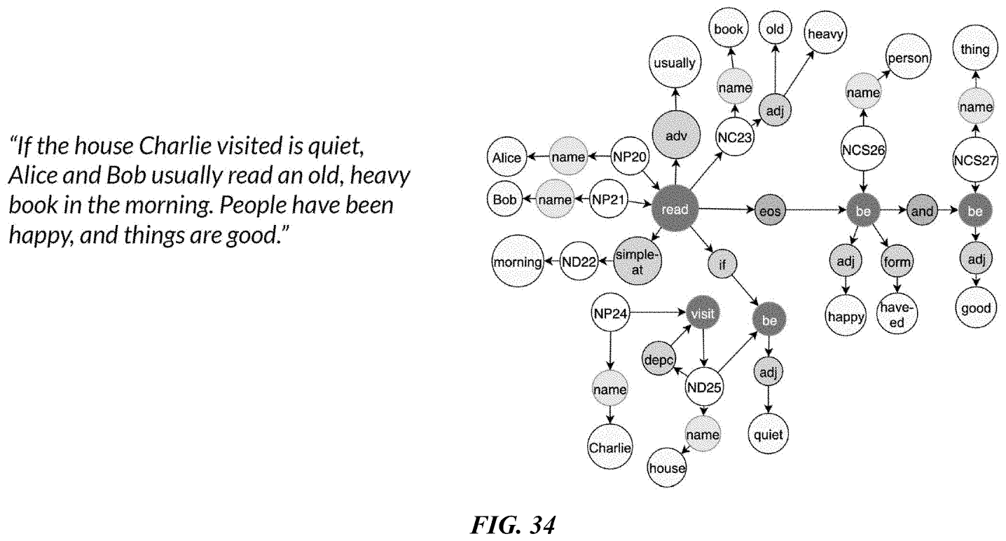

FIG. 34 illustrates another example CS graph. The assistant system 140 may represent language and data together in CS graphs and use end-to-end (E2E) data to generate text, e.g., “If the house Charlie visited is quiet, Alice and Bob usually read an old, heavy book in the morning. People have been happy, and things are good.”

In particular embodiments, CS graphs may support a family of assistant-specific data types out of the box, which allows one to use content stitching natively for various assistant experiences. In particular embodiments, users may need to write source adapters that convert the following data types to CS graph inputs. For assistant task data, content stitching may support reading the triggering intent (if any), and all of the task state slots. Content stitching may additionally support reading the entities from the slots and adding them to the graph.

In particular embodiments, content stitching may support different APIs from the knowledge graph (KG). As an example and not by way of limitation, one API may comprise KGQL API with JSON string output. As another example and not by way of limitation, another API may comprise a search API with list of entities. With these APIs, one may ingest any KG data (e.g., entities and relations) into a CS graph.

In particular embodiments, content stitching may support a plurality of AUM entry types. In particular embodiments, content stitching may support assistant entities. Assistant entities may be a special data type, which map to the entity nodes in the CS graph. Content stitching may support reading as well as creation of assistant entities. Apart from being able to read assistant entities into the graph, content stitching may be integrated with assistant entities in the following fashion. Firstly, each supported assistant entity type may have a corresponding graph entity node and supported assistant entities may have an optional field called “node identifier (ID)”. In the case that this field is populated, rather than initializing a random node for the entity, content stitching may use node ID, which is assumed to be an existing node in the graph. The NLG 372 may be in closed loop for authoring of new assistant entities that are CS graph-compatible. Sometimes, assistant entities may have a different format than how they will be represented in the graph. In these cases, the assistant system 140 may leverage graph planning during the graph ingestion step (for ingesting this entity). In particular embodiments, content stitching may also create assistant entities from an entity node (collection entity if there is a list of nodes).

In particular embodiments, content stitching may support reading from SGRs (serialized graph representations), and even from plain text by parsing the text into a CS graph.

In particular embodiments, to facilitate NLG 372 with the framework, content stitching may support CS graph operations that are key for converting custom data into adequate NLG 372 output formats. There may be two main graph operations: read and edit. Edit rules may do general graph editing, including initial ingestion of graph input and graph planning (or “response planning”). Read rules may get readouts from graphs. Among all possible read and write operations, there may be three key ones: graph ingestion, graph-to-text (GTT), and graph-to-entity (GTE).

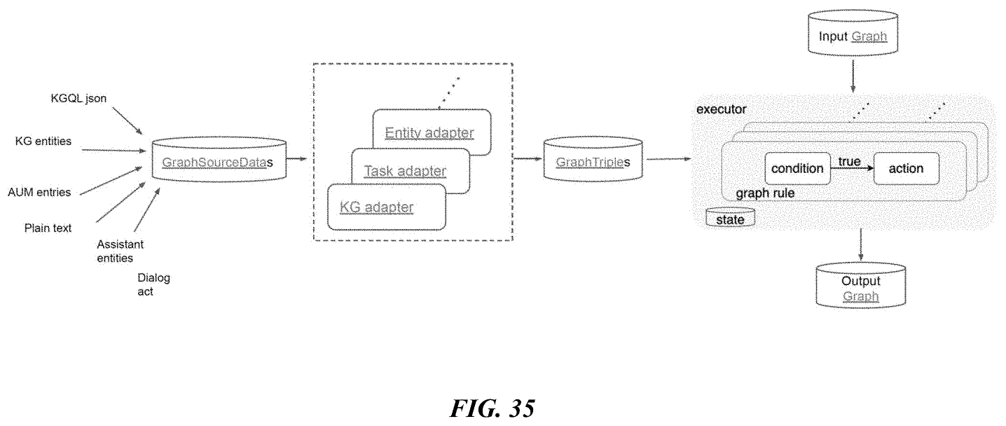

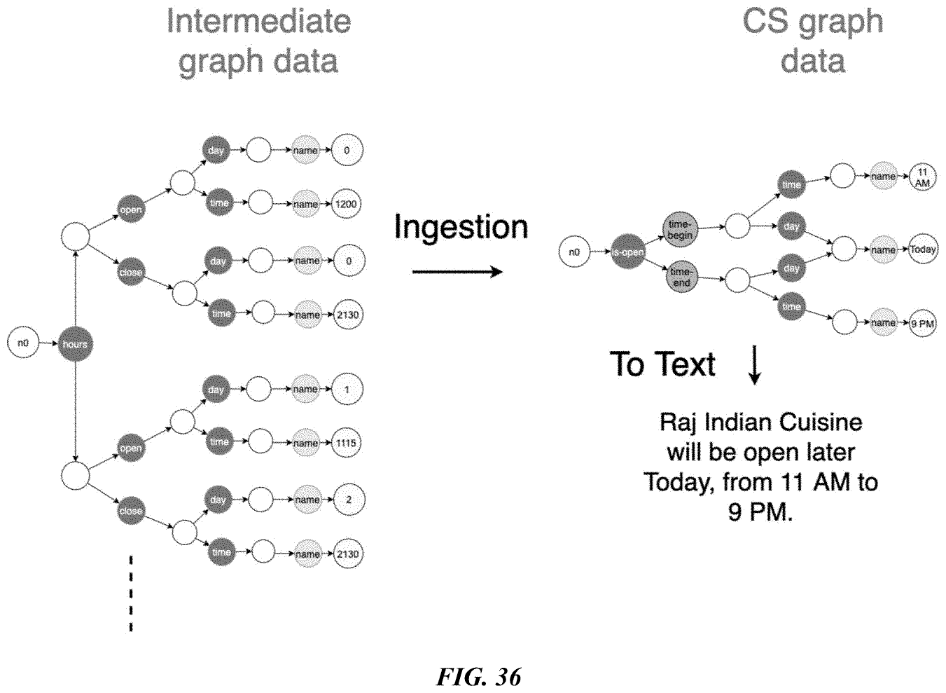

FIG. 35 illustrates an example workflow for graph ingestion. Graph ingestion may add data to a CS graph including KG, AUM, assistant entities, plain text, assistant Task, session, etc. Graph ingestion may be a graph edit operation. The role of an ingestion operation may be to take raw graph triples (the canonical graph input) and add them to the CS graph. There may be data processing involved, commonly referred to in NLG as response planning. FIG. 36 illustrates an example graph ingestion for text generation. FIG. 36 shows the intermediate graph, which may be represented by the raw graph triples. Ingestion may take this raw graph data and morph it into the desired format, which may be guided by graph grammar and feedback on what data needs to be represented and how. Much planning may happen during ingestion. FIG. 36 also shows an example where the KG gives us operating hours for 7 days of the week (numbers 0-6) for a place, and the assistant system 140 turns it into a graph describing its current open/close information.

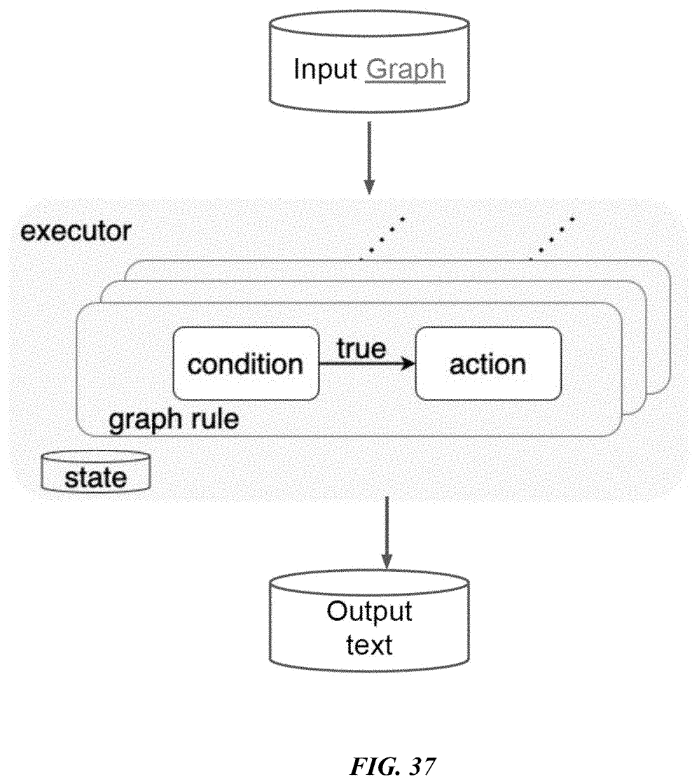

FIG. 37 illustrates an example workflow for graph-to-text. Graph-to-text may be a read operation which turns the CS graph (the main input) to natural language text that describes it. In particular embodiments, the assistant system 140 may frame graph-to-text as text transduction by graph traversal. The sub-operations may traverse the graph one hop at a time, according to either programmatic or ML-based rules. For instance, these support the traditional sequence-to-sequence generation paradigm. For that, one may author rules that first serialize the graph into an intermediate text by traversing nodes according to certain graph grammar rules and then feed that text along with the context (e.g. dialog history) to a generation model. For simple cases, one may also carry out the transduction in a fully programmatic way, looking up templates along the way to build an NLG text.

The following may be an example list of GTT rules (declaring logic). If there is a future node, GTT may traverse that node and incremental SGR update. If text isn't empty and no future nodes exist, GTT may call predictor to run a sequence-to-sequence transformer model. If text isn't empty and no future nodes exist, GTT may validate text. If text is empty, GTT may find a root node.

The following may be example GTT operation executions (control flow). If text is empty, GTT may find a root node. While future nodes exist, GTT may traverse node and incremental SGR update, call predictor to run the sequence-to-sequence transformer model, and validate text.

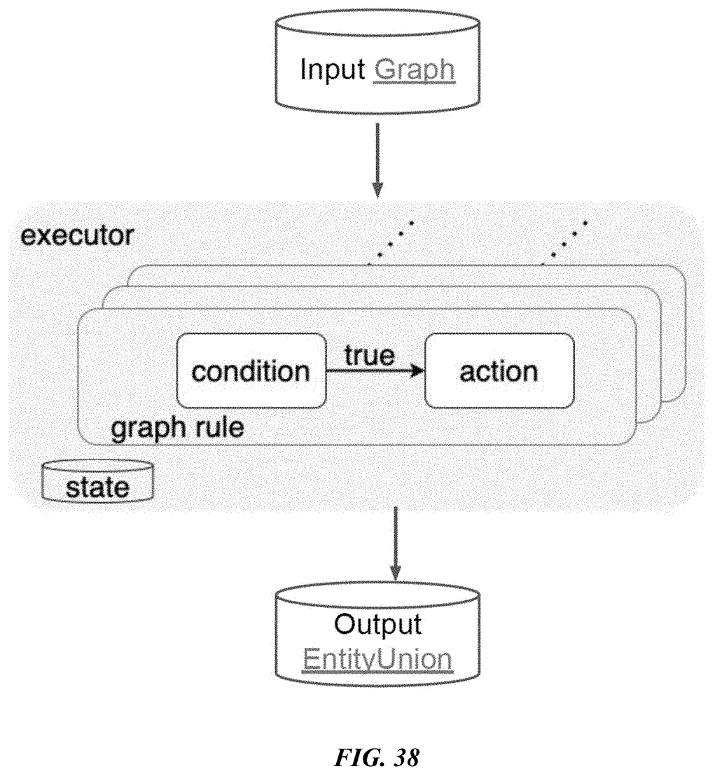

FIG. 38 illustrates an example workflow for graph entity export. Graph entity export may be a read operation and may be used for converting entity nodes in a CS graph to assistant entities. Graph entity export may have great scaling if no custom export is needed. It may support dynamic entities and support others through it. In particular embodiments, graph-to-entity may take query SGRs that each describes an entity node of interest and use graph entity to assistant entity converter rules for each query SGR, returning the requested assistant entities.

In particular embodiments, one may use content stitching as a standalone library, as well as an RPC (remote procedure call) service. This may allow to add all supported source data into graphs and turn them into text using currently registered operations.

In particular embodiments, content stitching may be integrated into the assistant system 140 through existing assistant paradigms and patterns. The integrations may revolve around two building blocks. One building block may be graph integration for assistant entities. Assistant entities may be the canonical way for content stitching to communicate data with other assistant runtime components. We may add graph metadata (e.g., “node ID”) to existing, supported entity types in order to achieve a seamless integration without changing current behavior. The other may be integrations with first-party assistant data providers. We may build source integrations directly with APIs for data providers like KG, AUM, etc. in order to stand up experiences without having to worry about parsing the fetched data and communicating them to NLG. In addition, the integrations may be capable of facilitating multi-turn (two-way entity exchange), data parsing and answer generation for Q&A module, NLG for task driven agents through NLG module 372 (via dialog acts).

In particular embodiments, for Q&A module integration, content stitching may serve as its data parsing and answer generation backend for the Q&A module. There may be three typical tasks in Q&A, i.e., question understanding, data fetching, and answer generation. In particular embodiments, in answer generation, initially Q&A may parse the data from multiple servers itself and the content stitching may process the parsed data. The reasoning about the answer may happen in two places, i.e., the parsing logic of the Q&A and the processing logic of content stitching. They may be unified and content stitching may handle the parsing and answer generation for Q&A. With the contract with content stitching, Q&A may send any format of the data to content stitching, e.g., JSON, AUM, or public knowledge database. In particular embodiments, answer generation may comprise answer entities. All fetched Q&A data may be represented internally in CS graphs, but the Q&A module may communicate them back to dialog in assistant entities. For this purpose, content stitching may use graph entity export to identify the “answer entity” nodes and convert them into assistant entities. Q&A module may then serve these as Q&A answer entities. In particular embodiments, content stitching may be able to generate a graph out of it and output both short answers and long answers. Short answers may include the answers representing the structure, e.g. location entity “Houston”. Since content stitching may be used to generate entities for short answers, it may be also leveraged to generate long answers. Long answers may include the natural language answer text, e.g., “Beyonce was born in Houston.” The Q&A domain configurations may allow long answer generation using content stitching GTT.

For data parsing, content stitching may be integrated with the sources that Q&A supports as data providers and fetched data may be parsed into CS graphs.

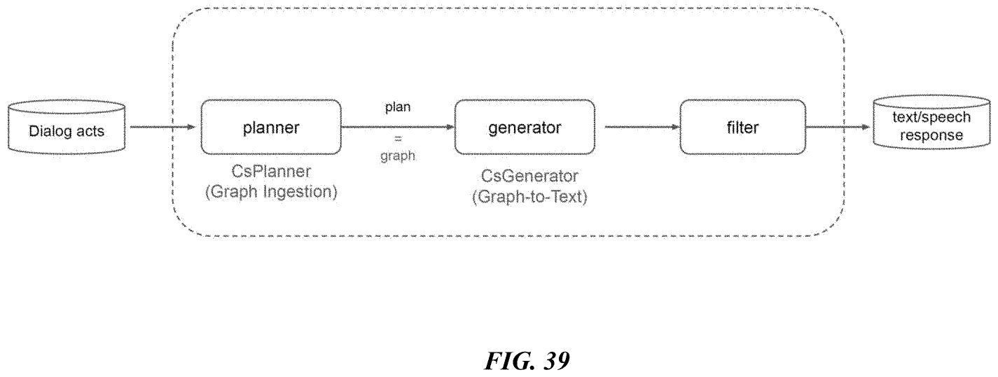

FIG. 39 illustrates an example pipeline for NLG module 372 integration.

For dialog integration, in order to facilitate multi-turn, entity resolution, and co-reference, NLG module 372 and Q&A module may communicate CS-generated assistant entities as answer entities, with graph metadata associated with them for later use.

In a multi-turn setting, content stitching may create assistant entities comprising adequate graph metadata for future CS use. Content stitching may also send the current graph in its own slot, again for future CS use. Therefore, the generated slot may be guaranteed to be useful next turn regardless whether other assistant components or content stitching consumes it. The following may be an example of multi-turn list navigation in local Q&A. The setting may be that Q&A module executes CS and can send CS-generated entity/slots to dialog. The utterance may be “show nearby restaurants.” Knowledge graph may send data with Nrestaurants. Content stitching may make a graph with all restaurants and their descriptions. Content stitching may then send the graph in a task slot to fetch later. Content stitching may further send two slots. The first slot may be named [SL:LOCAL_RESTAURANTS] with a collection entity of N restaurant entities. The second slot may be named [SL:NAME_BUSINESS] with text of the first restaurant, and its restaurant entity (the reason for doing this may be that coreference can use the current restaurant slot). Content stitching may also make NLG answer “there are a lot, first one is . . . .” In the second turn, the utterance may be “show next one.” List intent handler may act on the forward intent and execute its native business logic to read from a collection entity with slot. One slot may be [SL:LOCAL_RESTAURANTS], for which the list intent handler may send the right restaurant entity with slot name. Another slot may be [SL:NAME_BUSINESS] with new intent [IN:GET_INFO_RESTAURANT]. The Q&A module may continue with the intent, skip knowledge graph, and call content stitching. Content stitching may further map [SL:NAME_BUSINESS] to an existing restaurant node and do graph-to-text accordingly.

In particular embodiments, coreference resolution may be taken care of by content stitching without effort, similar with the multiturn list navigation example above. Continuing with the above example but assuming a different second utterance, the second turn now may be a coreference turn. The following may be the handling of it. In the second turn, the utterance may be “is it expensive?” The NLU module 210 may create an intent as [IN:GET_RESTAURANT] with [SL:NAME_BUSINESS it]. The coreference may match the slot to the slot from the last task, i.e., the one generated by content stitching. The local Q&A logic may work as is. In particular embodiments, content stitching may enable coreference across different tasks. That means the assistant system 140 may handle coreference to a previously non-existent slot. For example, there may be a flow from music Q&A to weather coreference (i.e., CS solution for coreference to non-existing slot). In the first turn, the utterance may be “where was Beyonce born?” The music Q&A flow may execute the query and content stitching may create an answer location entity (e.g., “Houston, Tex.”) for a new slot [SL:LOCATION]. The Q&A module may send slots to dialog. In the second turn, the utterance may be “how's the weather there?” The NLU module 210 may create a “get weather” intent with [SL:LOCATION there]. The coreference may then match the slot to the slot from the last task, i.e., the one generated by content stitching. The weather task may be then executed.

In particular embodiments, task-driven agent integration may comprise enabling content stitching with agents via the standard task-oriented agent paradigm and the NLG module 372. Our graph source data type may be also an assistant entity itself, and agents may add any of the supported sources as a dialog act slot. One may also combine other assistant entities with our graph source data entity in order to add a mixture of entities into the CS graph.

### On-Device Conversational Understanding Reinforcement Engines

In particular embodiments, the assistant system 140 may implement a fully on-device CURE (conversational understanding reinforcement engine) model which adapts using real-time user feedback to provide a frictionless user experience when interacting with the assistant system 140. Besides providing the assistant system 140 with the capability to learn rapidly and continuously from live user interactions with weak supervision and adapt its behavior in real time, the on-device CURE model may provide strong privacy guarantees by avoiding passing private/sensitive user states to the server, allow greater scalability by simplifying the assistant stack and pushing all functions client-side/offline, and greatly improve latency since there are no client-server communications to slow things down. Under a hybrid architecture of the assistant system 140, there may be a split in where the CURE functionality is being carried out. On the client system 130, there may be a local CURE model, which may handle disambiguating requests. However, learning may all happen server-side (e.g., user context is sent back to the server) and the server may push the updated CURE model to the client system 130 after the learning. The assistant system 140 may address this issue by bringing all CURE server-side functionality to the client-side, which means the tracking, learning, and feedback functions may all move to the client-side. In addition, the assistant system 140 may take advantage of the client-side assistant orchestrator 206 function to determine when information shouldn't be sent to the server. For example, the assistant orchestrator 206 may decide that a request based on audio is privacy-sensitive, so the assistant system 140 doesn't send that audio to the server and instead processes the request completely on-device. The on-device CURE model may be useful in many use cases including multi-turn messaging dialogs, where the model may disambiguate referenced entities, confirm recipients and contents, request recipients and contents, revise recipient contact information, and correct/revise content before sending a message. For example, at the first turn the user may say “call Kevin.” The assistant system 140 may disambiguate by asking “Kevin X or Kevin Y?” The user may confirm by saying “Kevin Y.” The assistant system 140 may then implicitly acknowledge by saying “calling Kevin Y.” At the second turn, the user may say “call Kevin.” The assistant system 140 may confirm with user by asking “do you mean Kevin Y?” After receiving the user's confirmation, the assistant system 140 may implicitly acknowledge by saying “calling Kevin Y.” At the third turn, the user may say “call Kevin.” The assistant system 140 may proceed without disambiguation/confirmation but give the user implicit acknowledgement by saying “calling Kevin Y.” At each of these turns, the local CURE model may be updated based on the user's feedback. More information on conversational understanding reinforcement engine may be found in U.S. patent application Ser. No. 17/186,459, filed 26 Feb. 2021, which is incorporated by reference. Although this disclosure describes implementing particular models by particular systems in a particular manner, this disclosure contemplates implementing any suitable model by any suitable system in any suitable manner.

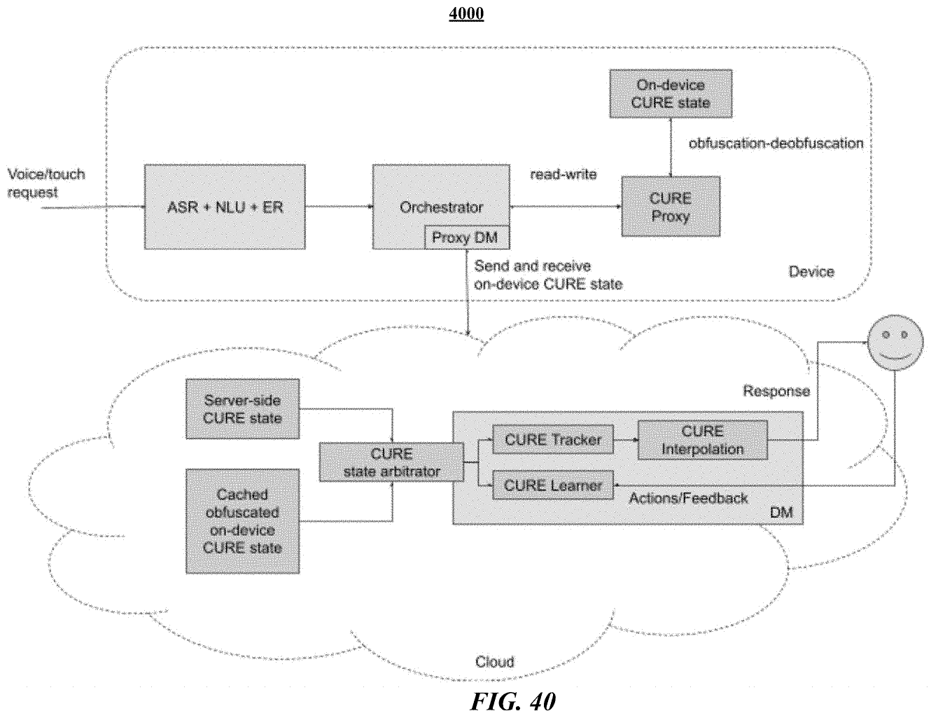

FIG. 40 illustrates an example hybrid processing architecture of the conversational understanding reinforcement engine. When receiving a voice/touch request of a user from the client system 130, the assistant system 140 may process it locally on device. The voice/touch request may be processed by the ASR module 208a, the NLU module 210a, and the entity resolution (ER) module 212a. The output from the entity resolution module 212a may be sent to the on-device orchestrator 206. The on-device orchestrator 206 may read from or write to the on-device CURE state via the CURE proxy. If the on-device orchestrator 206 determines it is necessary to have the server-side dialog manager 216b to further the processing, the on-device orchestrator 206 may send the on-device CURE state to the cloud. Before sending it over, the on-device CURE state may perform obfuscation of its stored states to protect user privacy. The on-device orchestrator 206 may reply on a dialog manager (DM) proxy 224 to send the obfuscated on-device CURE state to the dialog manager 216b on the cloud for server-side processing.

The obfuscated on-device CURE state may be stored in the cached obfuscated on-device CURE state. The CURE state arbitrator may access both server-side CURE state and cached obfuscated on-device CURE state and send the accessed states to CURE tracker and CURE learner, which may be implemented within the dialog manager 216b. The CURE tracker may perform CURE interpolation, which may further provide a response to the user. The user may perform some actions or provide feedback responsive to the response. Such actions/feedback may be sent back to the CURE learner, which may adapt the CURE model accordingly. In addition, the server-side CURE state may be updated according to these actions/feedback. The dialog manager 216b may further send the server-side CURE state to the client system 130 to update the on-device CURE state. The received CURE state may be written to the on-device via the CURE proxy by the on-device orchestrator 206, during which the received CURE state may be de-obfuscated. As may be seen, the back-and-forth data flow between the client system 130 and the cloud may cause privacy issue and latency issue. As such, the assistant system 140 may implement the CURE model fully on-device to resolve these issues.

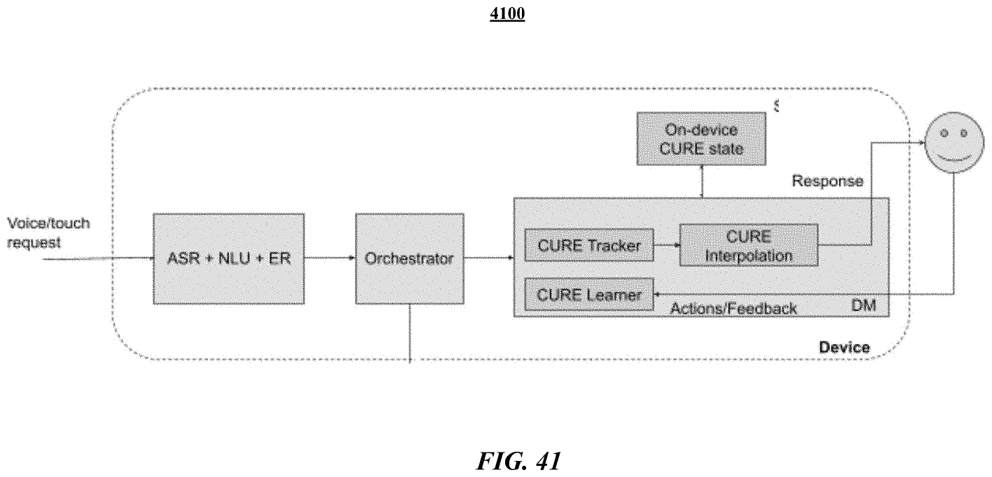

FIG. 41 illustrates an example fully on-device processing architecture of the conversational understanding reinforcement engine. When receiving a voice/touch request of a user from the client system 130, the assistant system 140 may process it locally on device. The voice/touch request may be processed by the ASR module 208a, the NLU module 210a, and the entity resolution (ER) module 212a. The output from the entity resolution module 212a may be sent to the on-device orchestrator 206. The on-device orchestrator 206 may route the request to the on-device dialog manager 216a. The on-device dialog manager 216a may access the on-device CURE state. The accessed CURE states may be provided to the CURE tracker of the dialog manager 216a. In particular embodiments, the tracked CURE states may go through CURE interpolation. Based on the interpolation, the dialog manager 216a may generate a response and present it to the user. The user may perform some actions or provide feedback regarding the response. In particular embodiments, the CURE learner of the dialog manager 216a may further adapt the CURE model and update the on-device CURE state.

In particular embodiments, the processing of fully on-device CURE may be useful for various use cases. One example use case may include offline messaging. The fully on-device CURE may enable the assistant system 140 to rapidly adapt to user's contact preferences for sending text messages. Fully on-device CURE may play a crucial role in enabling one-shot messaging, specifically when there is ambiguity involved in recipient contact resolution. In addition to, fully on-device CURE may support various offline multi-turn dialog capabilities, including disambiguation of recipient, confirmation of a recipient and content along with recipient, requesting recipient and content arguments, revising recipient contact, content correction/revision before sending message.

In particular embodiments, the assistant system 140 may perform positive adaptation with fully on-device CURE, which may include disambiguation, confirmation, and one-shot messaging. In particular embodiments, the assistant system 140 may perform rapid negative adaptation with fully on-device CURE, which may include disambiguation, confirmation, and disambiguation (on negative feedback).

In particular embodiments, the assistant system 140 may have several technical advantages by using fully on-device CURE. One technical advantage may be for privacy. Fully on-device CURE may provide strong privacy guarantees by avoiding passing private sensitive user states to server side in a typical hybrid architecture. Another technical advantage may be for scalability. Fully on-device CURE may greatly simplify the assistant stack to support CURE across different providers and make it easier to scale. Another technical advantage may be for latency. Fully on-device CURE may bring in latency gains since there is no client-server communication.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
receiving, via a user interface, one or more user inputs configuring a rendering of a response, wherein the one or more user inputs comprise one or more selections of one or more rendering-templates;
determining one or more types of one or more client systems at which the response is to be rendered, respectively;
determining, based on the one or more user inputs and the one or more types of the one or more client systems, one or more ways to render the response, respectively; and
sending, to the one or more client systems, instructions for rendering the response in the one or more ways, respectively.

2. A method comprising, by one or more computing systems:
receiving, from a client system, one or more user inputs during one or more user-turns in a dialog session;
determining, based on a discourse representation graph, one or more intents and one or more slots for each of the user inputs, wherein the discourse representation graph comprises one or more first nodes corresponding to the one or more user-turns, and wherein two or more nodes of the one or more first nodes are connected with relationship indications;
generating, based on the discourse representation graph, one or more natural-language responses during one or more system-turns, wherein the discourse representation graph further comprises one or more second nodes corresponding to the one or more system-turns, and wherein two or more nodes of the one or more second nodes are connected with relationship indications; and
sending, to the client system, instructions for presenting the one or more natural-language responses.

3. A method comprising, by one or more computing systems:
receiving, from a client system associated with a first user, a user query;
identifying, based on the user query, one or more related queries authored by one or more second users, wherein each second user is within a threshold degree of separation from the first user, and wherein each related query is associated with one or more answers authored by one or more third users;
generating a response based on one or more of the answers associated with each related query; and
sending, to the client system responsive to the user query, instructions for presenting the response.

4. A method comprising, by one or more computing systems:
receiving, from a client system associated with a user, a user input;
generating intermediate graph data based on data accessed from one or more data sources;
converting the intermedia graph data into a content stitching graph, wherein the content stitching graph comprises a plurality of nodes, each node comprising one or more of an entity node or a predicate node;
generating, based on the content stitching graph and one or more grammars, a natural-language response; and
sending, to the client system responsive to the user input, instructions for presenting the natural-language response.

5. A method comprising, by a client system:
receiving, at the client system, a user input from a user, wherein the user input is associated with an input context;
accessing a plurality of episodic states associated with the user, wherein each episodic state comprises a context and a corresponding task;
determining a plurality of candidate tasks based on a comparison between the input context and the contexts of the episodic states;
receiving, at the client system, user feedback corresponding to the plurality of candidate tasks;
updating, in real-time responsive to receiving the user feedback, one or more of the corresponding tasks of the episodic states to one of the candidate tasks based on the user feedback; and
executing a finalized task responsive to the user input, wherein the finalized task is determined based on the updated episodic states.
